(19) United States
(12) Patent Application Publication
(10) Pub. No.: US 2025/0112526 A1
(43) Pub. Date: Apr. 3, 2025

(54) MOTOR UNIT AND WORKING MACHINE

(71) Applicant: MAKITA CORPORATION, Anjo-shi (JP)

(72) Inventor: Hajime TAKEUCHI, Anjo-shi (JP)

(73) Assignee: MAKITA CORPORATION, Anjo-shi (JP)

(21) Appl. No.: 18/830,981

(22) Filed: Sep. 11, 2024

(30) Foreign Application Priority Data
Oct. 2, 2023 (JP) 2023-171589
Feb. 15, 2024 (JP) 2024-021177

(51) Int. Cl. H02K 11/00; B25D 17/00; H02K 7/14; H02K 9/14

(52) U.S. Cl. CPC H02K 11/0094; B25D 17/00; H02K 7/14; H02K 9/14

(57) ABSTRACT

A motor unit may include: a body housing including an accommodating part including a first wall, a first battery receptacle and a second battery receptacle that are disposed on the first wall; and a motor disposed inside the accommodating part and configured to drive a working unit. The first receptacle may be configured to have a first battery attached thereto, the first battery being configured to slide along the first wall. The second receptacle may be configured to have a second battery attached thereto, the second battery being configured to slide along the first wall. The first battery may include a first side surface. The second battery may include a second side surface which may face the first side surface and be disposed parallel to the first side surface when the first battery is attached to the first receptacle and the second battery is attached to the second receptacle.

### REFERENCE TO RELATED APPLICATION

This application claims priority to Japanese Patent Application No. 2023-171589, filed on Oct. 2, 2023, and Japanese Patent Application No. 2024-21177, filed on Feb. 15, 2024, the entire contents of which are hereby incorporated by reference into the present application.

### TECHNICAL FIELD

This disclosure herein relates to a motor unit and a working machine.

### BACKGROUND ART

US 2021/0143710 A describes a motor unit. The motor unit is configured to be detachably attached to each of a plurality of types of working units to drive the working unit to which the motor unit is attached. The motor unit includes an accommodating part including a first wall, a first battery receptacle disposed on the first wall, and a motor located inside the accommodating part to drive the working unit. The battery receptacle has a battery configured to power the motor attached thereto, the battery being configured to slide along the first wall.

Further, a motor unit is also disclosed in WO 2020/049617 A1. The motor unit is detachably attached to each of first and second working units to operate the first or second working unit that the motor unit is attached to. The motor unit has a motor with a motor shaft, a motor housing that supports the motor, and a battery receptacle to which a battery pack is detachably attached. It further has a body housing that houses the motor housing, a first bearing and a second bearing that rotatably support the motor shaft, a first fan fixed to the motor shaft, and a control unit configured to drive the motor.

### SUMMARY

The motor unit in the above US 2021/0143710 A uses a dedicated large battery. Use of a small battery with higher versatility is demanded.

In the motor unit of WO 2020/049617 A1 as above, the first fan is located between the first bearing and the second bearing. Due to this, it is necessary to design a longer distance between the first bearing and the second bearing. This leads to an increase in the size of the motor unit.

Further, in the motor unit of WO 2020/049617 A1, the first fan is located in an accommodating space inside the motor housing. Due to this, the motor housing becomes larger, and this leads to the motor unit being larger.

Furthermore, in motor units, a space may be defined between the control unit and a wall of the body housing where the battery receptacle is located. Effective use of such a space between the control unit and the wall of the body housing where the battery receptacle is located is demanded.

In the motor unit of WO 2020/049617 A1 as mentioned above, it is desired to reduce the size of the motor unit by making the magnets smaller.

The purpose of this specification is to provide an art that achieves at least one of the following technologies: a technology that enables the use of a versatile and compact battery for a motor unit, a technology that prevents the motor unit from becoming larger, and a technology that enables efficient use of a space between a control unit and a wall of a body housing.

A motor unit disclosed herein may be configured to be detachably attached to each of a plurality of types of working units to drive the working unit to which the motor unit is attached. The motor unit may comprise: a body housing comprising an accommodating part including a first wall, a first battery receptacle disposed on the first wall, and a second battery receptacle disposed on the first wall; and a motor disposed inside the accommodating part and configured to drive the working unit. The first battery receptacle may be configured to have a first battery configured to power the motor attached thereto, the first battery being configured to slide along the first wall. The second battery receptacle may be configured to have a second battery configured to power the motor attached thereto, the second battery being configured to slide along the first wall. The accommodating part may be not disposed between the first battery attached to the first battery receptacle and the second battery attached to the second battery receptacle. The first battery may comprise a first side surface. The second battery may comprise a second side surface. The second side surface may face the first side surface and be disposed parallel to the first side surface when the first battery is attached to the first battery receptacle and the second battery is attached to the second battery receptacle.

The first and second batteries are versatile and compact batteries. According to the above configuration, the first battery is attached to the first battery receptacle and the second battery is attached to the second battery receptacle. This enables use of the versatile and compact first and second batteries to be used in the motor unit. In addition, because the first side surface of the first battery faces the second side surface of the second battery in parallel, the motor unit to which the first and second batteries are attached can be made smaller as compared to a configuration in which the first side surface of the first battery does not face the second side surface of the second battery in parallel.

Another motor unit disclosed herein may be configured to be detachably attached to each of a plurality of types of working units to drive the working unit to which the motor unit is attached. The motor unit may comprise: a body housing comprising an accommodating part including a first wall, a first battery receptacle disposed on the first wall, and a second battery receptacle disposed on the first wall; and a motor disposed inside the accommodating part and configured to drive the working unit. The first battery receptacle may be configured to have a first battery configured to power the motor attached thereto. The second battery receptacle may be configured to have a second battery configured to power the motor attached thereto. A maximum output of the motor may be equal to or more than 1.5 kW and equal to or less than 2.35 kW.

The first and second batteries are versatile and compact batteries. According to the above configuration, the first battery is attached to the first battery receptacle and the second battery is attached to the second battery receptacle. The motor with the maximum output value equal to or more than 1.5 kW and equal to or less than 2.35 kW is used to operate a relatively high-power working unit. Due to this, the versatile and compact first and second batteries can be used for the motor unit to operate a relatively high-power working unit.

Yet another motor unit disclosed herein may be configured to be detachably attached to each of a plurality of types of working units to drive the working unit to which the motor unit is attached. The motor unit may comprise: a body housing comprising an accommodating part including a first wall, a first battery receptacle disposed on the first wall, and a second battery receptacle disposed on the first wall; a motor disposed inside the accommodating part and configured to drive the working unit; and a fixing unit comprising a first fixing part and a second fixing part. The first battery receptacle may be configured to have a first battery configured to power the motor attached thereto. The second battery receptacle may be configured to have a second battery configured to power the motor attached thereto. The plurality of types of working units may comprise a first working unit and a second working unit different from the first working unit. The first fixing part may be configured to be fixed to the first working unit. The second fixing part may be configured to be fixed to the second working unit.

The first and second batteries are versatile and compact batteries. According to the above configuration, the first battery is attached to the first battery receptacle and the second battery is attached to the second battery receptacle. Due to this, the versatile and compact first and second batteries can be used in the motor unit. The motor unit is fixed to the first working unit via the first fixing part and to the second working unit via the second fixing part. This increases the types of working units in which the motor unit can be used.

A working machine disclosed herein may comprise: a rammer unit; and a motor unit configured to be detachably attached to the rammer unit to drive the rammer unit. The motor unit may comprise: a body housing comprising an accommodating part, a first battery receptacle disposed on the accommodating part, and a second battery receptacle disposed on the accommodating part; and a direct-current motor disposed inside the accommodating part and configured to drive the rammer unit. The first battery receptacle may be configured to have a first battery configured to power the direct-current motor attached thereto. The second battery receptacle may be configured to have a second battery configured to power the direct-current motor attached thereto.

The first and second batteries are versatile and compact batteries. According to the above configuration, the first battery is attached to the first battery receptacle and the second battery is attached to the second battery receptacle. Due to this, the versatile and compact first and second batteries can be used in the motor unit to operate the rammer unit.

Yet another motor unit disclosed herein may be configured to be detachably attached to each of a first working unit and a second working unit to drive the first working unit and the second working unit to which the motor unit is attached. The motor unit may comprise: a motor comprising a motor shaft, wherein the motor has a maximum output of equal to or more than 1.8 kW; a motor housing supporting the motor; a body housing comprising a battery receptacle to which a battery pack is configured to be detachably attached, the body housing accommodating the motor housing; and a first bearing and a second bearing that are attached to the motor housing and rotatably support the motor shaft. The second bearing may be disposed rearward than the first bearing. A distance between a front end of the first bearing and a rear end of the second bearing may be equal to or less than 115 mm.

According to the above configuration, the motor unit can be suppressed from becoming larger as compared to a configuration in which the distance between the front end of the first bearing and the rear end of the second bearing exceeds 115 mm.

Yet another motor unit disclosed herein may be configured to be detachably attached to each of a first working unit and a second working unit to drive the first working unit and the second working unit to which the motor unit is attached. The motor unit may comprise: a motor comprising a motor shaft; a motor housing including an accommodating space which accommodates the motor and including an air vent; a body housing comprising a battery receptacle to which a battery pack is configured to be detachably attached, the body housing accommodating the motor housing; a fan fixed to the motor shaft and disposed only outside the accommodating space; and a fixing unit comprising a first fixing part configured to be fixed to the first working unit and a second fixing part configured to be fixed to the second working unit. When the fan rotates, air may pass through a space inside the body housing and outside the motor housing, the air vent, and the accommodating space in this order.

According to the above configuration, since the fan is located outside of the accommodating space, the motor housing can be suppressed from becoming larger. This can suppress the motor unit from becoming larger in size.

Yet another motor unit disclosed herein may be configured to be detachably attached to each of a first working unit and a second working unit to drive the first working unit and the second working unit. The motor unit may comprise: a motor; a motor housing supporting the motor; a control unit configured to drive the motor; a body housing comprising a battery receptacle to which a battery pack is configured to be detachably attached, the body housing accommodating the motor housing and the control unit; a motor electric wire extending from the motor; and a motor connection electric wire extending from the control unit and connected to the motor electric wire. The battery receptacle may be disposed on a first wall of the body housing. A terminal connecting the motor electric wire and the motor connection electric wire may be disposed in a space between the first wall and the control unit.

According to the above configuration, the terminal connecting the motor electric wire to the motor connection wire is disposed in the space between the first wall and the control unit, by which the space between the first wall and the control unit can be used efficiently.

Yet another motor unit disclosed herein may be configured to be detachably attached to each of a first working unit and a second working unit to drive the first working unit and the second working unit. The motor unit may comprise: a motor; a motor housing supporting the motor; a body housing comprising a battery receptacle to which a battery pack is configured to be detachably attached, the body housing accommodating the motor housing; and a fixing unit comprising a first fixing part configured to be fixed to the first working unit and a second fixing part configured to be fixed to the second working unit. The motor may comprise: a stator body; a coil wound around the stator body; a rotor body; and a plurality of magnets fixed to the rotor body. A residual magnetic flux density of each of the plurality of magnets may be equal to or more than 1.32 T. A coercivity of each of the plurality of magnets may be equal to or more than 971 kA/m.

According to the above configuration, the magnets can be made smaller than in a configuration in which the residual magnetic flux density of the magnet is less than 1.32 T and/or the coercivity of the magnet is less than 971 kA/m. Due to this, the motor unit can be downsized.

### BRIEF DESCRIPTION OF DRAWINGS

FIG. 1 shows a system 1 of a first embodiment.

FIG. 2 shows a perspective view of a motor unit 10 and a rammer 4a of the first embodiment.

FIG. 3 shows a perspective view of the motor unit 10 and a plate compactor 4b of the first embodiment.

FIG. 4 shows a perspective view of the motor unit 10 and battery packs BP of the first embodiment.

FIG. 5 is a table showing specifications of the motor unit 10, a body housing 12, a motor 86, and the battery packs BP of the first embodiment.

FIG. 6 shows a perspective view of the motor unit 10 and battery pack BP of the first embodiment.

FIG. 7 is a perspective view of a first battery receptacle 22 and a second battery receptacle 24 and a surrounding area thereof in the motor unit 10 of the first embodiment.

FIG. 8 shows a cross-sectional view of a first battery pack BP1 and a second battery pack BP2 and a surrounding area thereof in the motor unit 10 of the first embodiment.

FIG. 9 is a table showing specifications of the motor 86 and the battery packs BP of the first embodiment.

FIG. 10 shows a perspective view of the battery pack BP of the first embodiment.

FIG. 11 shows a cross-sectional view of the first battery receptacle 22 and the first battery pack BP1 and a surrounding area thereof in the motor unit 10 of the first embodiment.

FIG. 12 shows an exploded perspective view of the motor unit 10 of the first embodiment.

FIG. 13 shows a cross-sectional view of the motor unit 10 and battery pack BP of the first embodiment.

FIG. 14 shows a perspective view of a motor housing 84 and the motor 86 of the first embodiment.

FIG. 15 shows a cross-sectional view of an area surrounding an air intake 28a in the motor unit 10 of the first embodiment.

FIG. 16 shows a cross-sectional view of the motor housing 84, the motor 86, and a fan 88 of the first embodiment.

FIG. 17 shows an exploded perspective view of the motor housing 84, the motor 86, and a plate member 92 of the first embodiment.

FIG. 18 shows an exploded perspective view of the motor unit 10 of the first embodiment with the body housing 12 and a support unit 100 removed.

FIG. 19 shows an exploded perspective view of the motor unit 10 of the first embodiment with the body housing 12 and the support unit 100 removed.

FIG. 20 shows a right side view of the motor unit 10 of the first embodiment with the body housing 12 and the support unit 100 removed.

FIG. 21 is a left side view of the motor unit 10 of the first embodiment with the body housing 12 and the support unit 100 removed.

FIG. 22 shows a cross-sectional view of the motor unit 10 of the first embodiment.

FIG. 23 shows a front view of the motor unit 10 of the first embodiment with the body housing 12 removed.

FIG. 24 shows an exploded perspective view of the motor unit 10 of the first embodiment with the body housing 12 removed.

FIG. 25 shows an exploded perspective view of the motor unit 10 of the first embodiment with the body housing 12 removed.

FIG. 26 shows a cross-sectional view of an area surrounding a control unit 102 in the motor unit 10 of the first embodiment.

FIG. 27 shows a left side view of the motor unit 10 and the rammer 4a of the first embodiment.

FIG. 28 shows a front view of the motor housing 84, the motor 86, and a fixing unit 90 of the first embodiment.

FIG. 29 is a perspective view of the rammer 4a of the first embodiment near a fixing platform 308.

FIG. 30 shows an exploded perspective view of the motor unit 10 and the rammer 4a of the first embodiment.

FIG. 31 shows a left side view of the motor unit 10 and the plate compactor 4b of the first embodiment.

FIG. 32 shows an exploded perspective view of a first fixing part 148 and the plate compactor 4b of the first embodiment.

FIG. 33 shows a side view of the motor unit 10 and a slope mower 4c of the first embodiment.

FIG. 34 shows a perspective view of a motor unit 10 and battery packs BP of a second embodiment.

FIG. 35 shows a perspective view of a motor unit 10 and battery pack BP of a third embodiment.

FIG. 36 shows a right side view of a motor unit 10 of a fourth embodiment with a body housing 12 and a support unit 100 removed.

FIG. 37 shows a right side view of a motor unit 10 of a fifth embodiment with a body housing 12 and a support unit 100 removed.

FIG. 38 is a perspective view of a power tool 6 of a sixth embodiment.

FIG. 39 shows a right cross-sectional view of a motor housing 84, a motor 86, and a fan 88 of the sixth embodiment.

FIG. 40 shows a right cross-sectional view of the motor housing 84, the motor 86, and the fan 88 of the sixth embodiment.

FIG. 41 shows a rear cross-sectional view of the motor housing 84 and the motor 86 of the sixth embodiment.

FIG. 42 is a right cross-sectional view of the motor housing 84 and the motor 86 of the sixth embodiment near a sensor board 520.

FIG. 43 shows a rear cross-sectional view of the motor unit 10 of the sixth embodiment near a main power switch 74, a display panel 76, and a speed change switch 78b.

FIG. 44 shows a right side view of a control unit 102, first switch signal wires 530, first switch connection signal wires 532, a first switch connection terminal 534, second switch wires 536, second switch connection wires 538, and a second switch connection terminal 540 of the sixth embodiment.

FIG. 45 is a perspective view of the motor unit 10 of the sixth embodiment with a left body housing 16 removed.

FIG. 46 is a perspective view of the motor unit 10 of the sixth embodiment near a terminal accommodating space 544.

FIG. 47 shows a schematic view of the motor unit 10 of the sixth embodiment.

FIG. 48 shows a perspective view of the motor housing 84, the control unit 102, a tubular vibration-proof member 104, motor power wires 560, motor connection power wires 562, first motor connection terminals 564, motor signal wires 566, motor connection signal wires 568, and a second motor connection terminal 570 of the sixth embodiment.

FIG. 49 is a perspective view of the motor unit 10 of the sixth embodiment with the right body housing 14 removed.

FIG. 50 shows a perspective view of the motor unit 10 of the sixth embodiment with the right body housing 14, the plate member 92, a right cover member 96, and a support unit 100 removed.

FIG. 51 is a right side view of the motor unit 10 of the sixth embodiment with the right body housing 14 removed.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved motor units and working machines, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A motor unit disclosed herein may be configured to be detachably attached to each of a plurality of types of working units to drive the working unit to which the motor unit is attached. The motor unit may comprise: a body housing comprising an accommodating part including a first wall, a first battery receptacle disposed on the first wall, and a second battery receptacle disposed on the first wall; and a motor disposed inside the accommodating part and configured to drive the working unit. The first battery receptacle may be configured to attach a first battery configured to power the motor, the first battery configured to slide along the first wall. The second battery receptacle may be configured to attach a second battery configured to power the motor, the second battery configured to slide along the first wall. The accommodating part may be not disposed between the first battery attached to the first battery receptacle and the second battery attached to the second battery receptacle. The first battery may comprise a first side surface. The second battery may comprise a second side surface. The second side surface may face the first side surface and be disposed parallel to the first side surface when the first battery is attached to the first battery receptacle and the second battery is attached to the second battery receptacle.

In one or more embodiments, the motor unit may not comprise a wall part disposed between the first side surface of the first battery and the second side surface of the second battery when the first battery is attached to the first battery receptacle and the second battery is attached to the second battery receptacle.

According to the above configuration, the motor unit to which the first and second batteries are attached can be made more compact.

In one or more embodiments, the first wall may be disposed above the motor when the motor unit is placed on a placement surface.

The motor is a high-weight component. Further, the weight of the motor is greater than the weight of each of the first battery and the second battery. According to the above configuration, the high-weight motor can be placed closer to the placement surface than the first and second batteries are to the placement surface.

In one or more embodiments, the first wall may comprise a first surface on which the first battery receptacle and the second battery receptacle are disposed.

According to the above configuration, the first battery can easily be attached to the first battery receptacle and the second battery can easily be attached to the second battery receptacle.

In one or more embodiments, the motor unit may further comprise a vibration-proof member disposed between the motor and the body housing and being elastically deformable.

According to the above configuration, vibration can be suppressed from being transmitted from the motor to the body housing. Due to this, the transmission of vibration to the first and second batteries can be suppressed.

In one or more embodiments, the motor unit may further comprise: a motor housing accommodating the motor; and a plate member fixed to the motor housing. The vibration-proof member may be fixed to the plate member and the body housing.

In a configuration in which the vibration-proof member is directly fixed to the motor housing, the configuration of the motor housing becomes complex. According to the above configuration, such complexity of the motor housing configuration can be suppressed.

In one or more embodiments, the motor unit may further comprise: a control unit disposed inside the accommodating part and configured to control the motor; and a support unit supporting the control unit and fixed to the plate member via the vibration-proof member.

According to the above configuration, vibration can be suppressed from being transmitted to the control unit.

In one or more embodiments, each of the first battery and the second battery may comprise a hook configured to be operated by a user. The body housing may comprise engaged parts, each engaged part being configured to engage with a corresponding one of the hooks.

According to the above configuration, the first and second batteries are engaged with the engaged parts of the body housing, by which the first and second batteries are suppressed from being detached from the body housing.

In one or more embodiments, when the motor unit is viewed along a direction perpendicular to the first wall, the first battery receptacle may not overlap the second battery receptacle.

According to the above configuration, when the motor unit is viewed along a direction perpendicular to the first wall, the structure of the first wall can be suppressed from becoming complex as compared to a configuration in which the first battery receptacle overlaps the second battery receptacle.

In one or more embodiments, the first battery receptacle may be configured to attach the first battery configured to slide in a first direction which extends along the first wall. The second battery receptacle may be configured to attach the second battery configured to slide in the first direction. The motor may comprise a motor shaft extending in the first direction and fixed to the working unit.

According to the above configuration, the direction to slide the first battery and the direction to slide the second battery can easily be recognized by an orientation of the motor shaft.

In one or more embodiments, the motor unit may further comprise a control unit disposed inside the accommodating part and configured to control the motor. When the motor unit is viewed along the first direction, the control unit may at least partially overlap the motor.

According to the above configuration, when the motor unit is viewed along the first direction, the motor unit can be suppressed from becoming larger in the direction perpendicular to the first direction as compared to a configuration in which the control unit does not at least partially overlap the motor.

In one or more embodiments, the motor unit may further comprise a fixing part fixed to the working unit. The motor may be disposed between the fixing part and the first battery receptacle and between the fixing part and the second battery receptacle.

According to the above configuration, the first and second batteries can be suppressed from interfering with the working unit.

Another motor unit disclosed herein may be configured to be detachably attached to each of a plurality of types of working units to drive the working unit to which the motor unit is attached. The motor unit may comprise: a body housing comprising an accommodating part including a first wall, a first battery receptacle disposed on the first wall, and a second battery receptacle disposed on the first wall; and a motor disposed inside the accommodating part and configured to drive the working unit. The first battery receptacle may be configured to have a first battery configured to power the motor attached thereto. The second battery receptacle may be configured to have a second battery configured to power the motor attached thereto. A maximum output of the motor may be equal to or more than 1.5 kW and equal to or less than 2.35 kW.

In one or more embodiments, a torque of the motor may be equal to or more than 2.0 Nm and equal to or less than 11.0 Nm during work by the working unit. A rotation speed of the motor may be equal to or more than 3000 rpm and equal to or less than 4300 rpm during work by the working unit.

A motor with the torque equal to or more than 2.0 Nm and equal to or less than 11.0 Nm and the rotation speed equal to or more than 3000 rpm and equal to or less than 4300 rpm is used to operate a relatively high-power working unit. Due to this, a versatile, compact first and second batteries can be used for the motor unit to operate such a relatively high-power working unit.

In one or more embodiments, a volume of the body housing may be equal to or less than 9500 cm³.

In general, a motor having a higher maximum output has a larger size. Accordingly, the body housing becomes larger. According to the above configuration, the body housing can be made smaller in the motor unit that operates a relatively high-power working unit. Due to this, the motor unit can be downsized.

In one or more embodiments, each of a volume of the first battery and a volume of the second battery may be equal to or less than 1500 cm³.

According to the above configuration, the motor unit can be downsized.

In one or more embodiments, the first wall may be disposed above the motor when the motor unit is placed on a placement surface.

The motor is a high-weight component. Further, the weight of the motor is greater than the weight of each of the first battery and the second battery. According to the above configuration, the high-weight motor can be placed closer to the placement surface than the first and second batteries are to the placement surface.

In one or more embodiments, the first battery receptacle may be configured to have the first battery attached thereto, wherein the first battery is configured to slide in a first direction which extends along the first wall. The second battery receptacle may be configured to have the second battery attached thereto, wherein the second battery is configured to slide in the first direction. The motor may comprise a motor shaft extending in the first direction and fixed to the working unit.

According to the above configuration, the direction to slide the first battery and the direction to slide the second battery can easily be recognized by the orientation of the motor shaft.

In one or more embodiments, the motor unit may further comprise a fixing part fixed to the working unit. The motor may be disposed between the fixing part and the first battery receptacle and between the fixing part and the second battery receptacle.

According to the above configuration, the first and second batteries can be suppressed from interfering with the working unit.

In one or more embodiments, the first battery attached to the first battery receptacle and the second battery attached to the second battery receptacle may be electrically connected in series.

According to the above configuration, the output power of the motor unit can be increased as compared to a configuration in which the first and second batteries are electrically connected in parallel.

Yet another motor unit disclosed herein may be configured to be detachably attached to each of a plurality of types of working units to drive the working unit to which the motor unit is attached. The motor unit may comprise: a body housing comprising an accommodating part including a first wall, a first battery receptacle disposed on the first wall, and a second battery receptacle disposed on the first wall; a motor disposed inside the accommodating part and configured to drive the working unit; and a fixing unit comprising a first fixing part and a second fixing part. The first battery receptacle may be configured to have a first battery configured to power the motor attached thereto. The second battery receptacle may be configured to have a second battery configured to power the motor attached thereto. The plurality of types of working units may comprise a first working unit and a second working unit different from the first working unit. The first fixing part may be configured to be fixed to the first working unit. The second fixing part may be configured to be fixed to the second working unit.

In one or more embodiments, when the motor unit is placed on a placement surface, the first fixing part may be placed on the placement surface. The motor may be disposed between the first fixing part and the first battery receptacle and between the first fixing part and the second battery receptacle.

According to the above configuration, the first and second batteries can be suppressed from interfering with the first working unit.

In one or more embodiments, the motor unit may further comprise a motor housing accommodating the motor. The second fixing part may be disposed on the motor housing.

According to the above configuration, the number of components in the motor unit can be reduced as compared to a configuration in which the second fixing part is not disposed in the motor housing.

In one or more embodiments, the first fixing part may comprise a first fixing surface configured to be fixed to the first working unit. The second fixing part may comprise a second fixing surface configured to be fixed to the second working unit. The second fixing surface may be substantially perpendicular to the first fixing surface.

According to the above configuration, one of the first and second fixing parts is selected according to the shape, etc. of the working unit. Due to this, types of working units to which the motor unit is compatible can be increased.

In one or more embodiments, the motor unit may further comprise a fan disposed inside the accommodating part and configured to rotate by operation of the motor. A first air vent may be defined between the accommodating part and the second fixing part. A second air vent may be defined on the second fixing part. When the fan rotates, air may flow into the accommodating part via one of the first air vent and the second air vent and flow outside the accommodating part via another of the first air vent and the second air vent.

According to the above configuration, the motor disposed inside the accommodating part can be cooled.

In one or more embodiments, a rated capacity of the first battery may differ from a rated capacity of the second battery.

According to the above configuration, multiple types of batteries can be used in the motor unit.

Yet another motor unit disclosed herein may be configured to be detachably attached to each of a first working unit and a second working unit to drive the first working unit and the second working unit to which the motor unit is attached. The motor unit may comprise: a motor comprising a motor shaft, wherein the motor has a maximum output of equal to or more than 1.8 kW; a motor housing supporting the motor; a body housing comprising a battery receptacle to which a battery pack is configured to be detachably attached, the body housing accommodating the motor housing; and a first bearing and a second bearing that are attached to the motor housing and rotatably support the motor shaft. The second bearing may be disposed rearward than the first bearing. A distance between a front end of the first bearing and a rear end of the second bearing may be equal to or less than 115 mm.

In one or more embodiments, the first bearing and the second bearing may be disposed inside the motor housing.

According to the above configuration, a user touching the first and second bearings can be suppressed.

In one or more embodiments, the motor housing may comprise: a first member to which the first bearing is attached, and a second member defining an accommodating space which accommodates the motor between the first member and the second member and to which the second bearing is attached.

According to the above configuration, the configuration of the motor housing can be suppressed from becoming complicated as compared to a configuration in which the first and second bearings are attached on the same member.

In one or more embodiments, the motor unit may further comprise a fan fixed to the motor shaft and disposed only outside the accommodating space. The motor housing may include an air vent. Air may flow into the accommodating space via the air vent by rotation of the fan.

According to the above configuration, the motor housing can be suppressed from becoming large as compared to a configuration in which the fan is disposed in the accommodating space.

In one or more embodiments, the motor unit may further comprise a control unit configured to drive the motor. Air may flow from the control unit toward the air vent by the rotation of the fan.

According to the above configuration, the air passes through the control unit and the air vent before passing through the motor. Due to this, a single air stream can cool both the control unit and the motor.

In one or more embodiments, when the motor unit is viewed along a direction in which the motor shaft extends, the control unit may at least partially overlap the motor.

According to the above configuration, when the motor unit is viewed along the direction in which the motor shaft extends, the motor unit can be suppressed from becoming larger in the direction perpendicular to the direction in which the motor shaft extends, as compared to a configuration in which the control unit does not overlap the motor.

In one or more embodiments, the motor unit may further comprise a sensor board disposed in the accommodating space and configured to detect rotation of the motor. The motor shaft may comprise a fixing part configured to be fixed to each of the first working unit and the second working unit. The first bearing may be disposed between the fixing part and the second bearing. The sensor board may be fixed to the second member.

According to the above configuration, the sensor board can be separated from the first and second working units as compared to a configuration in which the sensor board is fixed to the first member.

In one or more embodiments, the motor unit may further comprise a fixing unit comprising a first fixing part configured to be fixed to the first working unit and a second fixing part configured to be fixed to the second working unit. When the motor unit is placed on a placement surface, the first fixing part may be placed on the placement surface. The motor shaft may comprise a fixing part configured to be fixed to each of the first working unit and the second working unit. The fixing part of the motor shaft may be substantially parallel to the first fixing part.

According to the above configuration, the fixing part of the motor shaft can easily be fixed to the first working unit when the first fixing part is fixed to the first working unit.

In one or more embodiments, the motor unit may further comprise a fixing unit comprising a first fixing part configured to be fixed to the first working unit and a second fixing part configured to be fixed to the second working unit. When the motor unit is placed on a placement surface, the first fixing part may be placed on the placement surface. When the battery pack is attached to the battery receptacle, the battery pack may be substantially parallel to the first fixing part and disposed above the motor.

The motor is a high-weight component. Further, the weight of the motor is greater than that of the battery pack. According to the above configuration, the high-weight motor can be placed closer to the placement surface than the battery pack is to the placement surface. Due to this, the center of gravity of the motor unit can be positioned closer to the placement surface.

In one or more embodiments, the battery pack may be configured to be used for a power tool.

According to the above configuration, the motor unit can be operated using a highly versatile battery pack.

In one or more embodiments, the motor unit may further comprise a switch configured to accept an operation by a user of controlling the motor. The switch may be disposed on the body housing.

According to the above configuration, the configuration of the motor unit can be suppressed from becoming complicated as compared to a configuration in which the switch is disposed in another component other than the body housing.

In one or more embodiments, the motor unit may further comprise: a control unit configured to drive the motor; a switch electric wire extending from the switch; and a switch connection electric wire extending from the control unit and connected to the switch electric wire. The battery receptacle may be disposed on a first wall of the body housing. A terminal connecting the switch electric wire and the switch connection electric wire may be disposed in a space between the first wall and the control unit.

According to the above configuration, the terminal connecting the switch electric wire and the switch connection wire is disposed in the space between the first wall and the control unit. Due to this, the space between the first wall and the control unit can be used efficiently.

In one or more embodiments, the motor unit may further comprise: a motor electric wire extending from the motor; and a motor connection electric wire extending from the control unit and connected to the motor electric wire. A terminal connecting the motor electric wire and the motor connection electric wire may be disposed in the space between the first wall and the control unit.

According to the above configuration, the terminal connecting the motor electric wire and the motor connection wire is disposed in the space between the first wall and the control unit. Due to this, the space between the first wall and the control unit can be used efficiently.

In one or more embodiments, the motor may comprise: a stator body; a coil wound around the stator body; a rotor body; and a plurality of magnets fixed to the rotor body. A residual magnetic flux density of each of the plurality of magnets may be equal to or more than 1.32 T. A coercivity of each of the plurality of magnets may be equal to or more than 971 kA/m.

According to the above configuration, the magnets can be made smaller as compared to a configuration in which the residual magnetic flux density of each magnet is less than 1.32 T and/or the coercivity of each magnet is less than 971 kA/m. Due to this, the motor unit can be downsized.

In one or more embodiments, each of the plurality of magnets may be a neodymium magnet.

According to the above configuration, since the magnetic force of the neodymium magnet is the strongest among permanent magnets, the magnet can be made smaller. Due to this, the motor unit can be downsized.

In one or more embodiments, the stator body may comprise a plurality of teeth. A number of the plurality of magnets may be equal to or more than a number of the plurality of teeth.

According to the above configuration, an occurrence of cogging can be suppressed during operation of the motor.

In one or more embodiments, the motor unit may further comprise: a control unit configured to drive the motor; and a vibration-proof member configured to be elastically deformable and suppress transmission of vibration of the motor from the motor to the battery receptacle and transmission of vibration of the motor from the motor to the control unit.

According to the above configuration, the battery pack and the control unit can be suppressed from vibrating even if the motor vibrates due to operation of the motor.

Yet another motor unit disclosed herein may be configured to be detachably attached to each of a first working unit and a second working unit to drive the first working unit and the second working unit to which the motor unit is attached. The motor unit may comprise: a motor comprising a motor shaft; a motor housing including an accommodating space which accommodates the motor and including an air vent; a body housing comprising a battery receptacle to which a battery pack is configured to be detachably attached, the body housing accommodating the motor housing; a fan fixed to the motor shaft and disposed only outside the accommodating space; and a fixing unit comprising a first fixing part configured to be fixed to the first working unit and a second fixing part configured to be fixed to the second working unit. When the fan rotates, air may pass through a space inside the body housing and outside the motor housing, the air vent, and the accommodating space in this order.

In one or more embodiments, the motor unit may further comprise a control unit configured to drive the motor. Air may flow from the control unit toward the air vent by the rotation of the fan.

According to the above configuration, air passes through the control unit and the air vent before passing through the motor. Due to this, a single air stream can cool both the control unit and the motor.

In one or more embodiments, when the motor unit is viewed along a direction in which the motor shaft extends, the control unit may at least partially overlap the motor.

According to the above configuration, when the motor unit is viewed along the direction in which the motor shaft extends, the motor unit can be suppressed from becoming larger in the direction perpendicular to the direction in which the motor shaft extends, as compared to the configuration in which the control unit does not overlap the motor.

Yet another motor unit disclosed herein may be configured to be detachably attached to each of a first working unit and a second working unit to drive the first working unit and the second working unit. The motor unit may comprise: a motor; a motor housing supporting the motor; a control unit configured to drive the motor; a body housing comprising a battery receptacle to which a battery pack is configured to be detachably attached, the body housing accommodating the motor housing and the control unit; a motor electric wire extending from the motor; and a motor connection electric wire extending from the control unit and connected to the motor electric wire. The battery receptacle may be disposed on a first wall of the body housing. A terminal connecting the motor electric wire and the motor connection electric wire may be disposed in a space between the first wall and the control unit.

In one or more embodiments, the motor unit may further comprise: a switch configured to accept an operation by a user of controlling the motor; a switch electric wire extending from the switch; and a switch connection electric wire extending from the control unit and connected to the switch electric wire. A terminal connecting the switch electric wire and the switch connection electric wire may be disposed in the space between the first wall and the control unit.

According to the above configuration, the terminal connecting the switch electric wire and the switch connection wire is disposed in the space between the first wall and the control unit. Due to this, the space between the first wall and the control unit can be used efficiently.

Yet another motor unit disclosed herein may be configured to be detachably attached to each of a first working unit and a second working unit to drive the first working unit and the second working unit. The motor unit may comprise: a motor; a motor housing supporting the motor; a body housing comprising a battery receptacle to which a battery pack is configured to be detachably attached, the body housing accommodating the motor housing; and a fixing unit comprising a first fixing part configured to be fixed to the first working unit and a second fixing part configured to be fixed to the second working unit. The motor may comprise: a stator body; a coil wound around the stator body; a rotor body; and a plurality of magnets fixed to the rotor body. A residual magnetic flux density of each of the plurality of magnets may be equal to or more than 1.32 T. A coercivity of each of the plurality of magnets may be equal to or more than 971 kA/m.

In one or more embodiments, each of the plurality of magnets may be a neodymium magnet.

According to the above configuration, since the magnetic force of the neodymium magnet is the strongest among permanent magnets, the magnet can be made smaller. Due to this, the motor unit can be downsized.

In one or more embodiments, the stator body may comprise a plurality of teeth. A number of the plurality of magnets may be equal to or more than a number of the plurality of teeth.

According to the above configuration, the occurrence of cogging can be suppressed during the motor operation.

### FIRST EMBODIMENT

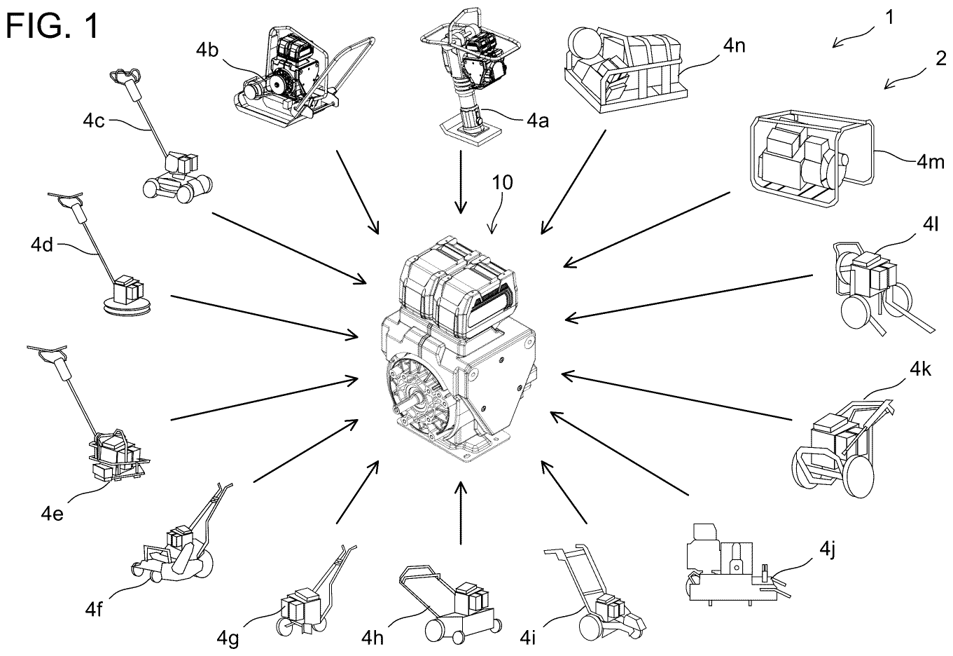

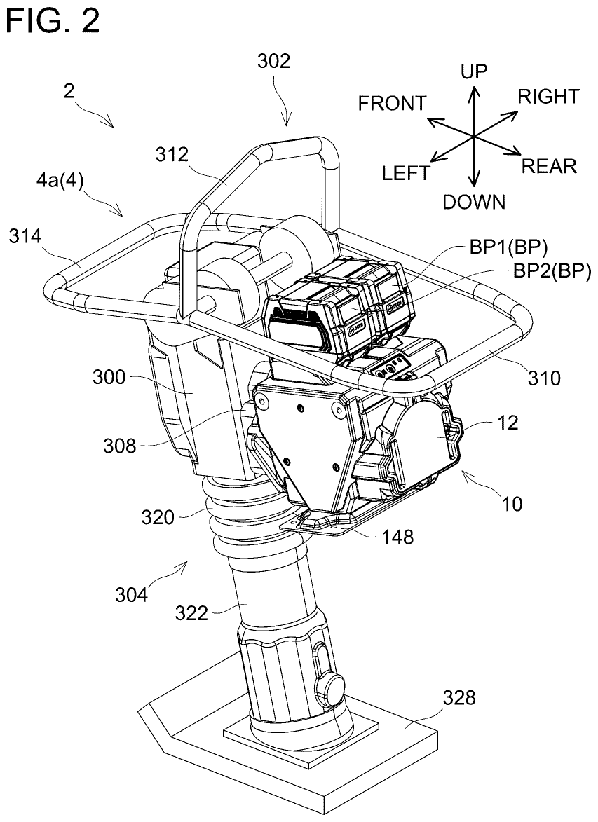

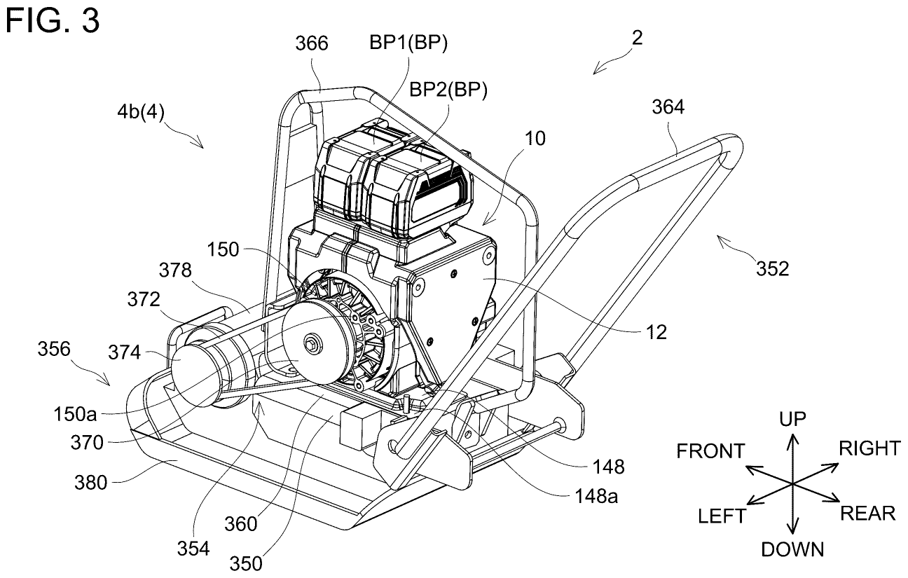

As shown in FIG. 1, a system 1 has multiple types of working units 4 and a motor unit 10. The motor unit 10 is a multi-purpose motor unit. The motor unit 10 can be detachably attached to each of the multiple types of working units 4. Those working units 4 can also have an engine unit detachably attached instead of the motor unit 10. The engine unit is a versatile engine unit, for example, the GX120 engine unit sold by Honda R&D Co. Ltd. That is, the working unit 4 is applicable to both the motor unit 10 and the engine unit. The multiple types of working units 4 are, for example, a rammer 4a, a plate compactor 4b, a slope mower 4c, a trowel 4d, a concrete saw 4e, a reel-type lawn mower 4f, an edger 4g, a detacher 4h, a stump grinder 4i, a compressor 4j, a high pressure washer 4k, a paint sprayer 41, a trash pump 4m, and a chemical sprayer 4n. The working unit 4 is not limited to the above working unit 4, but may be any other working unit 4 other than the above. For example, as shown in FIG. 2, the motor unit 10 is detachably attached to the rammer 4a. As shown in FIG. 3, the motor unit 10 is detachably attached to the plate compactor 4b. In the following, the configuration in which the motor unit 10 is attached to the working unit 4 is sometimes referred to as a working machine 2. A user works using the working machine 2.

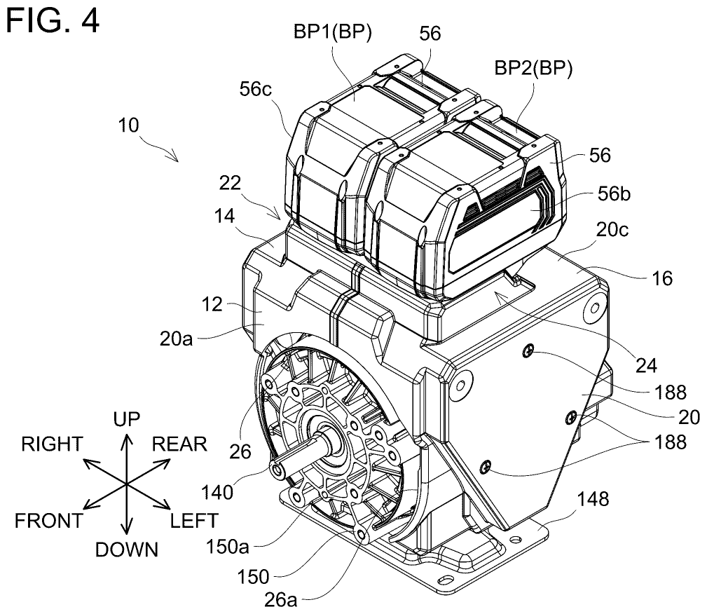

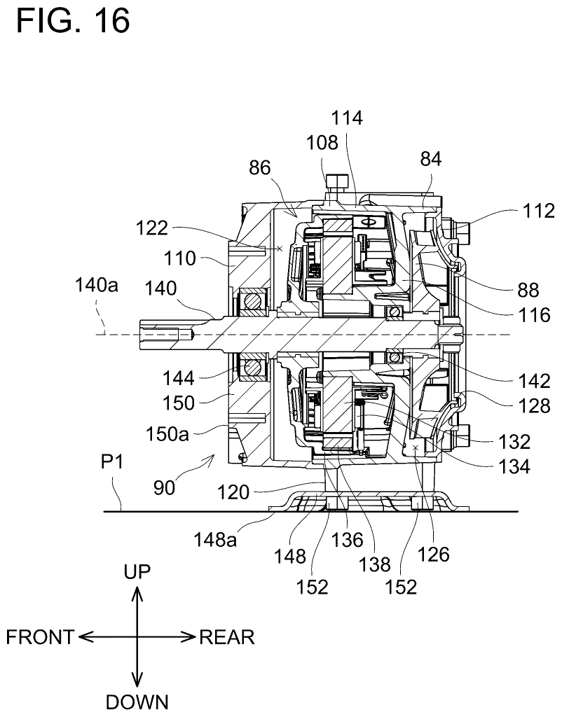

As shown in FIG. 4, the motor unit 10 is operated by power from multiple (in this example, two) battery packs BP. Hereinbelow, one battery pack BP is referred to as a first battery pack BP1 and the other battery pack BP is referred to as a second battery pack BP2. A direction in which a motor shaft 140 of a motor 86 (see FIG. 16) described below extends may be termed a front-rear direction, a direction perpendicular to the front-rear direction may be termed a left-right direction, and a direction perpendicular to the front-rear and left-right directions may be termed an up-down direction. The above front-rear, left-right, and up-down directions are defined to describe the detailed configuration of the motor unit 10. In a working machine 2 in which motor unit 10 and the working unit 4 are combined, front-rear, left-right, and up-down directions of the working machine 2 may differ from the front-rear, left-right, and up-down directions of the motor unit 10.

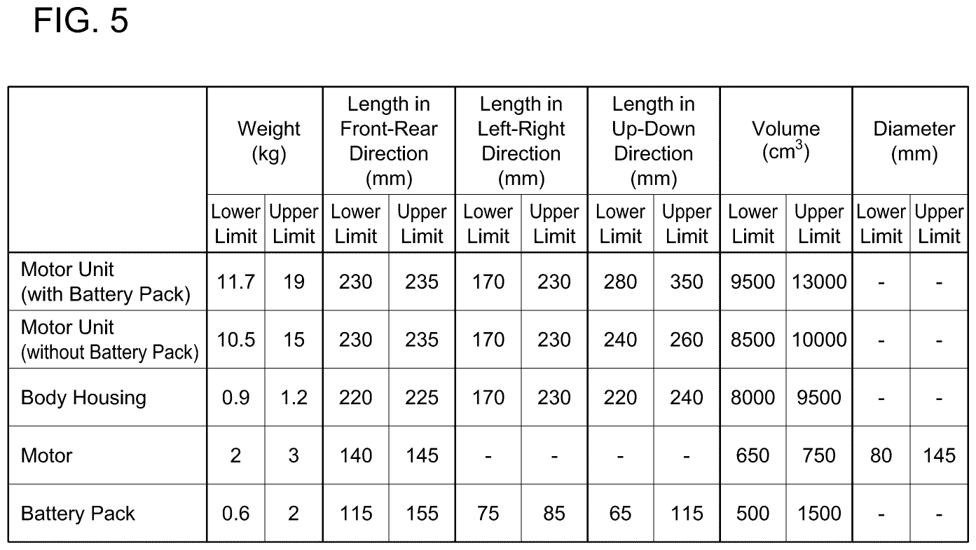

As shown in FIG. 5, for the motor unit 10 including the plurality of battery packs BP, the weight of the motor unit 10 is equal to or more than 11.7 kg and equal to or less than 19 kg. The length of the motor unit 10 in the front-rear direction is equal to or more than 230 mm and equal to or less than 235 mm. The length in the front-rear direction does not include the length of the motor shaft 140 exposed outside the motor unit 10. The length of the motor unit 10 in the left-right direction is equal to or more than 170 mm and equal to or less than 230 mm. The length of the motor unit 10 in the up-down direction is equal to or more than 280 mm and equal to or less than 350 mm. The volume of the motor unit 10 is equal to or more than 9500 cm³ and equal to or less than 13000 cm³.

For the motor unit 10 not including the plurality of battery packs BP, the weight of the motor unit 10 is equal to or more than 10.5 kg and equal to or less than 15 kg. The length of the motor unit 10 in the front-rear direction is equal to or more than 230 mm and equal to or less than 235 mm. The length in the front-rear direction does not include the length of the motor shaft 140 exposed outside the motor unit 10. The length of the motor unit 10 in the left-right direction is equal to or more than 170 mm and equal to or less than 230 mm. The length of the motor unit in the up-down direction is equal to or more than 240 mm and equal to or less than 260 mm. The volume of the motor unit 10 is equal to or more than 8500 cm³ and equal to or less than 10000 cm³.

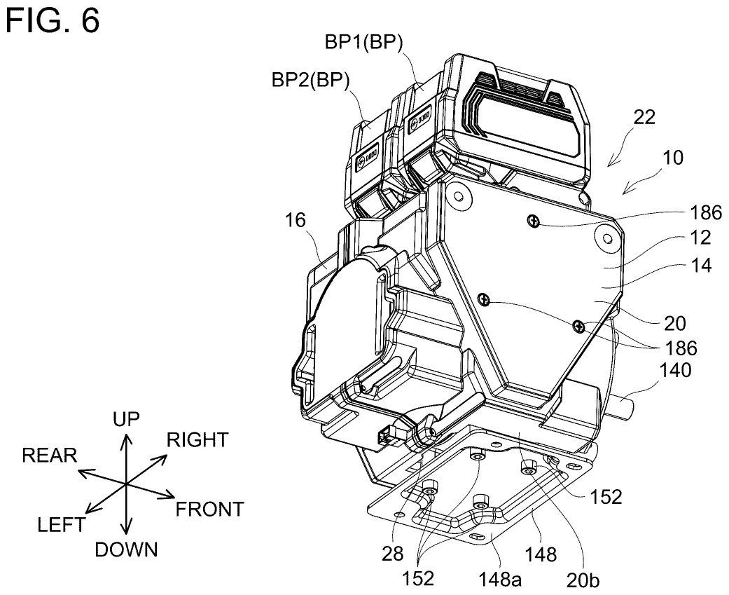

As shown in FIGS. 4 and 6, the motor unit 10 comprises a body housing 12. The body housing 12 is made of, for example, a resin material. As shown in FIG. 5, the weight of the body housing 12 is equal to or more than 0.9 kg and equal to or less than 1.2 kg. The length of the body housing 12 in the front-rear direction is equal to or more than 220 mm and equal to or less than 225 mm. The length of the body housing 12 in the left-right direction is equal to or more than 170 mm and equal to or less than 230 mm. The length of the body housing 12 in the up-down direction is equal to or more than 220 mm and equal to or less than 240 mm. The volume of the body housing 12 is equal to or more than 8000 cm³ and equal to or less than 9500 cm³.

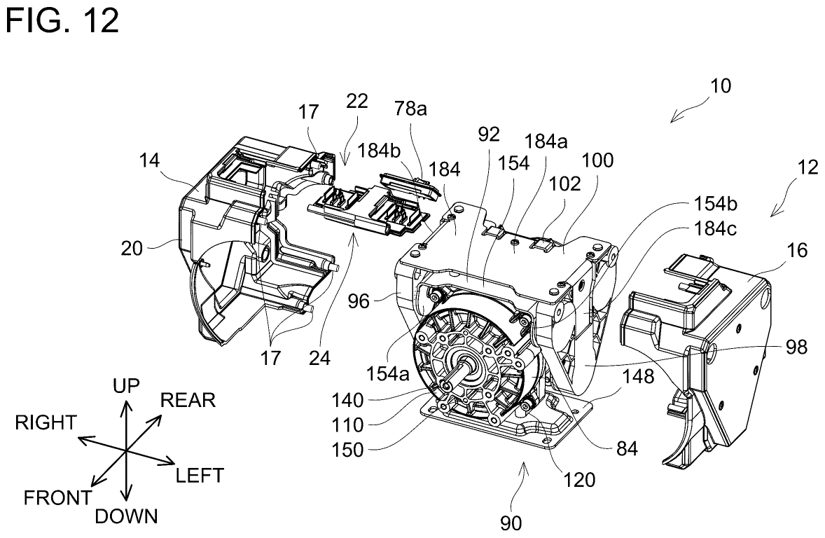

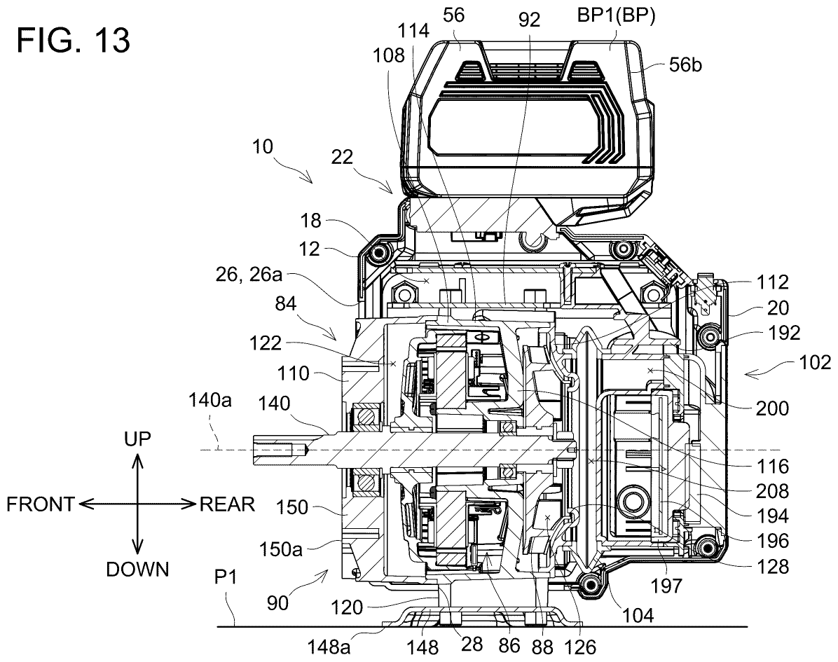

As shown in FIGS. 4 and 6, the body housing 12 has a right body housing 14 and a left body housing 16. The right body housing 14 defines an external shape of a right half of the body housing 12. The left body housing 16 defines an external shape of a left half of the body housing 12. The right body housing 14 and the left body housing 16 are fixed by screws 17 (see FIG. 12). Each of the right body housing 14 and the left body housing 16 has a shape that divides the body housing 12 in half in a plane along the front-rear and up-down directions. A boundary between the right body housing 14 and the left body housing 16 is disposed at the center of the body housing 12 in the left-right direction. An accommodating space 18 (see FIG. 13) is defined between the right body housing 14 and the left body housing 16.

The body housing 12 has an accommodating part 20, a first battery receptacle 22, and a second battery receptacle 24. The accommodating part 20 has the interior accommodating space 18 (see FIG. 13). The accommodating part 20 has a first opening 26 and a second opening 28. The first opening 26 is defined in a front wall 20a of the accommodating part 20. The first opening 26 has a substantially circular cross-sectional shape. The first opening 26 connects the accommodating space 18 to outside of the body housing 12. As shown in FIG. 6, the second opening 28 is defined in a lower wall 20b of the accommodating part 20. The second opening 28 has a substantially rectangular cross-sectional shape. The second opening 28 connects the accommodating space 18 to the outside of the body housing 12.

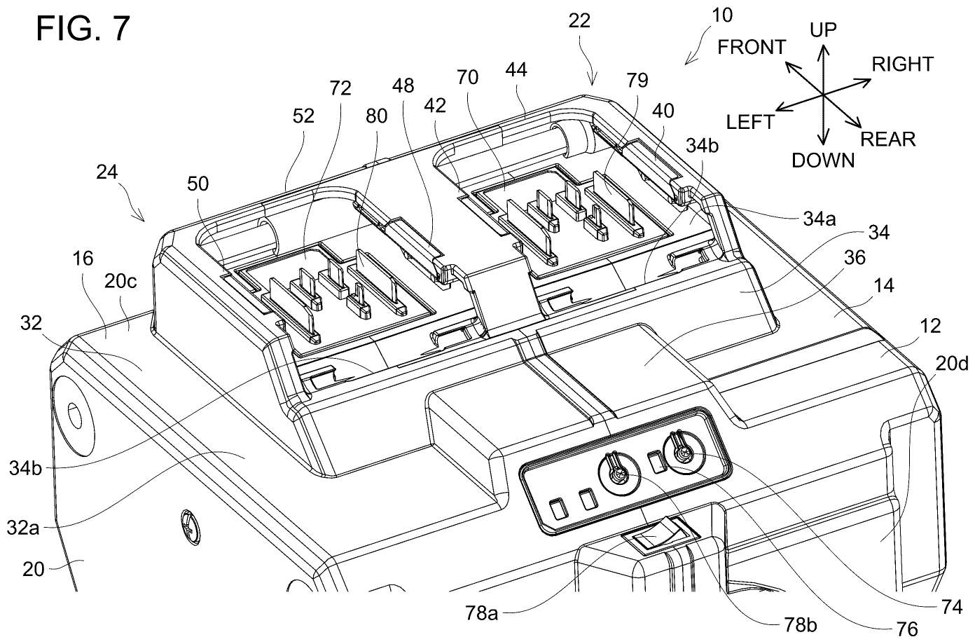

As shown in FIG. 7, an upper wall 20c of the accommodating part 20 has a base 32, a first pyramidal base 34, and a second pyramidal base 36. The first pyramidal base 34 protrudes upward from the base 32. The first pyramidal base 34 has a quadrangular pyramidal shape. An upper surface 34a of the first pyramidal base 34 is positioned above an upper surface 32a of the base 32. Each of the upper surfaces 32a and 34a is perpendicular to the up-down direction.

The second pyramidal base 36 protrudes upward from the base 32. The second pyramidal base 36 is connected to a rear end of the first pyramidal base 34.

The first battery receptacle 22 and the second battery receptacle 24 are disposed on the upper surface 34a of the first pyramidal base 34. The first battery receptacle 22 and the second battery receptacle 24 are arranged side-by-side in the left-right direction. When the motor unit 10 is viewed along the up-down direction, the first battery receptacle 22 does not overlap the second battery receptacle 24.

The first battery receptacle 22 has a first right rail portion 40, a first left rail portion 42, and a first connection portion 44. The first right rail portion 40 and the first left rail portion 42 extend in a front-rear direction. The first right rail portion 40 extends upward from the upper surface 34a of the first pyramidal base 34 and then bends to extend leftward. The first left rail portion 42 extends upward from the upper surface 34a of the first pyramidal base 34, then bends to extend rightward. The first left rail portion 42 opposes the first right rail portion 40 in the left-right direction. The first connection portion 44 connects a front end of the first right rail portion with a front end of the first left rail portion 42.

The second battery receptacle 24 has a second right rail portion 48, a second left rail portion 50, and a second connection portion 52. The second right rail portion 48 and the second left rail portion 50 extend in the front-rear direction. The second right rail portion 48 extends upward from the upper surface 34a of the first pyramidal base 34, and then bends to extend leftward. The second left rail portion 50 is integrated with the first right rail portion 40. The second left rail portion 50 extends upward from the upper surface 34a of the first pyramidal base 34, and then bends to extend rightward. The second left rail portion 50 is opposite the second right rail portion 48 in the left-right direction. The second connection portion 52 connects a front end of the second right rail portion 48 with a front end of the second left rail portion 50.

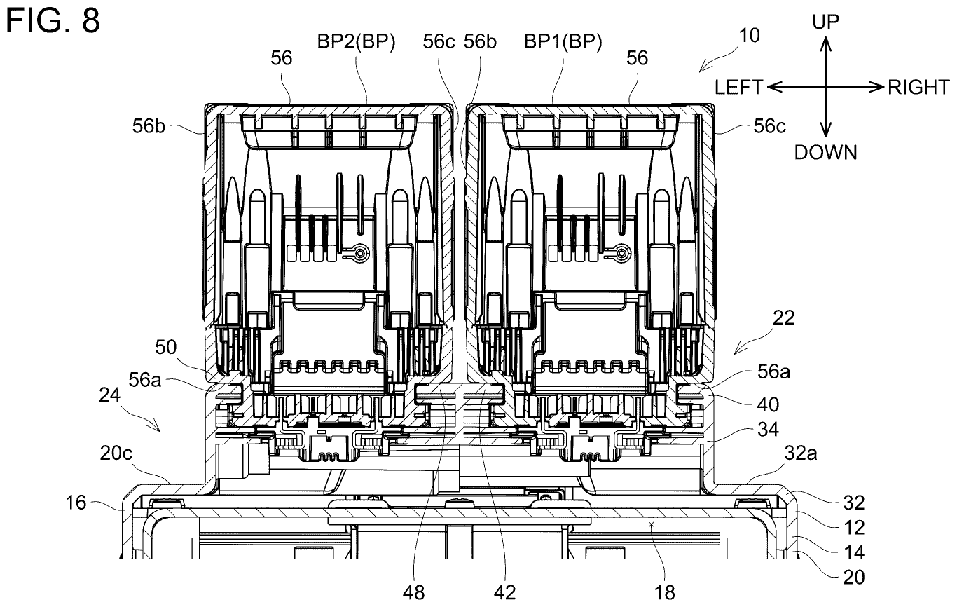

As shown in FIG. 8, the first battery pack BP1 is attached to the first battery receptacle 22. The second battery pack BP2 is attached to the second battery receptacle 24. In the present embodiment, the configuration of the first battery pack BP1 is identical to that of the second battery pack BP2. For this reason, the first battery pack BP1 is exemplified below.

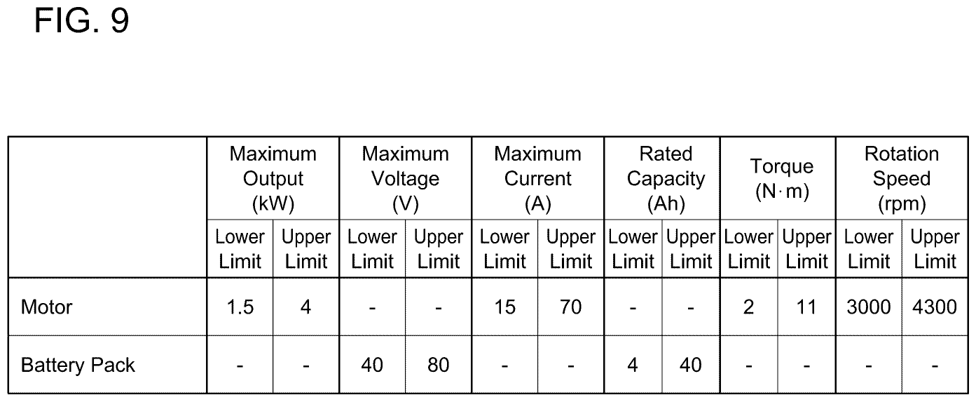

The first battery pack BP1 includes a rechargeable battery that can be charged and discharged, for example, a lithium-ion battery. As shown in FIG. 5, the weight of the first battery pack BP1 is equal to or more than 0.6 kg and equal to or less than 2 kg. The length of the first battery pack BP1 in the front-rear direction is equal to or more than 115 mm and equal to or less than 155 mm. The length of the first battery pack BP1 in the left-right direction is equal to or more than 75 mm and equal to or less than 85 mm. The length of the first battery pack BP1 in the up-down direction is equal to or more than 65 mm and equal to or less than 115 mm. The volume of the first battery pack BP1 is equal to or more than 500 cm³ and equal to or less than 1500 cm³. As shown in FIG. 9, a maximum voltage value of the first battery pack BP1 is equal to or more than 40 V and equal to or less than 80 V. A rated capacity of the first battery pack BP1 is equal to or more than 4 Ah and equal to or less than 40 Ah. In a variant, the configuration of the first battery pack BP1 (i.e., dimensions, maximum voltage value, and rated capacity) may be different from the configuration of the second battery pack BP2 (i.e., dimensions, maximum voltage value, and rated capacity).

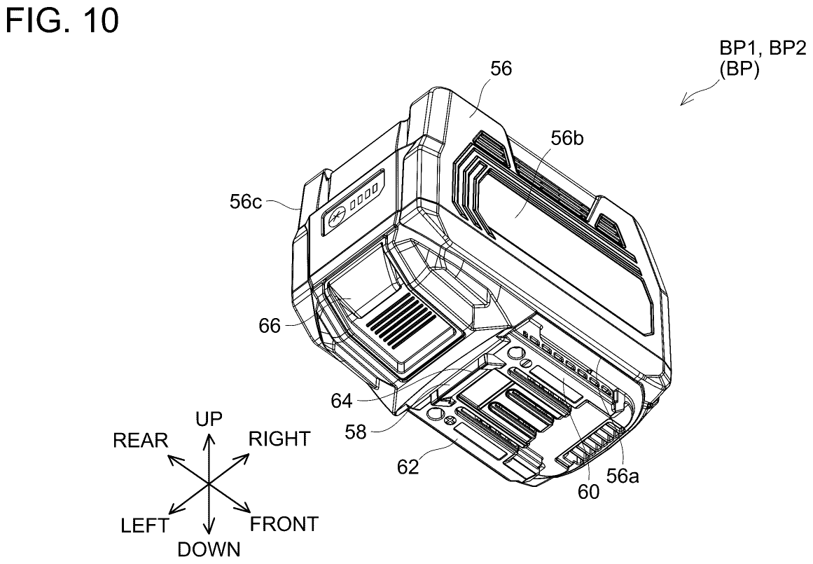

As shown in FIG. 10, the first battery pack BP1 has a battery housing 56, a hook 58, a right battery rail 60, and a left battery rail 62. The battery housing 56 houses rechargeable secondary battery cells, e.g., lithium-ion battery cells therein.

The hook 58 is movably attached to a lower surface 56a of the battery housing 56. The hook 58 has an engagement portion 64 and an operation portion 66. The engagement portion 64 is, for example, an engagement claw. The engagement portion 64 typically protrudes outside of the battery housing 56. When the operation portion 66 is pushed into the battery housing 56, the entire engagement portion 64 moves into the interior of the battery housing 56.

The right battery rail 60 and left battery rail 62 protrude from the lower surface 56a of the battery housing 56. The right battery rail 60 and the left battery rail 62 extend in the front-rear direction. The right battery rail 60 is arranged side-by-side with the left battery rail 62 in the left-right direction. With respect to the left-right direction, the engagement portion 64 is positioned between the right battery rail 60 and the left battery rail 62. The right battery rail 60 extends downward from the lower surface 56a of the battery housing 56, then bends to extend rightward. The left battery rail 62 extends downward from the lower surface 56a of the battery housing 56, then bends to extend leftward.

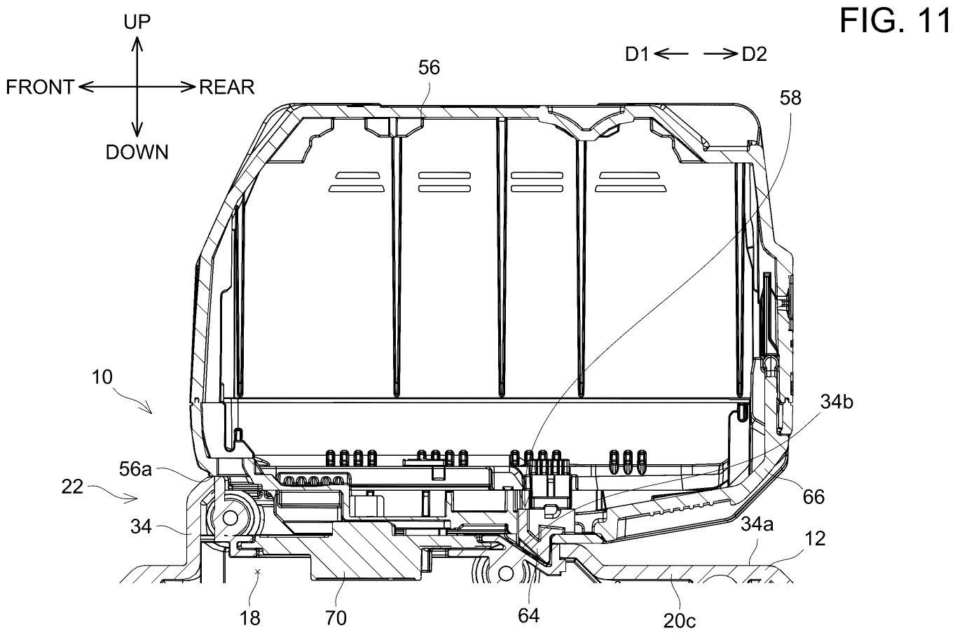

As shown in FIG. 11, when the first battery pack BP1 is slid in an attaching direction D1, the first battery pack BP1 is guided by the first right rail portion 40 (see FIG. 7) and the first left rail portion 42 (see FIG. 7) and slides on the upper surface 34a of the first pyramidal base 34. The attaching direction D1 is directed frontward. As a result, the right battery rail 60 (see FIG. 10) is slidably engaged with the first right rail portion 40, and the left battery rail 62 (see FIG. 10) is slidably engaged with the first left rail portion 42. When the first battery pack BP1 slides on the upper surface 34a and the engagement portion 64 contacts the upper surface 34a, the engagement portion 64 is pushed into the battery housing 56 by the upper surface 34a. The upper surface 34a has a recessed groove 34b recessed from the upper surface 34a. When the engagement portion 64 reaches the recessed groove 34b, it exits out from inside the battery housing 56 and engages with the upper surface 34a in the recessed groove 34b. Due to this, the first battery pack BP1 is attached to the first battery receptacle 22. When the operation portion 66 is pushed in, the engagement portion 64 slips out of the recessed groove 34b, so that the first battery pack BP1 is removed from the first battery receptacle 22 by sliding the first battery pack BP1 in a detaching direction D2. The detaching direction D2 is opposite to the attaching direction D1 and is directed rearward. Although omitted in the drawings, an attaching direction for attaching the second battery pack BP2 to the second battery receptacle 24 is the same as the attaching direction D1. A detaching direction for removing the second battery pack BP2 from the second battery receptacle 24 is the same as the detaching direction D2.

As shown in FIG. 8, when the first battery pack BP1 is attached to the first battery receptacle 22 and the second battery pack BP2 is attached to the second battery receptacle 24, the lower surface 56a of the battery housing 56 of the first battery pack BP1 is in contact with the first battery receptacle 22 from above, and the lower surface 56a of the battery housing 56 of the second battery pack BP2 is in contact with the second battery receptacle 24 from above. A left side surface 56b of the battery housing 56 of the first battery pack BP1 is opposite a right side surface 56c of the battery housing 56 of the second battery pack BP2 in the left-right direction. The left side surface 56b of the battery housing 56 of the first battery pack BP1 is substantially parallel to the right side surface 56c of the battery housing 56 of the second battery pack BP2.

There is no wall including the accommodating part 20 between the left side surface 56b of the battery housing 56 of the first battery pack BP1 and the right side surface 56c of the battery housing 56 of the second battery pack BP2. A distance between the left side surface 56b of the battery housing 56 of the first battery pack BP1 and the right side surface 56c of the battery housing 56 of the second battery pack BP2 is equal to or less than 175 mm. In a variant, the distance between the left side surface 56b of the battery housing 56 of the first battery pack BP1 and the right side surface 56c of the battery housing 56 of the second battery pack BP2 may be equal to or less than 350 mm.

As shown in FIG. 7, the motor unit 10 has a first battery terminal 70, a second battery terminal 72, a main power switch 74, a display panel 76, an operation switch 78a, and a speed change switch 78b. The first battery terminal 70 and the second battery terminal 72 are disposed on the upper surface 34a of the first pyramidal base 34. The first battery terminal 70 is surrounded by the first battery receptacle 22. The first battery terminal 70 comprises a plurality of first terminal members 79. The first terminal members 79 are electrically connected to terminal members (not shown) of the first battery pack BP1 when the first battery pack BP1 is attached to the first battery receptacle 22.

The second battery terminal 72 is surrounded by the second battery receptacle 24. The second battery terminal 72 comprises a plurality of second terminal members 80. The second terminal members 80 are electrically connected to the terminal members (not shown) of the second battery pack BP2 when the second battery pack BP2 is attached to the second battery receptacle 24. In the present embodiment, when the first battery pack BP1 is attached to the first battery receptacle 22 and the second battery pack BP2 is attached to the second battery receptacle 24, the first battery pack BP1 and the second battery pack BP2 are electrically connected in series. In a variation, the second terminal members 80 may be electrically connected in parallel with the first terminal members 79.

The main power switch 74 and the display panel 76 are disposed on the second pyramidal base 36. The main power switch 74 is configured to switch the motor unit 10 between on and off states. The display panel 76 lights up when the motor unit 10 is in an on state.

An operation switch 78a is disposed behind the main power switch 74 and the display panel 76. The operation switch 78a is a rocker switch. When a right portion of the operation switch 78a is pushed into the body housing 12, a left portion of the operation switch 78a exits out from inside the body housing 12, and when the left portion of the operation switch 78a is pushed into the body housing 12, the right portion of the operation switch 78a exits out from inside the body housing 12. When the left portion of the operation switch 78a is pushed into the body housing 12 when the motor unit 10 is on, the motor unit 10 operates. While the motor unit 10 is operating, when the right portion of the operation switch 78a is pushed into the body housing 12, the motor unit 10 stops.

The speed change switch 78b is disposed on the second pyramidal base 36. The speed change switch 78b is disposed on a left side of the display panel 76. The speed change switch 78b changes the rotation speed of the motor 86, which will be described later.

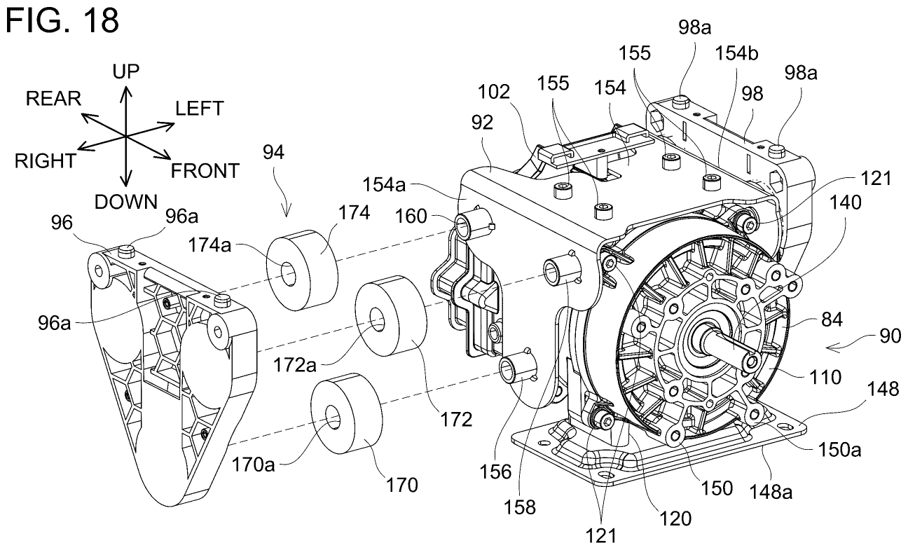

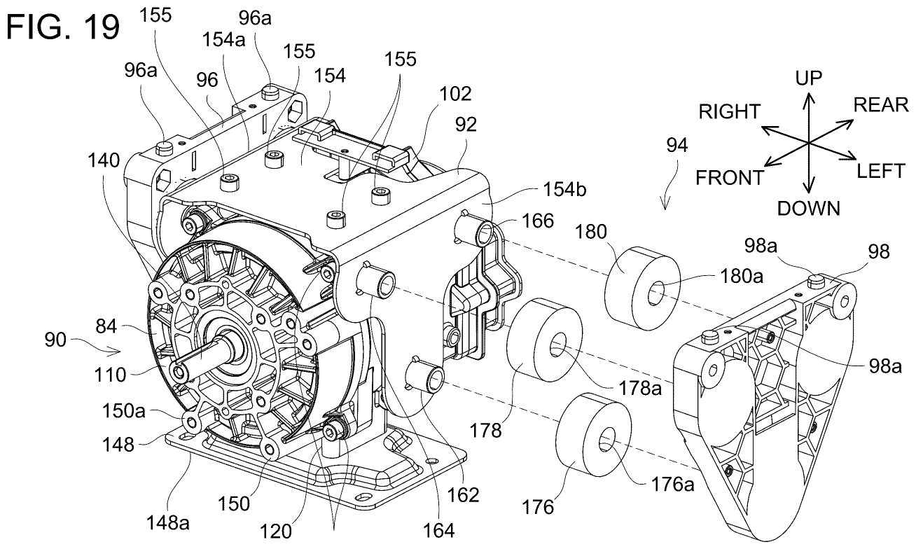

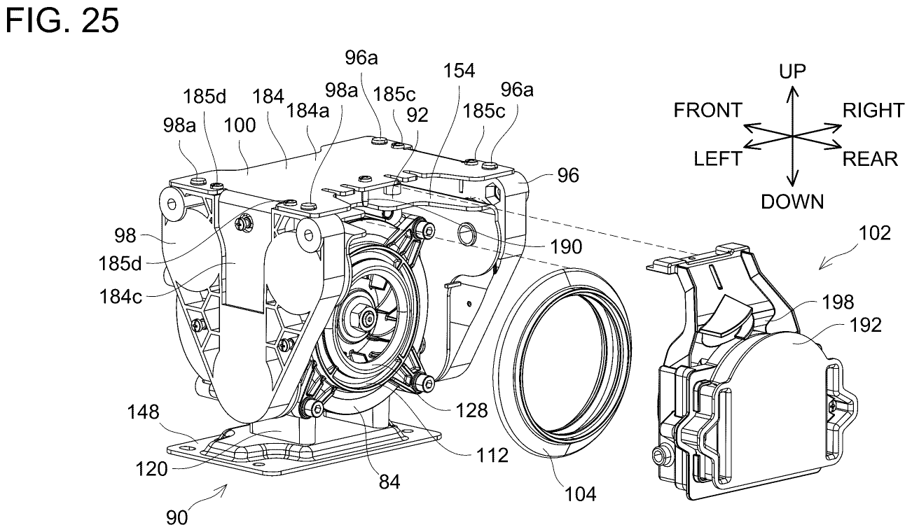

As shown in FIG. 12, motor unit 10 has the motor housing 84, the motor 86 (see FIG. 16), the fan 88 (see FIG. 16), a fixing unit 90, a plate member 92, a vibration-proof part 94 (see FIGS. 18 and 19), a right cover member 96, a left cover member 98, a support unit 100, a control unit 102 (see FIG. 25), and a tubular vibration-proof member 104 (see FIG. 25).

As shown in FIG. 13, the motor housing 84 is surrounded by the accommodating part 20. The accommodating part 20 is disposed outside of the motor housing 84. The motor housing 84 houses the motor 86 and the fan 88 therein. The motor housing 84 has a motor housing body 108, a front bracket 110, and a rear bracket 112.

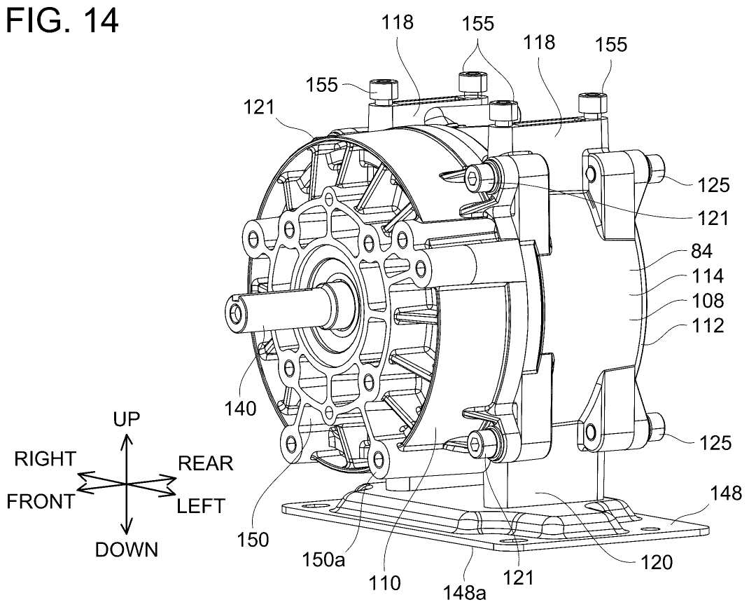

The motor housing body 108 has a tube portion 114, a bulkhead portion 116, a screw boss portion 118 (see FIG. 14), and a leg portion 120. The tube portion 114 has a cylindrical shape. The bulkhead portion 116 extends radially inward from an inner surface of the tube portion 114 toward a center of the tube portion 114. As shown in FIG. 14, the screw boss portion 118 protrudes upward from a top of the tube portion 114. The leg portion 120 protrudes downward from a bottom of the tube portion 114. As shown in FIG. 13, the leg portion 120 penetrates the second opening 28.

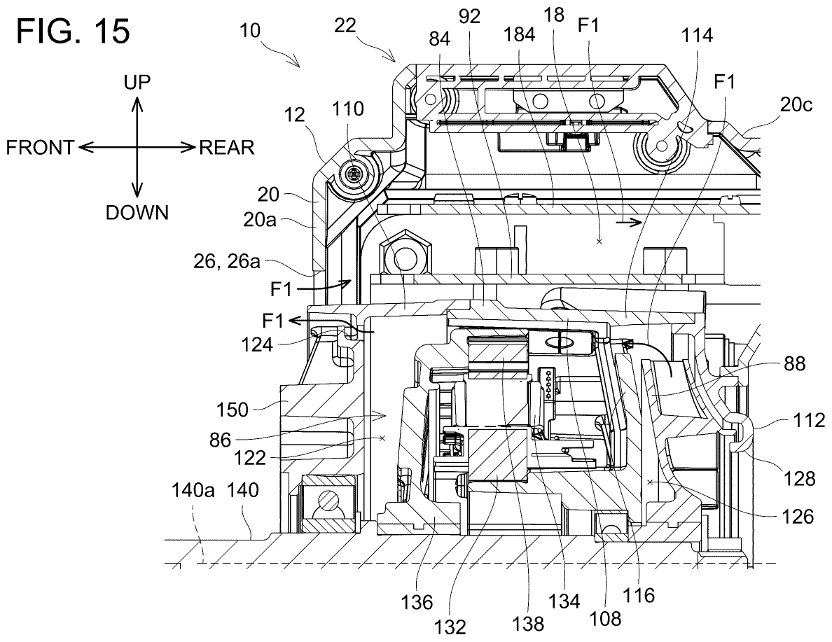

The front bracket 110 is fixed to a front end of the motor housing body 108 by screws 121 (see FIG. 14). A motor accommodating space 122 is defined by the front bracket 110, the tube portion 114, and a front surface of the bulkhead portion 116. The front bracket 110 penetrates the first opening 26 of the body housing 12. The front bracket 110 is separated away from an outer edge of the first opening 26. The front bracket 110 and the outer edge of the first opening 26 define an air intake port 26a. The air intake port 26a is a portion of the first opening 26. The air intake port 26a connects the accommodating space 18 of the body housing 12 to the outside of the body housing 12. As shown in FIG. 15, the front bracket 110 has an exhaust port 124. The exhaust port 124 penetrates the front bracket 110 in the front-rear direction. The exhaust port 124 connects the motor accommodating space 122 to the outside of the motor housing 84.

As shown in FIG. 16, the rear bracket 112 is fixed to a rear end of the motor housing body 108 by screws 125 (see FIG. 14). A fan accommodating space 126 is defined by the rear bracket 112, the tube portion 114, and a rear surface of the bulkhead portion 116. The rear bracket 112 has a motor intake port 128. The motor intake port 128 passes through the rear bracket 112 in the front-rear direction. The motor intake port 128 connects the fan accommodating space 126 to the outside of the motor housing 84.

The motor 86 is disposed in a motor accommodating space 122. The motor 86 is, for example, a DC motor. In a variant, the motor 86 may be an AC motor. The motor 86 is an outer rotor brushless motor. In a variant, the motor 86 may be an inner rotor brushless motor or a brushed motor. The motor 86 operates when the left portion of the operation switch 78a (see FIG. 7) is pushed into the body housing 12 when the motor unit 10 is in the on state. The motor 86 is operated by electric power supplied from the battery packs BP.

As shown in FIG. 5, a weight of motor 86 is equal to or more than 2 kg and equal to or less than 3 kg. A length of the motor 86 in the front-rear direction is equal to or more than 140 mm and equal to or less than 145 mm. A volume of the motor 86 is equal to or more than 650 cm³ and equal to or less than 750 cm³. A diameter of the motor 86 is equal to or more than 80 mm and equal to or less than or equal to 145 mm. As shown in FIG. 9, a maximum output value of the motor 86 is equal to or more than 1.5 kW and equal to or less than 4 kW. In a variant, the maximum output value of the motor 86 may be equal to or more than 1.5 kW and equal to or less than 3 kW, or equal to or more than 1.5 kW and equal to or less than 2.35 kW. A maximum current value of the motor 86 is equal to or more than 15 A and equal to or less than 70 A. A torque of the motor 86 is equal to or more than 2 Nm and equal to or less than 11 Nm. In a variant, the torque of the motor 86 may be equal to or more than 3 Nm and equal to or less than 8 Nm. A speed of the motor 86 is equal to or more than 3000 rpm and equal to or less than 4300 rpm.

As shown in FIG. 16, the motor 86 has a stator body 132, a coil 134, an outer rotor body 136, a plurality of permanent magnets 138, and a motor shaft 140. The coil 134 is wound around the stator body 132. The outer rotor body 136 is arranged to surround an outer circumference of the stator body 132. A diameter of the outer rotor body 136 is approximately the same as the diameter of the motor 86. Each permanent magnet 138 is fixed to the outer rotor body 136.

The motor shaft 140 is fixed to the outer rotor body 136. The motor shaft 140 extends along the placement surface P1 when the motor unit 10 is placed on the placement surface P1. The motor shaft 140 penetrates the stator body 132. The motor shaft 140 penetrates the bulkhead portion 116. The motor shaft 140 is rotatably supported by the bulkhead portion 116 via a bearing 142. The motor shaft 140 penetrates the front bracket 110. The motor shaft 140 is rotatably supported on the front bracket 110 via a bearing 144. The motor shaft 140 rotates around a central axis 140a.

The fan 88 is fixed to a rear end of the motor shaft 140. The fan 88 is disposed in the fan accommodating space 126. In the present embodiment, the fan 88 is a centrifugal fan. In a variant, the fan 88 may be an axial fan. The fan 88 rotates in unison with the motor shaft 140.

The fixing unit 90 has a first fixing part 148 and a second fixing part 150. The first fixing part 148 is fixed to a lower end of the leg portion 120 by screws 152. The first fixing part 148 has a first fixing surface 148a. The first fixing surface 148a corresponds to a lower surface of the first fixing part 148. The first fixing surface 148a is substantially parallel to the motor shaft 140. When the motor unit 10 is placed on the placement surface P1, the first fixing surface 148a contacts the placement surface P1. The first fixing surface 148a is fixed to the working unit 4 (see FIG. 3).

As shown in FIG. 13, the first fixing part 148 is disposed below the motor 86. The motor 86 is positioned between the first fixing part 148 and the first battery receptacle 22. Further, the motor 86 is disposed between the first fixing part 148 and the second battery receptacle 24 (see FIG. 12).

As shown in FIG. 16, the second fixing part 150 is formed on the front bracket 110. The second fixing part 150 has a second fixing surface 150a. The second fixing surface 150a corresponds to a front surface of the second fixing part 150. When the motor unit 10 is placed on the placement surface P1, the second fixing surface 150a is perpendicular to the placement surface P1. The second fixing surface 150a is substantially perpendicular to the first fixing surface 148a. The second fixing surface 150a is substantially perpendicular to the motor shaft 140. The second fixing surface 150a is fixed to the working unit 4 (see FIG. 2). The type of the working unit 4 configured to be fixed to the second fixing surface 150a is different from the type of the working unit 4 configured to be fixed to the first fixing surface 148a.

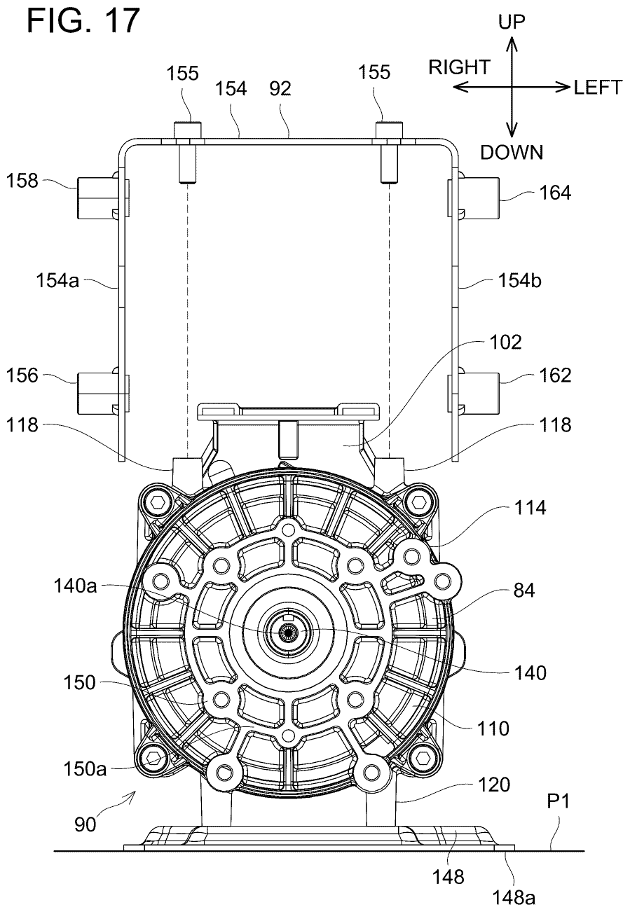

As shown in FIG. 17, the plate member 92 has a plate body 154. The plate body 154 is formed by bending a single plate. The plate body 154 has a substantially U-shape. The plate body 154 is fixed to the screw boss portion 118 by screws 155. The plate body 154 faces the top, a right portion, and a left portion of the tube portion 114.

As shown in FIGS. 18 and 19, the plate member 92 has a first right sleeve 156, a second right sleeve 158, a third right sleeve 160, a first left sleeve 162, a second left sleeve 164, and a third left sleeve 166. The first right sleeve 156 has a cylindrical shape. A shape of the second right sleeve 158, a shape of the third right sleeve 160, a shape of the first left sleeve 162, a shape of the second left sleeve 164, and a shape of the third left sleeve 166 are identical to the shape of the first right sleeve 156.

As shown in FIG. 18, the first right sleeve 156, the second right sleeve 158, and the third right sleeve 160 project rightward from a right wall 154a of the plate body 154. The first right sleeve 156 is disposed at a bottom of the right wall 154a. The second right sleeve 158 is disposed at a front upper portion of the right wall 154a. The third right sleeve 160 is disposed at a rear upper portion of the right wall 154a.

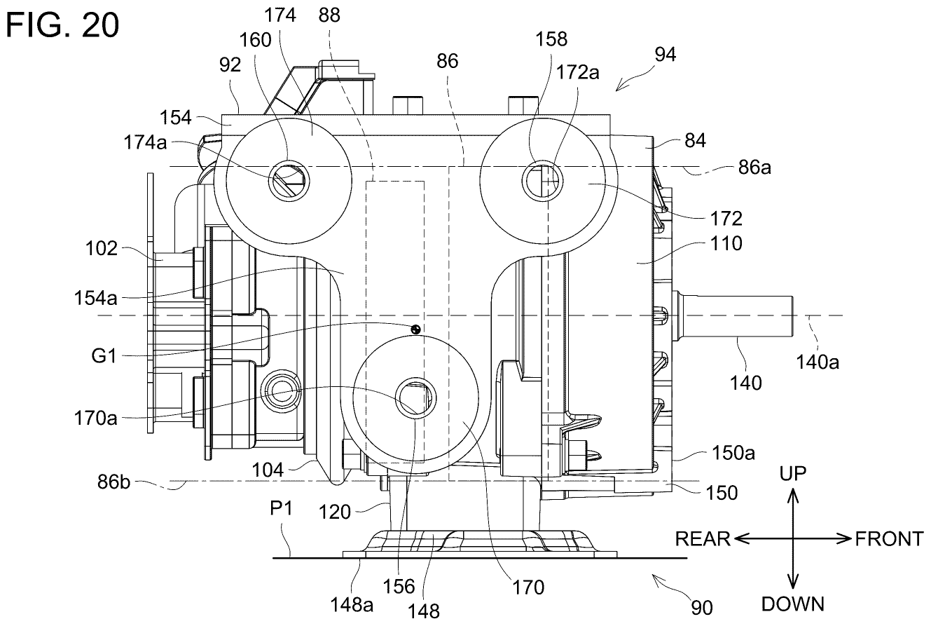

As shown in FIG. 20, the first right sleeve 156 is disposed below the central axis 140a of the motor shaft 140. The second right sleeve 158 and the third right sleeve 160 are positioned above the central axis 140a of the motor shaft 140. A position of the second right sleeve 158 in the up-down direction is identical to a position of the third right sleeve 160 in the up-down direction. With respect to the front-rear direction, the first right sleeve 156 is positioned in the center between the second right sleeve 158 and the third right sleeve 160. A distance between the first right sleeve 156 and the second right sleeve 158 is identical to a distance between the second right sleeve 158 and the third right sleeve 160 and to a distance between the third right sleeve 160 and the first right sleeve 156, respectively.

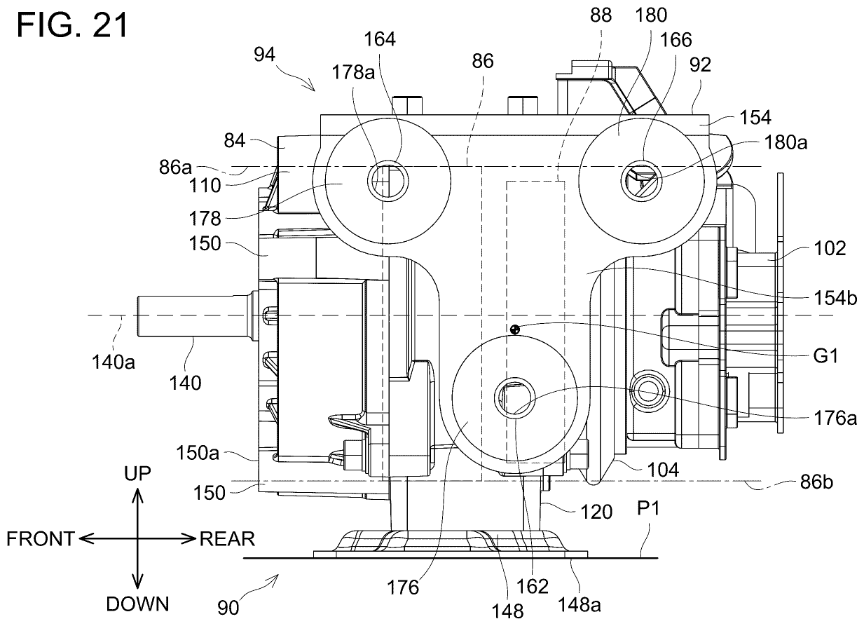

As shown in FIG. 19, the first left sleeve 162, the second left sleeve 164, and the third left sleeve 166 project leftward from a left wall 154b of the plate body 154. A position of the first left sleeve 162 in the up-down and front-rear directions is identical to a position of the first right sleeve 156 in the up-down and front-rear directions. A position of the second left sleeve 164 in the up-down and front-rear directions is identical to a position of the second right sleeve 158 in the up-down and front-rear directions. A position of the third left sleeve 166 in the up-down and front-rear directions is identical to a position of the third right sleeve 160 in the up-down and front-rear directions. As shown in FIG. 21, a distance between the first left sleeve 162 and the second left sleeve 164 is substantially identical to a distance between the second left sleeve 164 and the third left sleeve 166 and to a distance between the third left sleeve 166 and the first left sleeve 162, respectively. Further, the distance between the first left sleeve 162 and the second left sleeve 164 is substantially identical to a distance between the first right sleeve 156 (see FIG. 20) and the second right sleeve 158 (see FIG. 20).

As shown in FIGS. 18 and 19, the vibration-proof part 94 has a first right vibration-proof member 170, a second right vibration-proof member 172, a third right vibration-proof member 174, a first left vibration-proof member 176, a second left vibration-proof member 178, and a third left vibration-proof member 180. The first right vibration-proof member 170 has a cylindrical shape. The first right vibration-proof member 170 is constituted of an elastic material. The first right vibration-proof member 170 is constituted of, for example, a foam, a rubber material, a thermoplastic elastomer material, or a thermosetting elastomer material. Shapes of the second right vibration-proof member 172, the third right vibration-proof member 174, the first left vibration-proof member 176, the second left vibration-proof member 178, and the third left vibration-proof member 180 are the same as that of the first right vibration-proof member 170. Materials of the second right vibration-proof member 172, the third right vibration-proof member 174, the first left vibration-proof member 176, the second left vibration-proof member 178, the third left vibration-proof member 180 are the same as the material of the first right vibration-proof member 170.

As shown in FIG. 18, the first right sleeve 156 is inserted into an opening 170a of the first right vibration-proof member 170. The second right sleeve 158 is inserted into an opening 172a of the second right vibration-proof member 172. The third right sleeve 160 is inserted into an opening 174a of the third right vibration-proof member 174. The first right vibration-proof member 170 protrudes to the right of the first right sleeve 156 when in contact with the right wall 154a of the plate body 154. The second right vibration-proof member 172 protrudes to the right of the second right sleeve 158 when in contact with the right wall 154a of the plate body 154. The third right vibration-proof member 174 protrudes to the right of the third right sleeve 160 when in contact with the right wall 154a of the plate body 154. As shown in FIG. 20, the first right vibration-proof member 170 is positioned below a center of gravity G1 of the motor unit 10. The center of gravity G1 of the motor unit 10 is the center of gravity when the battery packs BP are not mounted. The second right vibration-proof member 172 and the third right vibration-proof member 174 are disposed above the center of gravity G1 of the motor unit 10. A distance between the first right vibration-proof member 170 and the second right vibration-proof member 172 is substantially identical to a distance between the second right vibration-proof member 172 and the third right vibration-proof member 174 and to a distance between the third right vibration-proof member 174 and the first right vibration-proof member 170, respectively. With respect to the front-rear direction, a center position of the first right vibration-proof member 170 is substantially identical to the position of the center of gravity G1 of the motor unit 10.

As shown in FIG. 19, the first left sleeve 162 is inserted into an opening 176a of the first left vibration-proof member 176. The first left vibration-proof member 176 is positioned below the center of gravity G1 of the motor unit 10. The second left sleeve 164 is inserted into an opening 178a of the second left vibration-proof member 178. The third left sleeve 166 is inserted into an opening 180a of the third left vibration-proof member 180. The second left vibration-proof member 178 and the third left vibration-proof member 180 are positioned above the center of gravity G1 of the motor unit 10. The first left vibration-proof member 176 protrudes to the left of the first left sleeve 162 when in contact with the left wall 154b of the plate body 154. The second left vibration-proof member 178 protrudes to the left of the second left sleeve 164 when in contact with the left wall 154b of the plate body 154. The third left vibration-proof member 180 protrudes to the left of the third left sleeve 166 when in contact with the left wall 154b of the plate body 154. As shown in FIG. 21, a distance between the first left vibration-proof member 176 and the second left vibration-proof member 178 is substantially identical to a distance between the second left vibration-proof member 178 and the third left vibration-proof member 180 and a distance between the third left vibration-proof member 180 and the first left vibration-proof member 176, respectively. Further, the distance between the first left vibration-proof member 176 and the second left vibration-proof member 178 is substantially identical to a distance between the first right vibration-proof member 170 (see FIG. 20) and the second right vibration-proof member 172 (see FIG. 20). With respect to the front-rear direction, a center position of the first left-vibration-proof member 176 is substantially identical to the position of the center of gravity G1 of the motor unit 10.

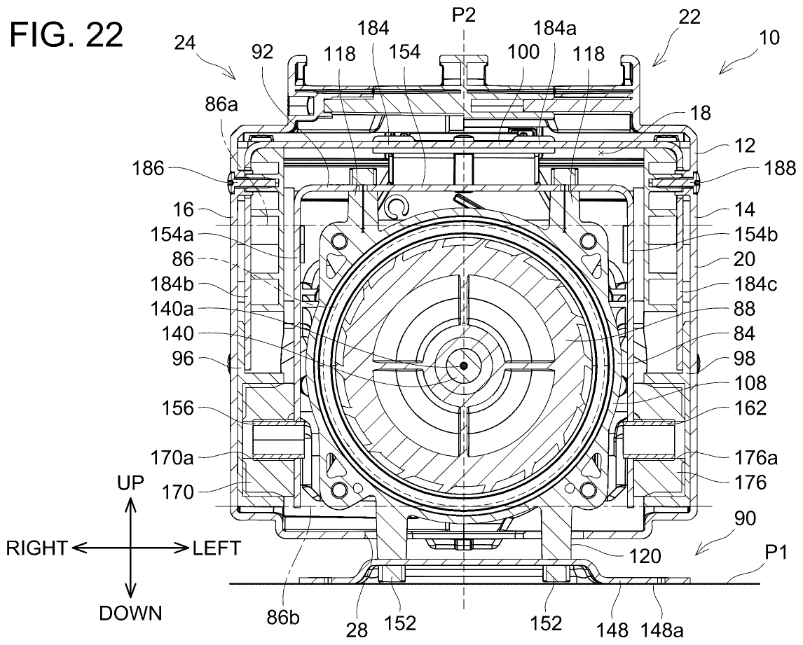

As shown in FIG. 22, when the motor unit 10 is placed on the placement surface P1, the first right vibration-proof member 170 and the first left vibration-proof member 176 are positioned below an upper end 86a of the motor 86. The upper end 86a of the motor 86 is substantially the same as an upper end of the outer rotor body 136. In FIGS. 20 through 23, a position of the upper end 86a of the motor 86 in the up-down direction is illustrated by a single dotted line. The first right vibration-proof member 170 and the first left vibration-proof member 176 are positioned below the central axis 140a of the motor shaft 140. The first right vibration-proof member 170 and the first left vibration-proof member 176 are disposed above a lower end 86b of the motor 86. The lower end 86b of the motor 86 is substantially the same as a lower end of the outer rotor body 136. In FIGS. 20 through 23, a position of the lower end 86b of the motor 86 in the up-down direction is illustrated by a single dotted line. The first right vibration-proof member 170 is disposed plane-symmetrical with the first left vibration-proof member 176 with respect to a perpendicular plane P2 perpendicular to the placement surface P1 and including the central axis 140a of the motor shaft 140 (i.e., front-rear direction). A distance between the first right vibration-proof member 170 and the perpendicular plane P2 is substantially identical to a distance between the first left vibration-proof member 176 and the perpendicular plane P2. When the motor unit 10 is viewed along the front-rear direction, the motor 86 and the fan 88 are positioned between the first right vibration-proof member 170 and the first left vibration-proof member 176. When the motor unit 10 is viewed along the left-right direction, each of the motor 86 and the fan 88 at least partially overlaps the first right vibration-proof member 170 and the first left vibration-proof member 176 (see FIG. 21).

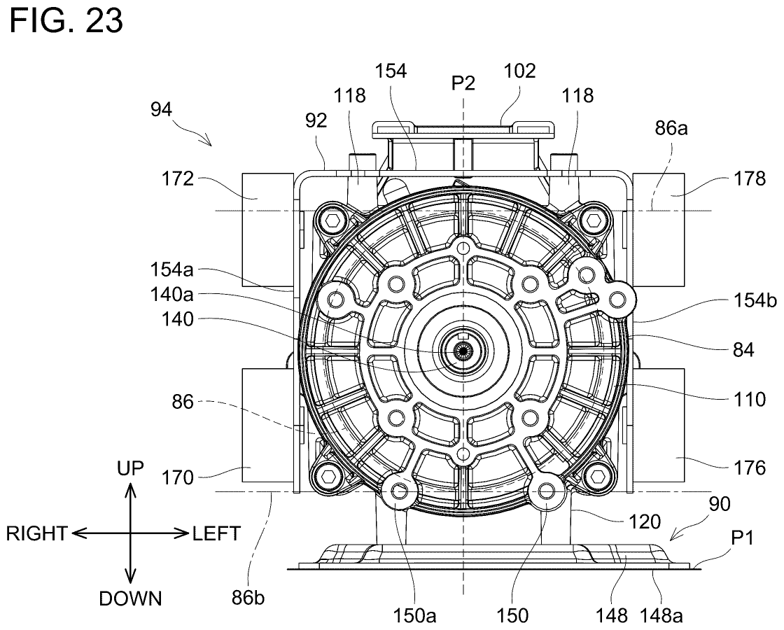

As shown in FIG. 23, when the motor unit 10 is placed on the placement surface P1, the second right vibration-proof member 172 and the second left vibration-proof member 178 are disposed above the lower end 86b of the motor 86. The second right vibration-proof member 172 and the second left vibration-proof member 178 are positioned above the lower end 86b of the motor 86. The second right vibration-proof member 172 and the second left vibration-proof member 178 are positioned above the central axis 140a of the motor shaft 140. A center of the second right vibration-proof member 172 in the up-down direction and a center of the second left vibration-proof member 178 in the up-down direction are disposed below the upper end 86a of the motor 86. An upper end of the second right vibration-proof member 172 and an upper end of the second left vibration-proof member 178 are disposed above the upper end 86a of the motor 86. The second right vibration-proof member 172 is positioned plane-symmetrical with the second left vibration-proof member 178 with respect to the perpendicular plane P2. A distance between the second right vibration-proof member 172 and the perpendicular plane P2 is substantially the same as a distance between the second left vibration-proof member 178 and the perpendicular plane P2. When the motor unit 10 is viewed along the front-rear direction, the motor 86 and the fan 88 (see FIG. 22) are disposed between the second right vibration-proof member 172 and the second left vibration-proof member 178. When the motor unit 10 is viewed along the front-rear direction, an entirety of the second right vibration-proof member 172 overlaps an entirety of the third right vibration-proof member 174 (see FIG. 20), and an entirety of the second left vibration-proof member 178 overlaps an entirety of the third left vibration-proof member 180 (see FIG. 21). With respect to the perpendicular plane P2, the third right vibration-proof member 174 is arranged in plane symmetry with the third left vibration-proof member 180. Further, when the motor unit 10 is viewed along the front-rear direction, the motor 86 and the fan 88 are positioned between the third right vibration-proof member 174 and the third left vibration-proof member 180.

When the motor unit 10 is viewed along the left-right direction, the motor 86 is positioned between the second right vibration-proof member 172 and the second left vibration-proof member 178 (see FIG. 21). Further as shown in FIG. 20, also the second right vibration-proof member 172 and the second left vibration-proof member 178 are disposed frontward of the fan 88. Moreover, the third right vibration-proof member 174 and the third left vibration-proof member 180 (see FIG. 21) are positioned rearward of the fan 88.

As shown in FIG. 18, the right cover member 96 is disposed on a right side of the right wall 154a of the plate body 154. The first right vibration-proof member 170, the second right vibration-proof member 172, and the third right vibration-proof member 174 are interposed between the right cover member 96 and the right wall 154a of the plate body 154. The right cover member 96 is attached to the plate body 154 via the first right vibration-proof member 170, the second right vibration-proof member 172, and the third right vibration-proof member 174. The right cover member 96 is not in contact with the plate member 92. As shown in FIG. 12, the right cover member 96 is positioned between the right body housing 14 and the right wall 154a of the plate body 154. The right cover member 96 is fixed to the right body housing 14. This suppresses the first right vibration-proof member 170 (see FIG. 18), the second right vibration-proof member 172 (see FIG. 18), and the third right vibration-proof member 174 (see FIG. 18) from being detached from the plate member 92.

As shown in FIG. 19, the left cover member 98 is disposed on the left side of the left wall 154b of the plate body 154. The first left vibration-proof member 176, the second left vibration-proof member 178, and the third left vibration-proof member 180 are interposed between the left cover member 98 and the left wall 154b of the plate body 154. The left cover member 98 is attached to the plate body 154 via the first left vibration-proof member 176, the second left vibration-proof member 178, and the third left vibration-proof member 180. The left cover member 98 is not in contact with the plate member 92. As shown in FIG. 12, the left cover member 98 is positioned between the left body housing 16 and the left wall 154b of the plate body 154. The left cover member 98 is fixed to the left body housing 16. This suppresses the first left vibration-proof member 176 (see FIG. 19), the second left vibration-proof member 178 (see FIG. 19), and the third left vibration-proof member 180 (see FIG. 19) from detaching from the plate member 92.

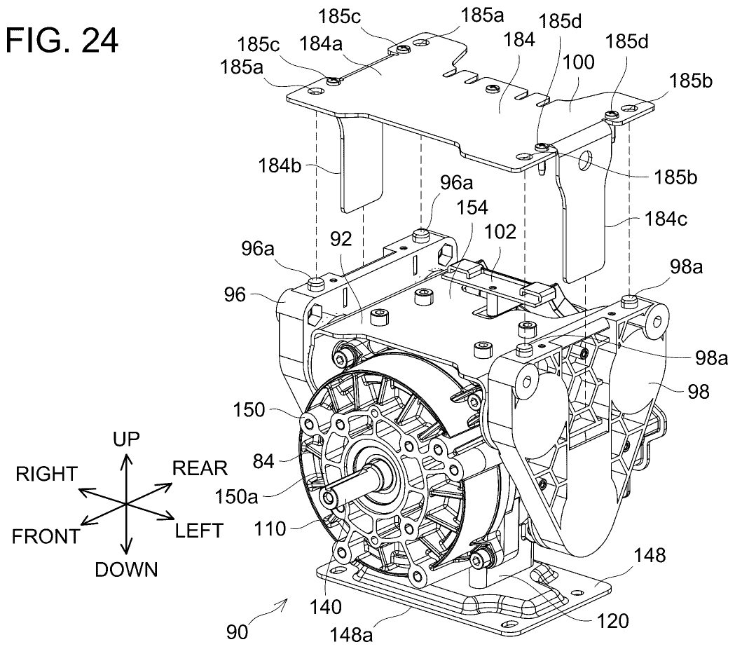

As shown in FIG. 24, the support unit 100 comprises a support plate 184. The support plate 184 is formed by bending a single plate. The support plate 184 has a substantially U-shape. The support plate 184 comprises an upper wall 184a facing an upper surface of the plate body 154 of the plate member 92, a right wall 184b facing a right surface of the right cover member 96, and a left wall 184c facing a left surface of the left cover member 98. The plate member 92, the right cover member 96, and the left cover member 98 are interposed between the right wall 184b and the left wall 184c.

The upper wall 184a has two right positioning holes 185a and two left positioning holes 185b. The right positioning holes 185a penetrate the upper wall 184a in the up-down direction. The right positioning holes 185a are disposed at a right end of the upper wall 184a. The two right positioning holes 185a are aligned in the front-rear direction. The left positioning holes 185b penetrate the upper wall 184a in the up-down direction. The left positioning holes 185b are disposed at a left end of the upper wall 184a. The two left positioning holes 185b are aligned in the front-rear direction.

The right cover member 96 comprises two right positioning projections 96a projecting upward, and the right positioning holes 185a receive these right positioning projections 96a. The left cover member 98 comprises two left positioning projections 98a projecting upward, and the left positioning holes 185b receive these left positioning projections 98a. Due to this, the support plate 184 is positioned relative to the right cover member 96 and the left cover member 98. The support plate 184 is fixed to the right cover member 96 by screws 185c. The support plate 184 is fixed to the left cover member 98 by screws 185d.

As shown in FIG. 22, the right wall 184b is interposed between the right surface of the right cover member 96 and the right body housing 14. The right wall 184b, the right cover member 96, and the right body housing 14 are fixed to each other with screws 186. The left wall 184c is interposed between the left surface of the left cover member 98 and the left body housing 16. The left wall 184c, the left cover member 98, and the left body housing 16 are fixed to each other with screws 188.

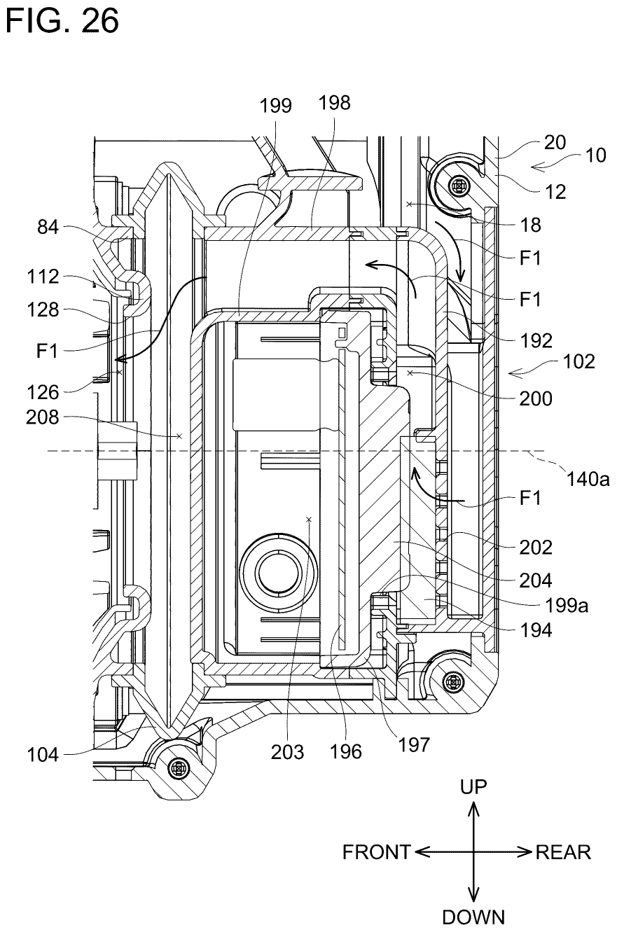

As shown in FIG. 25, the control unit 102 is disposed behind the motor housing 84. The control unit 102 is disposed inside the body housing 12 (see FIG. 4). The control unit 102 comprises a board housing 192, a filter member 194 (see FIG. 26), a control circuit board 196 (see FIG. 26), and a board case 197 (see FIG. 26). The board housing 192 comprises an outer housing part 198 and an inner housing part199 (see FIG. 26). The outer housing part198 defines an external shape of the control unit 102. The outer housing part 198 is fixed to a rear end of the support plate 184 by screws 190. As shown in FIG. 26, the outer housing part198 has an interior space 200. Further, the outer housing part198 has an intake port 202. The intake port 202 is disposed at a rear portion of the outer housing part198. The intake port 202 connects the interior space 200 to the outside of the board housing 192.

The inner housing part199 is disposed in the interior space 200. The inner housing part199 is disposed in front of the intake port 202. The inner housing part199 is fixed to the outer housing part198. The inner housing part199 has a board accommodating space 203 therein.

The filter member 194 is disposed in the interior space 200. The filter member 194 is disposed in front of the intake port 202. The filter member 194 blocks the intake port 202. The filter member 194 has fine vent holes (not shown) therein. The filter member 194 is constituted of, for example, filter material or foam material. Air flows through the filter member 194 through the vent holes. As the air flows through the vent holes, the filter member 194 removes dust and other foreign matters contained in the flowing air.

The control circuit board 196 is disposed in the board accommodating space 203. The control circuit board 196 has a microcontroller and a plurality of switching elements. The switching elements are, for example, IGBTs or MOSFETs. The switching elements are switched between an on state and an off state by being controlled by the microcontroller. The control circuit board 196 is arranged along a plane extending along the up-down and left-right directions. The control circuit board 196 is disposed in front of the intake port 202. The control circuit board 196 is disposed behind the motor intake port 128 on the rear bracket 112. The control circuit board 196 controls the motor 86 (see FIG. 13). As shown in FIG. 13, the control circuit board 196 is disposed on the central axis 140a of the motor shaft 140. The control circuit board 196 is disposed behind the fan 88. When the motor unit 10 is viewed along the front-rear direction, the control circuit board 196 at least partially overlaps each of the motor 86 and the fan 88. The motor 86, the fan 88, and the control circuit board 196 are aligned along the front-rear direction.

As shown in FIG. 26, the board case 197 is disposed in the board accommodating space 203. The board case 197 is disposed in front of the intake port 202. The board case 197 is positioned between the control circuit board 196 and the intake port 202. The board case 197 supports the control circuit board 196. The control circuit board 196 is disposed inside the board case 197. The board case 197 is fixed to the inner housing part199. The board case 197 comprises heat dissipating fins 204. The heat dissipating fins 204 have a flat plate shape extending in the up-down and front-rear directions. The inner housing part199 has a through hole 199a penetrating a rear end of the inner housing part 199, and the heat dissipating fins 204 pass through the through hole 199a. The heat dissipating fins 204 face the intake port 202 in the front-rear direction.

The tubular vibration-proof member 104 is disposed in front of the board housing 192 and behind the rear bracket 112. The tubular vibration-proof member 104 is constituted of an elastic material. A material of the tubular vibration-proof member 104 is the same as the material of the first right vibration-proof member 170 (see FIG. 18). The tubular vibration-proof member 104 has a tubular shape. The tubular shape includes a bellows shape having a circular cross section. The tubular vibration-proof member 104 has an air passage 208 therein. The tubular vibration-proof member 104 is fixed to each of a front end of the board housing 192 and a rear end of the rear bracket 112. The front end of the board housing 192 is open and the tubular vibration-proof member 104 encloses the front end of the board housing 192. The air passage 208 is connected to the interior space 200 through the front end of the board housing 192. The tubular vibration-proof member 104 encloses the motor intake port 128 of the rear bracket 112. The air passage 208 is connected to the fan accommodating space 126 via the motor intake port 128. As shown in FIG. 13, when the motor unit 10 is viewed along the front-rear direction, the air passage 208 at least partially overlaps each of the motor 86 and the fan 88.

When the control circuit board 196 controls the motor 86 to operate, the motor shaft 140 rotates, and the fan 88 rotates. As shown in FIG. 15, air flows through the air intake port 26a and into the accommodating space 18 of the body housing 12 from outside the motor unit 10. In the drawing, the air flow is indicated by an arrow line with a sign F1. The inflow air flows rearward between the motor housing 84 and the plate member 92, between the plate member 92 and the support plate 184, and between the support plate 184 and the upper wall 20c of the body housing 12.

As shown in FIG. 26, air flows around the outer housing part198, then passes through the intake port 202 and flows into the interior space 200. The inflowing air passes through the filter member 194 and flows upward between the outer housing part198 and inner housing part199 along the heat dissipating fins 204. As the air passes through the filter member 194, foreign matters contained in the flowing air are removed. Further, the control circuit board 196 is cooled as the air flows along the heat dissipating fins 204. The air then flows frontward between the outer housing part198 and inner housing part199, through the air passage 208 of the tubular vibration-proof member 104 and the motor intake port 128 of the rear bracket 112, and flows from the interior space 200 into the fan accommodating space 126.

As shown in FIG. 15, the air flowing into the fan accommodating space 126 is sent by the fan 88 in a direction separating away from the central axis 140a (outward in a radial direction of the fan 88). The air then flows from the fan accommodating space 126 into the motor accommodating space 122. The air flowing into the motor accommodating space 122 flows frontward inside and outside the motor 86. This cools the motor 86. The air then passes through the exhaust port 124 of the front bracket 110 and is discharged from the motor accommodating space 122 to the outside of the motor unit 10.

As shown in FIGS. 2, 3, and 27 to 33, the motor unit 10 can be applied to multiple types of working units 4. In FIGS. 2, 3, and 27 to 33, the coordinate system is changed to a coordinate system different from the coordinate system for the motor unit 10 described above. Specifically, a direction perpendicular to the placement surface P1 may be termed the up-down direction, a direction perpendicular to the up-down direction may be termed the front-rear direction, and a direction perpendicular to the up-down and front-rear directions may be termed the left-right direction.

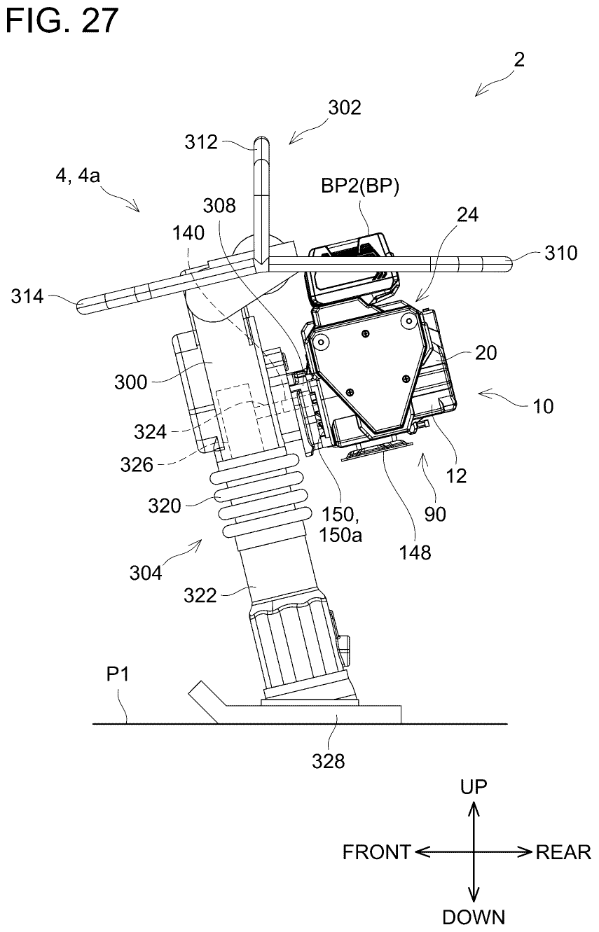

As shown in FIG. 27, motor unit 10 is configured to be attached to a rammer 4a. The rammer 4a is a ground consolidator that consolidates the ground. The rammer 4a comprises an upper housing 300, a handle unit 302, and a work part304. The upper housing 300 comprises a fixing platform 308 disposed at a rear upper portion thereof. The fixing platform 308 is fixed to the second fixing surface 150a of the motor unit 10.

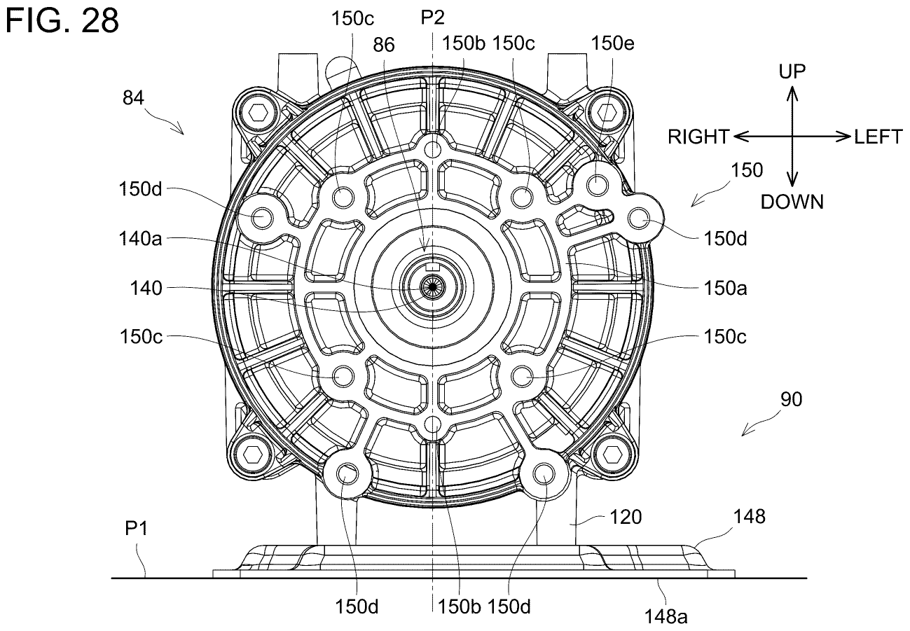

Before describing a detailed configuration of the fixing platform 308, a detailed configuration of the second fixing part 150 of the motor unit 10 is described. As shown in FIG. 28, the second fixing part 150 has two positioning holes 150b, four first fixing holes 150c, four second fixing holes 150d, and an auxiliary hole 150e. The positioning holes 150b, the first fixing holes 150c, the second fixing holes 150d, and the auxiliary hole 150e are defined in the second fixing surface 150a. Arrangement of the two positioning holes 150b, the four first fixing holes 150c, the four second fixing holes 150d, and the auxiliary hole 150e is same as arrangement of a plurality of holes in an engine unit configured to be attached to the rammer 4a. Therefore, the motor unit 10 can be used by fixing the second fixing part 150 to the working unit 4, to which the engine unit can be attached.

Each of the two positioning holes 150b is spaced apart from the central axis 140a of the motor shaft 140 by a certain distance. The two positioning holes 150b are arranged 180 degrees apart around the central axis 140a. The two positioning holes 150b are arranged on the perpendicular plane P2.

Each of the four first fixing holes 150c is separated from the central axis 140a by a certain distance. The four first fixing holes 150c are arranged at intervals of 90 degrees around the central axis 140a. A distance between the first fixing holes 150c and the central axis 140a is slightly shorter than a distance between the positioning holes 150b and the central axis 140a. Two of the first fixing holes 150c are disposed to the right of the perpendicular plane P2 and the remaining two first fixing holes 150c are disposed to the left of the perpendicular plane P2.

Each of the four second fixing holes 150d is separated from the central axis 140a by a certain distance. A distance between the second fixing holes 150d and the central axis 140a is longer than a distance between the positioning holes 150b and the central axis 140a. Two of the second fixing holes 150d are disposed to the right of the perpendicular plane P2 and the remaining two second fixing holes 150d are disposed to the left of the perpendicular plane P2. The auxiliary hole 150e is slightly farther away from the central axis 140a than the second fixing holes 150d.

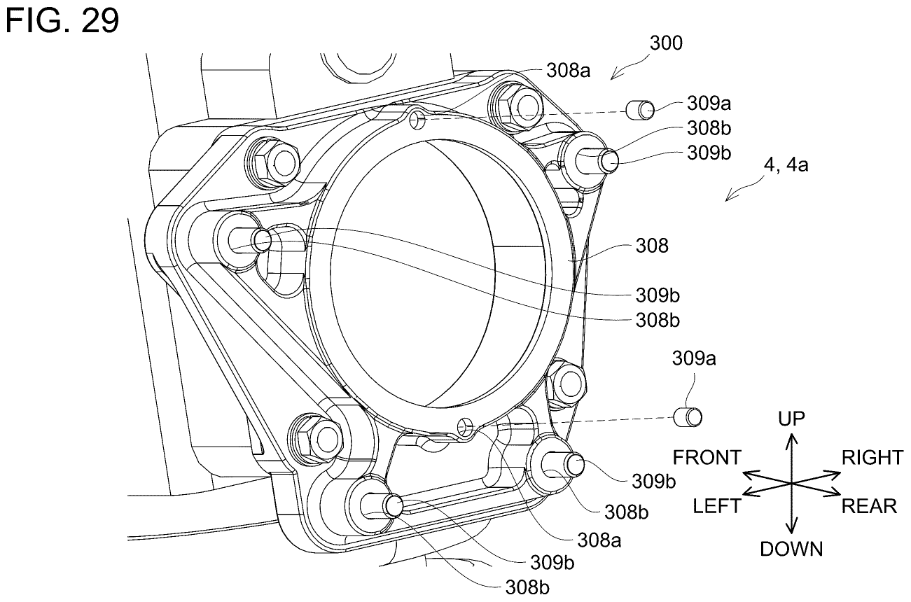

As shown in FIG. 29, the fixing platform 308 has two positioning holes 308a and four fixing holes 308b. Arrangement of the two positioning holes 308a and four fixing holes 308b is identical to arrangement of the two positioning holes 150b and four second fixing holes 150d in the second fixing part 150.

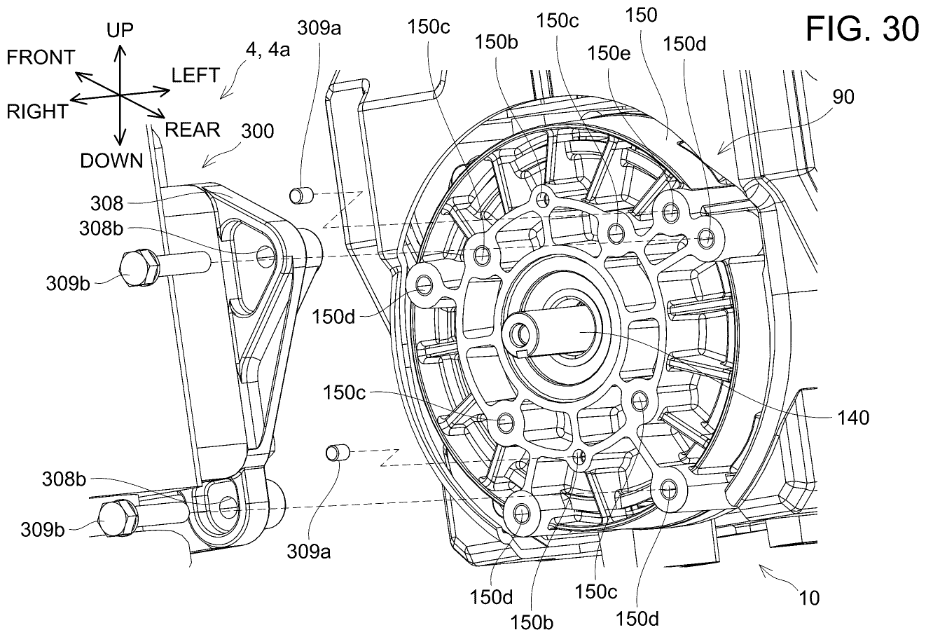

As shown in FIGS. 29 and 30, when fixing the second fixing part 150 to the fixing platform 308, firstly, each of two positioning pins 309a is inserted into a corresponding one of the positioning holes 308a and into a corresponding one of the positioning holes 150b. This positions the second fixing part 150 with respect to the fixing platform 308. As a result, the fixing holes 308b face the second fixing holes 150d. Next, each of four screws 309b is inserted into a corresponding one of the fixing holes 308b and screwed into a corresponding one of the second fixing holes 150d. As a result, the second fixing part 150 is fixed to the fixing platform 308 with the second fixing part 150 positioned with respect to the fixing platform 308. When the second fixing part 150 is fixed to the fixing platform 308, the motor shaft 140 of the motor unit protrudes from the body housing 12 toward a lower front side.

As shown in FIG. 2, the handle unit 302 comprises a first handle 310, a second handle 312, and a third handle 314. The first handle 310 extends rearward from an upper end of the upper housing 300, then bends to extend rightward, and further bends to extend frontward. The first handle 310 encloses the motor unit 10. The second handle 312 extends upward from the upper end of the upper housing 300, then bends to extend rightward, then further bends to extend downward. The third handle 314 extends frontward and downward from the upper end of the upper housing 300, then bends to extend rightward, and further bends to extend rearward and upward. The first handle 310, the second handle 312, and the third handle 314 are integrally formed. At least one of the first handle 310, the second handle 312, and the third handle 314 is grasped by the user during operation.

As shown in FIG. 27, the work part 304 has a bellows part 320, a rammer part 322, a shaft receiving part 324, and a drive part 326. The bellows part 320 is fixed to a lower portion of the upper housing 300. The bellows part 320 is extendable and retractable. The rammer part 322 is disposed at a bottom of the upper housing 300. An upper portion of the rammer part 322 is surrounded by the bellows part 320. The rammer part 322 is fixed to the bellows part 320. The rammer part 322 comprises a rammer plate 328 disposed at a lower end of the rammer part 322. The rammer plate 328 is in surface contact with the placement surface P1.

The shaft receiving part 324 and the drive part 326 are disposed inside the upper housing 300. The shaft receiving part 324 is fixed to the motor shaft 140 of the motor unit 10. The drive part 326 is fixed to the shaft receiving part 324. The drive part 326 operates the rammer part 322 when the motor shaft 140 rotates. Due to this, a detaching motion that moves the rammer part 322 away from the placement surface P1 and an approaching motion that moves the rammer part 322 closer to the placement surface P1 are repeatedly executed. The rammer plate 328 is repeatedly pressed against the placement surface P1, thereby hardening the placement surface P1, such as the ground.

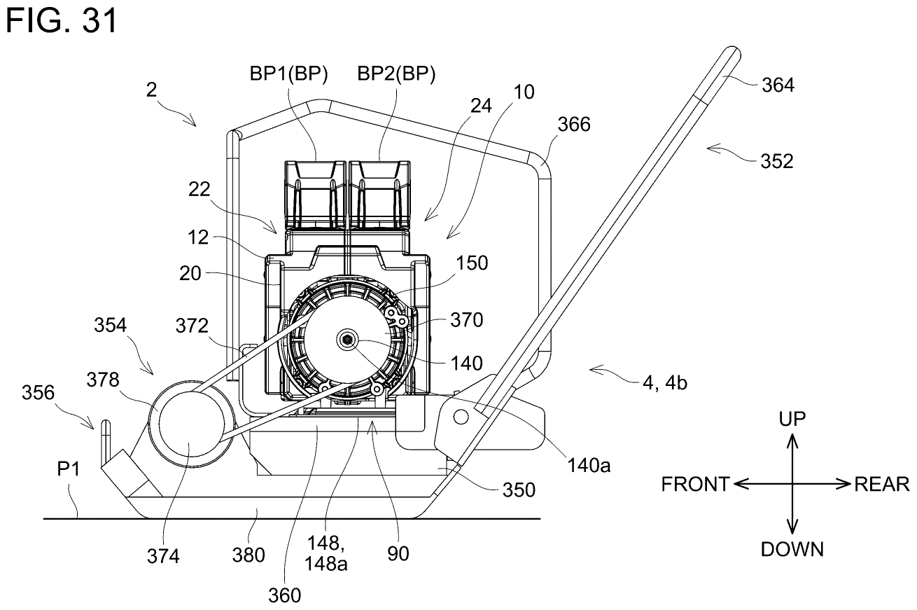

As shown in FIG. 31, the motor unit 10 can be attached to the plate compactor 4b. The plate compactor 4b is a ground consolidator that consolidates the ground. Force with which the plate compactor 4b consolidates the ground is less than force with which the rammer 4a consolidates the ground. The plate compactor 4b comprises a base 350, a handle unit 352, a transmission device 354, and a working part 356.

The base 350 has a fixing platform 360. The fixing platform 360 is fixed to the first fixing surface 148a of the motor unit 10.

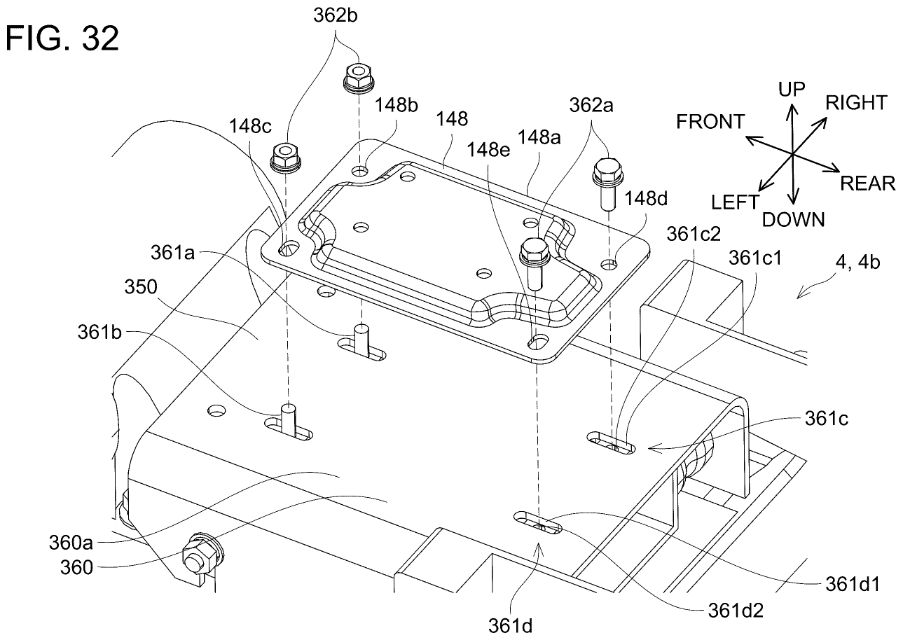

Before describing a detailed configuration of the fixing platform 360, a detailed configuration of the first fixing part 148 of the motor unit 10 is described. As shown in FIG. 32, the first fixing part 148 has a first positioning hole 148b, a second positioning hole 148c, a first fixing hole 148d, and a second fixing hole 148e. The first positioning hole 148b, the second positioning hole 148c, the first fixing hole 148d, and the second fixing hole 148e are disposed in the first fixing surface 148a. The first positioning hole 148b, the second positioning hole 148c, the first fixing hole 148d, and the second fixing hole 148e penetrate the first fixing part 148 in the up-down direction. Arrangement of the first positioning hole 148b, the second positioning hole 148c, the first fixing hole 148d, and the second fixing hole 148e is the same as arrangement of holes in an engine unit configured to be attached to the plate compactor 4b. Further, a distance between the first fixing surface 148a and the central axis 140a of the motor shaft 140 (see FIG. 28) is the same as a distance between a fixing surface of the engine unit and a shaft of the engine. Therefore, the motor unit 10 can be used by fixing the first fixing part 148 to the working unit 4 on which the engine unit is configured to be mounted.

The first and second positioning holes 148b and 148c are disposed at a front end of the first fixing part 148. The first positioning hole 148b and the second positioning hole 148c are aligned in the left-right direction. The first positioning hole 148b is a round hole. The second positioning hole 148c is a long hole extending in the left-right direction.

The first and second fixing holes 148d and 148e are disposed at a rear end of the first fixing part 148. The first fixing hole 148d and the second fixing hole 148e are aligned in the left-right direction. The first fixing hole 148d and the first positioning hole 148b are aligned in the front-rear direction. A shape of the first fixing hole 148d is substantially identical to that of the first positioning hole 148b. The second fixing hole 148e and the second positioning hole 148c are aligned in the front-rear direction. A shape of the second fixing hole 148e is substantially identical to that of the second positioning hole 148c.

The fixing platform 360 has a first positioning projection 361a, a second positioning projection 361b, a first fixing hole 361c, and a second fixing hole 361d. The first and second positioning protrusions 361a and 361b project upward from an upper surface 360a of the fixing platform 360. The first and second positioning protrusions 361a and 361b have a cylindrical shape. The first and second positioning protrusions 361a and 361b are aligned in the left-right direction.

The first fixing hole 361c and the second fixing hole 361d are aligned in the left-right direction. The first fixing hole 361c and the first positioning projection 361a are aligned in the front-rear direction. The second fixing holes 361d and the second positioning projection 361b are aligned in the front-rear direction.

The first fixing hole 361c comprises a first long hole part 361cl extending in the front-rear direction and a first round hole part 361c2 disposed at a lower end of the first long hole part 361c1. The second fixing hole 361d has a second long hole part 361dl extending in the front-rear direction and a second round hole part 361d2 disposed at a lower end of the second long hole part 361d1.

When fixing the first fixing part 148 to the fixing platform 360, firstly the first positioning projection 361a is inserted into the first positioning hole 148b and the second positioning projection 361b is inserted into the second positioning hole 148c. Due to this, the first fixing part 148 is positioned with respect to the fixing platform 360. Further, since the second positioning hole 148c is a long hole, the first fixing part 148 can be positioned with respect to the fixing platform 360 even when a distance between the first positioning projection 361a and the second positioning projection 361b varies from product to product. Next, a screw 362a is inserted into the first fixing hole 361c and the first long hole part 361cl from above the first fixing part 148 and screwed with the first round hole part 361c2. Next, the screw 362a is inserted into the second fixing hole 361d and the second long hole part 361dl from above the first fixing part 148 and screwed with the second round hole part 361d2. Then, each of two nuts 362b is screwed onto the first positioning projection 361a and the second positioning projection 361b. Due to this, the first fixing part 148 is fixed to the upper surface 360a of the fixing platform 360 with the first fixing part 148 positioned with respect to the fixing platform 360. When the first fixing part 148 is fixed to the fixing platform 360, the motor shaft 140 of the motor unit 10 extends in the left-right direction.

As shown in FIG. 3, the handle unit 352 comprises a first handle 364 and a second handle 366. The first handle 364 extends from a rear end of the base 350 rearward and upward, then bends to extend rightward and further bends to extend frontward and downward. The first handle 364 is disposed behind the motor unit 10. The first handle 364 is configured to be grasped by the user during operation.

The second handle 366 extends upward from the rear end of the base 350, then bends to extend frontward and upward, then further bends to extend frontward, then further bends to extend downward. The second handle 366 is arranged to surround the motor unit 10. The second handle 366 is configured to be grasped by the user, for example, when the plate compactor 4b is to be lifted.

As shown in FIG. 31, the transmission device 354 has a first pulley 370, a belt 372, and a second pulley 374. The first pulley 370 is fixed to the motor shaft 140. The belt 372 is strapped on the first pulley 370 and the second pulley 374. The second pulley 374 is positioned forward of the first pulley 370.

The working part 356 comprises an exciter 378 and a rammer plate 380. The exciter 378 is fixed to the second pulley 374. The exciter 378 allows the rammer plate 380 to operate when the second pulley 374 rotates. Due to this, the rammer plate 380 moves in the up-down direction. As the rammer plate 380 is repeatedly pressed against the placement surface P1, the placement surface P1, such as the ground, is hardened.

When the rammer 4a (see FIG. 27) or the plate compactor 4b is operated, the rammer 4a or the plate compactor 4b vibrates. This causes the vibration of the rammer 4a or the plate compactor 4b to be transmitted to the motor unit 10 via the motor shaft 140. As shown in FIG. 22, the vibration transmitted to the motor shaft 140 is transmitted from the motor 86 to the motor housing 84. The vibration is then transmitted from the motor housing 84 to the plate member 92 and then to the vibration-proof part 94. Once the vibration is transmitted to the vibration-proof part 94, the first right vibration-proof member 170, the second right vibration-proof member 172 (see FIG. 18), and the third right vibration-proof member 174 (see FIG. 18) deform elastically in the up-down, left-right, and front-rear directions between the right wall 154a of the plate member 92 and the right cover member 96, and the first left vibration-proof member 176, the second left vibration-proof member 178 (see FIG. 18), and the third left vibration-proof member 180 (see FIG. 18) deform elastically in the up-down, left-right, and front-rear directions between the left wall 154b of the plate member 92 and the left cover member 98. Due to this, the vibration is damped and the transmission of the vibration to the right cover member 96 and the left cover member 98 is suppressed. Thus, the vibration is suppressed from being transmitted to the battery packs BP (see FIG. 4) via the body housing 12, and the vibration is suppressed from being transmitted to the control circuit board 196 (see FIG. 26) of the control unit 102 via the support unit 100.

Further, as shown in FIG. 26, the vibration transmitted to the motor housing 84 is transmitted to the tubular vibration-proof member 104. When the vibration is transmitted to the tubular vibration-proof member 104, the tubular vibration-proof member 104 elastically deforms between the motor housing 84 and the board housing 192 in the up-down, left-right, and front-rear directions. This dampens the vibration and suppresses its transmission to the board housing 192. Thus, the vibration is suppressed from being transmitted to the control circuit board 196.

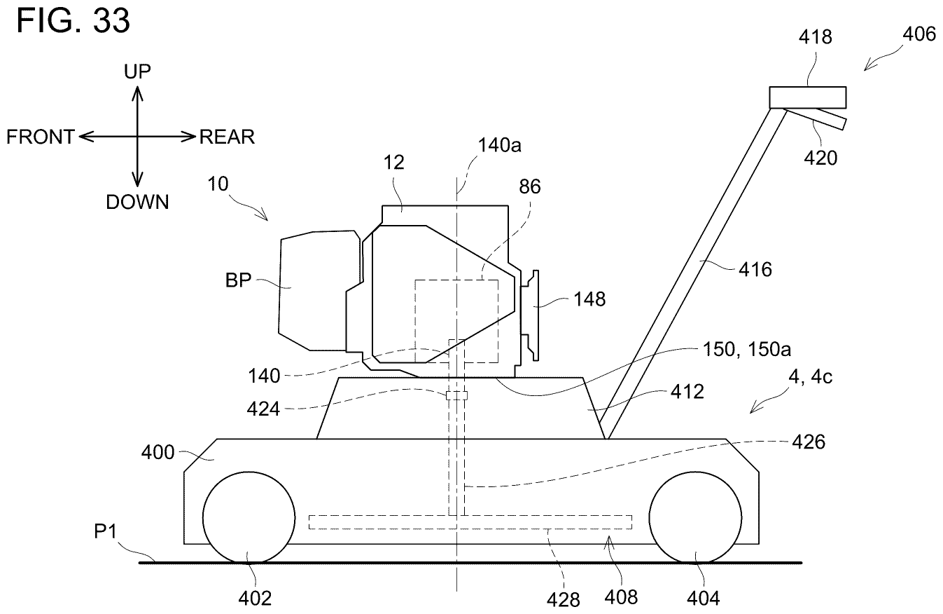

As shown in FIG. 33, the motor unit 10 is configured to be attached to a slope mower 4c. The slope mower 4c is a device configured to cut grass. The slope mower 4c comprises a housing 400, a pair of front wheels 402, a pair of rear wheels 404, a handle unit 406, and a work part 408. The housing 400 comprises a fixing platform 412 disposed at the top. The fixing platform 412 is fixed to the second fixing surface 150a of the motor unit 10. The motor shaft 140 of the motor unit 10 protrudes downward from the body housing 12.

The pair of front wheels 402 is rotatably supported onto a front portion of housing 400. The pair of rear wheels 404 is rotatably supported onto a rear portion of the housing 400. As the pair of front wheels 402 and the pair of rear wheels 404 rotate, the slope mower 4c moves on the placement surface P1.

The handle unit 406 comprises a fixed frame 416, a handle 418, and a trigger 420. The fixed frame 416 has a substantially U-shape. Both ends of the fixed frame 416 in its longitudinal direction are fixed to the housing 400.

The handle 418 is attached to a top of the fixed frame 416. The user moves the slope mower 4C by grasping the handle 418 and pushing it frontward.

The trigger 420 is pivotably attached to the handle 418. The trigger 420 is operated by a user's hand grasping the handle 418 to move it closer to the handle 418. When the trigger 420 is operated, the motor 86 of the motor unit 10 is activated.

The work part 408 comprises a coupling 424, a transmission shaft 426, and a blade 428. The coupling 424 connects the motor shaft 140 and the transmission shaft 426.

The transmission shaft 426 extends in the up-down direction. The transmission shaft 426 rotates around the central axis 140a, which extends in the up-down direction integrally with the motor shaft 140.

The blade 428 is fixed to a lower end of transmission shaft 426. The blade 428 rotates around the central axis 140a in unison with the transmission shaft 426. Due to this, the grass is cut.

### Effects

The motor unit 10 in the present embodiment is configured to be detachably attached to each of multiple types of working units 4 to operate the working units 4 to which the motor unit is attached. The motor unit 10 comprises: the body housing 12 comprising the accommodating part 20 including the upper wall 20c (example of first wall), the first battery receptacle 22 disposed on the upper wall 20c, and the second battery receptacle 24 disposed on the upper wall 20c; and the motor 86 disposed inside the accommodating part 20 and configured to drive the working unit 4. The first battery receptacle 22 is configured to have the first battery pack BP1 (example of first battery) configured to power the motor 86 attached thereto, the first battery pack BP1 being configured to slide along the upper wall 20c. The second battery receptacle 24 is configured to have the second battery pack BP2 (example of second battery) configured to power the motor 86 attached thereto, the second battery pack BP2 being configured to slide along the upper wall 20c. The accommodating part 20 is not disposed between the first battery pack BP1 attached to the first battery receptacle 22 and the second battery pack BP2 attached to the second battery receptacle 24. The first battery pack BP1 comprises the left side surface 56b (example of first side surface). The second battery pack BP2 comprises the right side surface 56c (example of second side surface). The right side surface 56c faces the left side surface 56b and is disposed parallel to the left side surface 56b when the first battery pack BP1 is attached to the first battery receptacle 22 and the second battery pack BP2 is attached to the second battery receptacle 24.

The first battery pack BP1 and the second battery pack BP2 are versatile and compact batteries. According to the above configuration, the first battery pack BP1 is attached to the first battery receptacle 22 and the second battery pack BP2 is attached to the second battery receptacle 24. This enables use of the versatile and compact first battery pack BP1 and second battery pack BP2 to be used in the motor unit 10. In addition, because the left side surface 56b of the first battery pack BP1 faces the right side surface 56c of the second battery pack BP2 in parallel, the motor unit 10 to which the first battery pack BP1 and second battery BP2 are attached can be made smaller as compared to a configuration in which the left side surface 56b of the first battery pack BP1 does not face the right side surface 56c of the second battery pack BP2 in parallel.

Further, the motor unit 10 does not comprise a wall disposed between the left side surface 56b of the first battery pack BP1 and the right side surface 56c of the second battery pack BP2 when the first battery pack BP1 is attached to the first battery receptacle 22 and the second battery pack BP2 is attached to the second battery receptacle 24.

According to the above configuration, the motor unit 10 with the first and second battery packs BP1 and BP2 attached can be made more compact.

Further, the upper wall 20c is disposed above the motor 86 when the motor unit 10 is placed on the placement surface P1.

The motor 86 is a high-weight component. Further, the weight of the motor 86 is greater than the weight of each of the first battery pack BP1 and the second battery pack BP2. According to the above configuration, the high-weight motor 86 can be placed closer to the placement surface P1 than the first battery pack BP1 and the second battery pack BP2 are to the placement surface P1.

Further, the upper wall 20c comprises the upper surface 34a (example of first surface) on which the first battery receptacle 22 and the second battery receptacle 24 are disposed.

According to the above configuration, the first battery pack BP1 can easily be attached to the first battery receptacle 22, and the second battery pack BP2 can easily be attached to the second battery receptacle 24.

Further, the motor unit 10 further comprises the vibration-proof part 94 (example of vibration-proof member) disposed between the motor 86 and the body housing 12 and being elastically deformable.

According to the above configuration, vibration can be suppressed from being transmitted from the motor 86 to the body housing 12. Due to this, the transmission of vibration to the first battery pack BP1 and the second battery pack BP2 can be suppressed.

The motor unit 10 further comprises the motor housing 84 housing the motor 86 and the plate member 92 fixed to the motor housing 84. The vibration-proof part 94 is fixed to the plate member 92 and the body housing 12.

In a configuration in which the vibration-proof part 94 is directly fixed to the motor housing 84, the configuration of the motor housing 84 becomes complex. According to the above configuration, such complexity of the configuration of the motor housing 84 can be suppressed.

The motor unit 10 further comprises the control unit 102 disposed inside the accommodating part 20 and configured to control the motor 86, and the support unit 100 supporting the control unit 102 and fixed to the plate member 92 via the vibration-proof part 94.

According to the above configuration, vibration can be suppressed from being transmitted to the control unit 102.

Each of the first and second battery packs BP1 and BP2 may comprise the hook 58 configured to be operated by the user. The body housing 12 has the recessed grooves 34b (example of engaged part), each of the recessed grooves 34b being configured to engage with the corresponding hook 58.

According to the above configuration, the first and second battery packs BP1 and BP2 are engaged with the recessed grooves 34b of the body housing 12, by which the first and second battery packs BP1 and BP2 can be suppressed from being detached from the body housing 12.

When the motor unit 10 is viewed along the up-down direction perpendicular to the upper wall 20c, the first battery receptacle 22 does not overlap the second battery receptacle 24.

According to the above configuration, when the motor unit 10 is viewed along the up-down direction perpendicular to the upper wall 20c, the structure of the upper wall 20c can be suppressed from becoming complex as compared to a configuration in which the first battery receptacle 22 overlaps the second battery receptacle 24.

The first battery receptacle 22 is configured to have the first battery pack BP1 attached thereto, wherein the first battery pack BP1 is configured to slide in the front-rear direction which extends along the upper wall 20c (example of first direction). The second battery receptacle 24 is configured to have the second battery pack BP2 attached thereto, wherein the second battery pack BP2 is configured to slide in the front-rear direction. The motor 86 comprises the motor shaft 140 extending in the front-rear direction and fixed to the working unit 4.

According to the above configuration, the direction to slide the first battery pack BP1 and the direction to slide the second battery pack BP2 can easily be recognized by the orientation of the motor shaft 140.

Further, the motor unit 10 further comprises the control unit 102 disposed inside the accommodating part 20 and configured to control the motor 86. When the motor unit 10 is viewed along the front-rear direction, the control unit 102 at least partially overlaps the motor 86.

According to the above configuration, when the motor unit 10 is viewed along the front-rear direction, the motor unit 10 can be suppressed from becoming larger in the direction perpendicular to the front-rear direction compared to a configuration in which the control unit 102 does not at least partially overlap with the motor 86.

The motor unit 10 further comprises the first fixing part 148 (example of fixing part) fixed to the working unit 4. The motor 86 is disposed between the first fixing part 148 and the first battery receptacle 22 and between the first fixing part 148 and the second battery receptacle 24.

According to the above configuration, the first and second battery packs BP1 and BP2 can be prevented from interfering with the working unit 4.

The motor unit 10 in the present embodiment is detachably attached to each of the plurality of types of working units 4 to operate the working unit 4 to which the motor unit 10 is attached. The motor unit 10 comprises: the body housing 12 comprising the accommodating part having the upper wall 20c (example of first wall), the first battery receptacle 22 disposed on the upper wall 20c, and the second battery receptacle 24 disposed on the upper wall 20c; and the motor 86 disposed inside the accommodating part 20 and configured to drive the working unit 4. The first battery receptacle 22 is configured to have the first battery pack BP1 (example of first battery) configured to power the motor 86 attached thereto. The second battery receptacle 24 is configured to have the second battery pack BP2 (example of second battery) configured to power the motor 86 attached thereto. The maximum output of the motor 86 is equal to or more than 1.5 kW and equal to or less than 2.35 kW.

The first battery pack BP1 and the second battery pack BP2 are versatile and compact batteries. According to the above configuration, the first battery pack BP1 is attached to the first battery receptacle 22 and the second battery pack BP2 is attached to the second battery receptacle 24. Further, the motor 86, of which maximum output is equal to or more than 1.5 kW and equal to or less than 2.35 KW, is used to operate a relatively high-power working unit 4. Due to this, the versatile and compact first battery pack BP1 and second battery pack BP2 can be used in the motor unit 10 to operate the relatively high-power working unit 4.

The torque of the motor 86 is equal to or more than 2.0 Nm and equal to or less than 11.0 Nm. The rotation speed of the motor 86 is equal to or more than 3,000 rpm and equal to or less than 4,300 rpm.

The motor 86 with the torque of equal to or more than 2.0 Nm and equal to or less than 11.0 Nm and the rotation speed of equal to or more than 3000 rpm and equal to or less than 4300 rpm is used to operate a relatively high-power working unit 4. Due to this, versatile and compact first battery pack BP1 and second battery pack BP2 can be used for the motor unit 10 to operate such relatively high-power working unit 4.

Further, the volume of the body housing 12 is equal to or less than 9500 cm³.

In general, the motor 86 having a higher maximum output has a larger size. Accordingly, the body housing 12 becomes larger. According to the above configuration, the body housing 12 can be made smaller in the motor unit 10 that operates the relatively high-power working unit 4. Due to this, the motor unit 10 can be downsized.

Further, the volume of the first battery pack BP1 and the volume of the second battery pack BP2 are each equal to or less than 1500 cm³.

According to the above configuration, the motor unit 10 can be downsized.

Further, the upper wall 20c is positioned above the motor 86 when the motor unit 10 is placed on the placement surface P1.

The motor 86 is a high-weight component. The weight of the motor 86 is greater than the weight of each of the first battery pack BP1 and the second battery pack BP2. According to the above configuration, the high-weight motor 86 can be positioned closer to the placement surface P1 than the first battery pack BP1 and the second battery pack BP2 are to the placement surface P1.

Further, the first battery receptacle 22 is configured to have the first battery pack BP1 slidably attached thereto, the first battery pack BP1 being configured to slide in the front-rear direction (example of first direction) along the upper wall 20c. The second battery receptacle 24 is configured to have the second battery pack BP2 attached thereto, the second battery pack BP2 being configured to slide in the front-rear direction. The motor 86 comprises the motor shaft 140 extending in the front-rear direction and fixed to the working unit 4.

According to the above configuration, the direction to slide the first battery pack BP1 and the direction to slide the second battery pack BP2 can easily be recognized by the orientation of the motor shaft 140.

Further, the motor unit 10 comprises the first fixing part 148 (example of fixing part) fixed to the working unit 4. The motor 86 is disposed between the first fixing part 148 and the first battery receptacle 22 and between the first fixing part 148 and the second battery receptacle 24.

According to the above configuration, the first and second battery packs BP1 and BP2 can be suppressed from interfering with the working unit 4.

Further, the first battery pack BP1, which is attached to the first battery receptacle 22, and the second battery pack BP2, which is attached to the second battery receptacle 24, are electrically connected in series.

According to the above configuration, the output power of the motor unit 10 can be increased as compared to a configuration in which the first battery pack BP1 and the second battery pack BP2 are electrically connected in parallel.

The motor unit 10 in the present embodiment is configured to be detachably attached to each of a plurality of types of working units 4 to drive the working unit 4 to which the motor unit is attached. The motor unit 10 comprises: the body housing 12 comprising the accommodating part 20 including the upper wall 20c (example of first wall), the first battery receptacle 22 disposed on the upper wall 20c, and the second battery receptacle 24 disposed on the upper wall 20c; the motor 86 disposed inside the accommodating part 20 and configured to drive the working unit 4; and the fixing unit 90 comprising the first fixing part 148 and the second fixing part 150. The first battery receptacle 22 is configured to have the first battery pack BP1 (example of first battery) configured to power the motor 86 attached thereto. The second battery receptacle 24 is configured to have the second battery pack BP2 (example of second battery) configured to power the motor 86 attached thereto. The plurality of types of working units 4 comprises the plate compactor 4b (example of first working unit) and the rammer 4a (example of second working unit) different from the plate compactor 4b. The first fixing part 148 is configured to be fixed to the plate compactor 4b. The second fixing part 150 is configured to be fixed to the rammer 4a.

The first battery pack BP1 and the second battery pack BP2 are versatile and compact batteries. According to the above configuration, the first battery pack BP1 is attached to the first battery receptacle 22 and the second battery pack BP2 is attached to the second battery receptacle 24. Due to this, the versatile and compact first battery pack BP1 and second battery pack BP2 can be used in the motor unit 10. The motor unit 10 is fixed to the plate compactor 4b via the first fixing part 148 and to the rammer 4a via the second fixing part 150. This increases the types of working units 4 in which the motor unit 10 can be used.

When the motor unit 10 is placed on the placement surface P1, the first fixing part 148 is placed on the placement surface P1. The motor 86 is disposed between the first fixing part 148 and the first battery receptacle 22 and between the first fixing part 148 and the second battery receptacle 24.

According to the above configuration, the first and second battery packs BP1 and BP2 can be suppressed from interfering with the plate compactor 4b.

The motor unit 10 further comprises the motor housing 84 accommodating the motor 86. The second fixing part 150 is disposed on the motor housing 84.

According to the above configuration, the number of components of the motor unit 10 can be reduced as compared to a configuration in which the second fixing part 150 is not disposed in the motor housing 84.

The first fixing part 148 comprises the first fixing surface 148a configured to be fixed to the plate compactor 4b. The second fixing part 150 comprises the second fixing surface 150a configured to be fixed to the rammer 4a. The second fixing surface 150a is substantially perpendicular to the first fixing surface 148a.

According to the above configuration, one of the first fixing part 148 and the second fixing part 150 is selected according to the shape, etc. of the working unit 4. Due to this, types of the working units 4 to which the motor unit 10 is compatible can be increased.

The motor unit 10 further comprises the fan 88 disposed inside the accommodating part and configured to rotate by operation of the motor 86. The air intake port 26a (example of first air vent) is disposed between the accommodating part 20 and the second fixing part 150. The exhaust port 124 (example of second air vent) is disposed on the second fixing part 150. When the fan 88 rotates, air flows into the interior of the accommodating part 20 from one of the air intake port 26a and the exhaust port 124, and flows outside the accommodating part 20 via the other of the air intake port 26a and the exhaust port 124.

According to the above configuration, the motor 86, which is disposed inside the accommodating part 20, can be cooled.

The rated capacity of the first battery pack BP1 differs from the rated capacity of the second battery pack BP2.

According to the above configuration, multiple types of battery packs BP can be used in the motor unit 10.

The working machine 2 in the present embodiment comprises: the rammer 4a; and the motor unit 10 configured to be detachably attached to the rammer 4a to drive the rammer 4a. The motor unit 10 comprises: the body housing 12 comprising the accommodating part 20, the first battery receptacle 22 disposed on the accommodating part 20, and the second battery receptacle 24 disposed on the accommodating part 20, and the DC motor 86 disposed inside the accommodating part 20 to drive the rammer 4a. The first battery receptacle 22 is configured to have the first battery pack BP1 (example of first battery) configured to power the DC motor 86 attached thereto. The second battery receptacle 24 is configured to have the second battery pack BP2 (example of second battery) configured to power the DC motor 86 attached thereto.

The first battery pack BP1 and the second battery pack BP2 are versatile and compact batteries. According to the above configuration, the first battery pack BP1 is attached to the first battery receptacle 22 and the second battery pack BP2 is attached to the second battery receptacle 24. Due to this, the versatile and compact first battery pack BP1 and second battery pack BP2 can be used in the motor unit 10 to operate the rammer 4a.

### SECOND EMBODIMENT

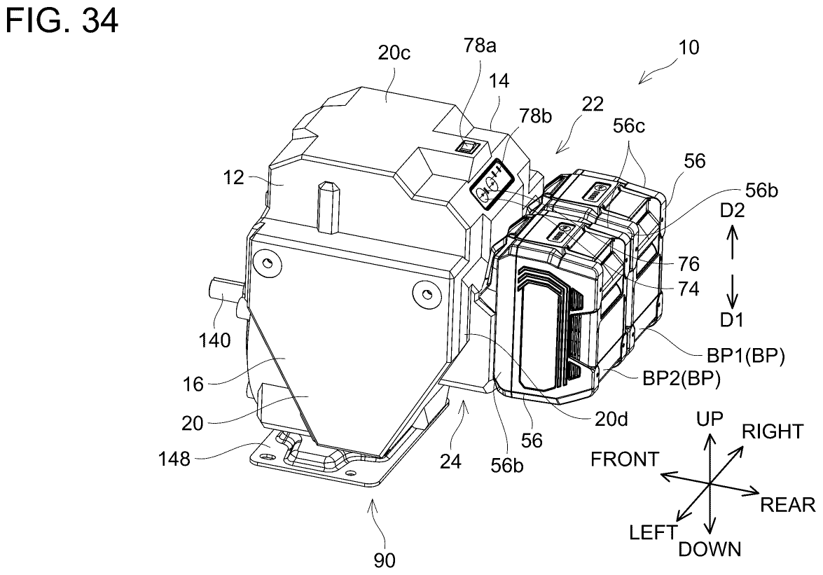

In a second embodiment, points that differ from the first embodiment will be described. As shown in FIG. 34, in the second embodiment, the first battery receptacle 22 and the second battery receptacle 24 are arranged on the rear wall 20d of the accommodating part 20. The first battery receptacle 22 and the second battery receptacle 24 are arranged side-by-side in the left-right direction. When the motor unit 10 is viewed along the front-rear direction, the first battery receptacle 22 does not overlap the second battery receptacle 24.

The first battery pack BP1 is attached to the first battery receptacle 22 by sliding it in the attaching direction D1 and removed from the first battery receptacle 22 by sliding it in the detaching direction D2, opposite to the attaching direction D1. The attaching direction D1 is downward. The detaching direction D2 is upward. The second battery pack BP2 is attached to the second battery receptacle 24 by sliding it in the first direction and removed from the second battery receptacle 24 by sliding it in the detaching direction D2.

### THIRD EMBODIMENT

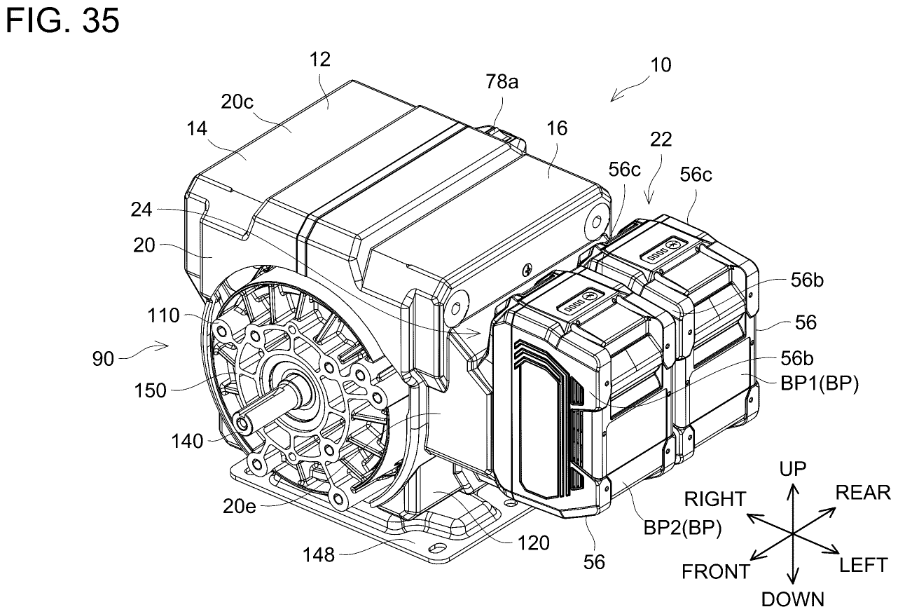

In a third embodiment, points that differ from the first embodiment will be described. As shown in FIG. 35, in the third embodiment, the first battery receptacle 22 and the second battery receptacle 24 are arranged on the left wall 20e of the accommodating part 20. The first battery receptacle 22 and the second battery receptacle 24 are arranged side-by-side in the front-rear direction. When the motor unit 10 is viewed along the left-right direction, the first battery receptacle 22 does not overlap the second battery receptacle 24.

The first battery pack BP1 is attached to the first battery receptacle 22 by sliding it in the attaching direction D1 and removed from the first battery receptacle 22 by sliding it in the detaching direction D2, opposite to the attaching direction D1. The attaching direction D1 is downward. The detaching direction D2 is upward. The second battery pack BP2 is attached to the second battery receptacle 24 by sliding it in the first direction and removed from the second battery receptacle 24 by sliding it in the detaching direction D2.

### FOURTH EMBODIMENT

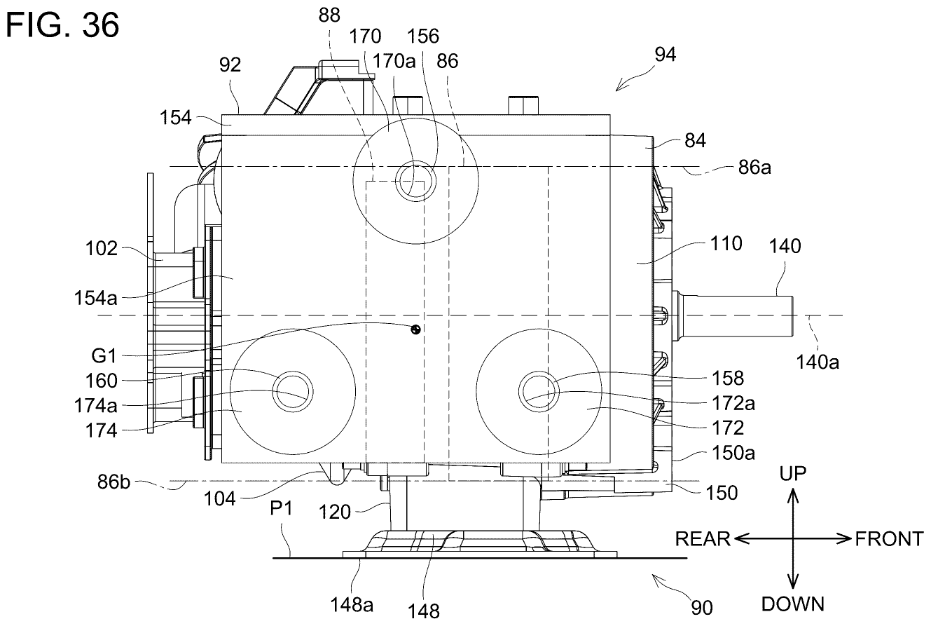

In a fourth embodiment, points that differ from the first embodiment will be described. As shown in FIG. 36, the first right vibration-proof member 170 is positioned above the center of gravity G1 of the motor unit 10 and the central axis 140a of the motor shaft 140. The center of the first right vibration-proof member 170 in the up-down direction is disposed below the upper end 86a of the motor 86. The upper end of the first right vibration-proof member 170 is disposed above the upper end 86a of the motor 86. With respect to the front-rear direction, the position of the center of the first right vibration-proof member 170 is substantially identical to the position of the center of gravity G1 of the motor unit 10.

The second right vibration-proof member 172 and the third right vibration-proof member 174 are disposed below the center of gravity G1 and the central axis 140a of the motor unit 10. The second right vibration-proof member 172 and the third right vibration-proof member 174 are disposed above the lower end 86b of the motor 86. With respect to the front-rear direction, the position of the center between the second right vibration-proof member 172 and the third right vibration-proof member 174 is substantially identical to the position of the center of gravity G1 of the motor unit 10.

The position of the first left vibration-proof member 176 (see FIG. 21) in the front-rear direction is substantially identical to the position of the first right vibration-proof member 170 in the front-rear direction. The position of the first left vibration-proof member 176 in the up-down direction is substantially identical to the position of the first right vibration-proof member 170 in the up-down direction. The position of the second left vibration-proof member 178 (see FIG. 21) in the front-rear direction is substantially identical to the position of the second right vibration-proof member 172 in the front-rear direction. The position of the second left vibration-proof member 178 in the up-down direction is substantially identical to the position of the second right vibration-proof member 172 in the up-down direction. The position of the third left vibration-proof member 180 (see FIG. 21) in the front-rear direction is substantially identical to the position of the third right vibration-proof member 174 in the front-rear direction. The position of the third left vibration-proof member 180 in the up-down direction is substantially identical to the position of the third right vibration-proof member 174 in the up-down direction.

### FIFTH EMBODIMENT

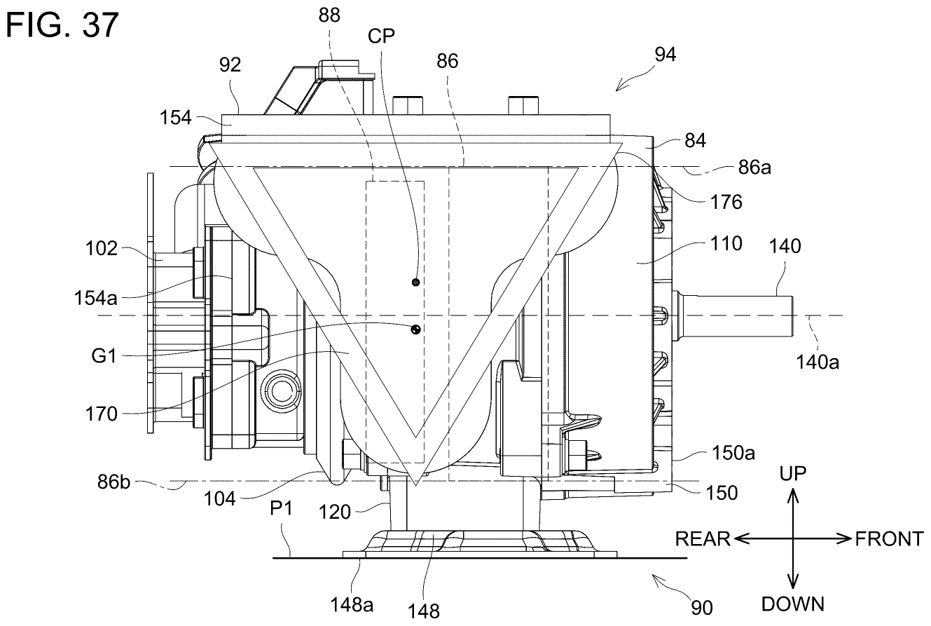

In a fifth embodiment, points that differ from the first embodiment will be described. As shown in FIG. 37, the vibration-proof part 94 comprises only the first right vibration-proof member 170 and the first left vibration-proof member 176. In FIG. 37, the first right vibration-proof member 170 is marked with a sign 176 on the outer surface of the first right vibration-proof member 170 to make the position of the first left vibration-proof member 176 easier to understand. The shape of the first right vibration-proof member 170 in the fifth embodiment differs from the shape of the first right vibration-proof member 170 of the first embodiment, and the shape of the first left vibration-proof member 176 in the fifth embodiment differs from the shape of the first left vibration-proof member 176 of the first embodiment.

The first right vibration-proof member 170 has a triangular ring shape. With respect to the first-back direction, the position of the center CP of the first right vibration-proof member 170 is identical to the position of the center of gravity G1 of the motor unit 10. The center CP of the first right vibration-proof member 170 is disposed above the center of gravity G1 of the motor unit 10 and the central axis 140a of the motor shaft 140. The upper end of the first right vibration-proof member 170 is disposed above the upper end 86a of the motor 86. The lower end of the first right vibration-proof member 170 is disposed below the lower end 86b of the motor 86. At least a portion of the first right vibration-proof member 170 is disposed below the upper end 86a of the motor 86.

The shape of the first left vibration-proof member 176 is substantially identical to the shape of the first right vibration-proof member 170. The position of the first left vibration-proof member 176 in the front-rear direction is substantially identical to the position of the first right vibration-proof member 170 in the front-rear direction. The position of the first left vibration-proof member 176 in the up-down direction is substantially identical to the position of the first right vibration-proof member 170 in the up-down direction.

### SIXTH EMBODIMENT

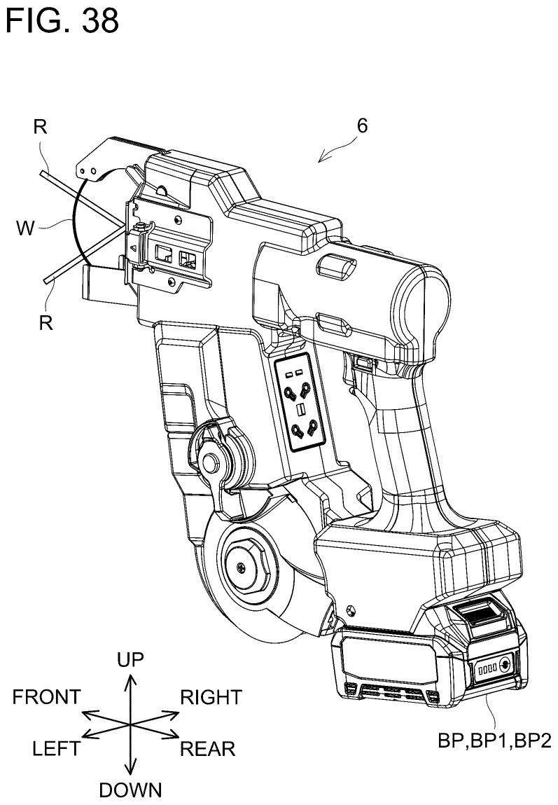

In a sixth embodiment, points that differ from the first embodiment will be described. As shown in FIGS. 4 and 38, the battery packs BP are versatile battery packs. The battery packs BP are configured to be used for a power tool 6 in addition to the motor unit 10. As shown in FIG. 38, for example, the battery packs BP can be used in a rebar tying machine that uses a wire W to tie plural rebars R. Further, the battery packs BP can also be used for power tools other than the rebar tying machine, such as an impact driver, a circular saw, and a driver drill. Each battery pack BP can be directly attached to the power tool 6. Furthermore, the battery packs BP can also be used for horticultural products. Examples of the horticultural products include a brush cutter, a blower, a hedge trimmer, a chain saw, a cart, a snow plower, and a tiller. Each of the battery packs BP can be directly attached to the respective horticultural products. Further, the battery cell(s) of each of the battery packs BP may be cylindrical cell(s), square cell(s), or laminated cell(s). Moreover, the configuration of the first battery pack BP1 shown in FIG. 4 (e.g., dimensions, shape, maximum voltage value, rated capacity, and battery cell type) may be different from the configuration of the second battery pack BP2 (e.g., dimensions, shape, maximum voltage value, rated capacity, and battery cell type).

As shown in FIG. 13, when the motor unit 10 is placed on the placement surface P1, the first and second battery packs BP1 and BP2 (see FIG. 8) are positioned above the motor 86. The first battery pack BP1 and the second battery pack BP2 (see FIG. 8) are substantially parallel to the first fixing part 148, e.g. the first fixing surface 148a.

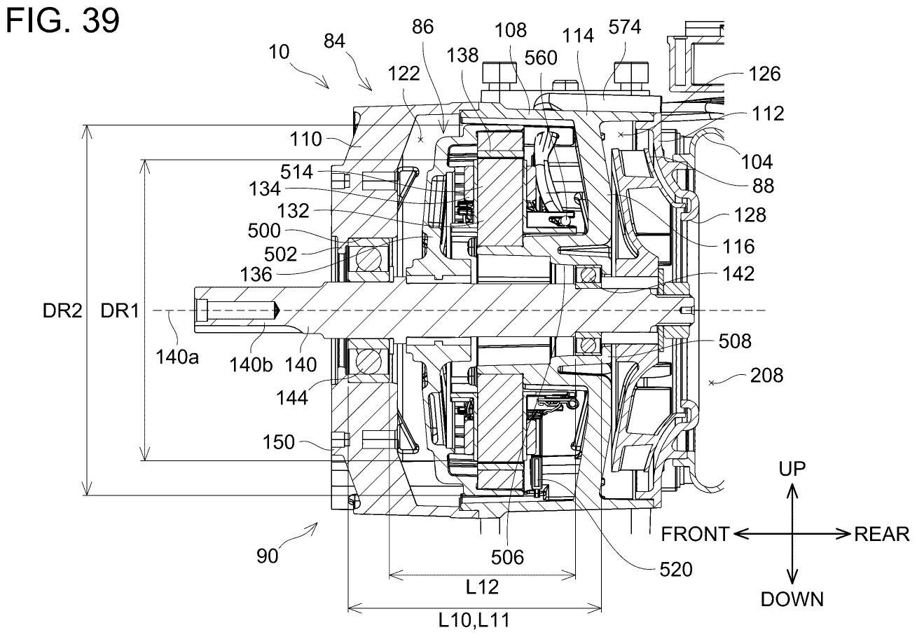

As shown in FIG. 39, the front bracket 110 has a front through hole 500 and a front rib 502. The front through hole 500 penetrates a front wall of the front bracket 110 in the front-rear direction. The front through hole 500 is disposed on the central axis 140a of the motor shaft 140. The motor shaft 140 passes through the front through hole 500.

The front rib 502 is disposed in the front through hole 500. The front rib 502 protrudes from an inner surface of the front through hole 500 toward the central axis 140a.

The bearing 144 is mounted on front bracket 110. The bearing 144 is disposed in front through hole 500. The bearing 144 is disposed rearward of the front end 140b of the motor shaft 140. The front end 140b of the motor shaft 140 is disposed outside of the body housing 12 (see FIG. 13). The front end 140b of the motor shaft 140 is configured to be fixed to each of the shaft receiving part 324 of the rammer 4a (see FIG. 27) and the first pulley 370 of the plate compactor 4b (see FIG. 31). Since the motor shaft 140 is substantially parallel to the first fixing part 148, e.g., to the first fixing surface 148a (see FIG. 13), the front end 140b of the motor shaft 140 is substantially parallel to the first fixing part 148, e.g., the first fixing surface 148a (see FIG. 13). The bearing 144 is in contact with a rear end of the front rib 502 from a motor accommodating space 122 side. Thus, the bearing 144 is disposed in the motor accommodating space 122, i.e., inside the motor housing 84. Further, the bearing 144 does not slip out of the motor accommodating space 122 through the front through hole 500. The bearing 144 rotatably supports the motor shaft 140. An outer diameter of the bearing 144 is, for example, equal to or more than 50 mm and equal to or less than 60 mm. Further, an inner diameter of the bearing 144 is, for example, equal to or more than 20 mm or equal to or less than 25 mm. A length of the bearing 144 in the front-rear direction is, for example, equal to or more than 10 mm and equal to or less than 20 mm.

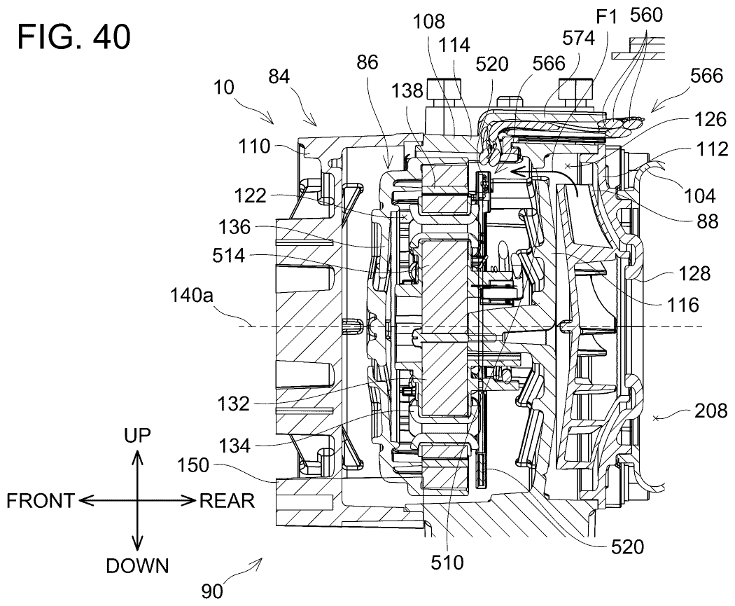

The bulkhead portion 116 of the motor housing body 108 has a rear through hole 506, a rear rib 508, and an air vent 510 (see FIG. 40). The rear through hole 506 penetrates the bulkhead portion 116 in the front-rear direction. The rear through hole 506 is disposed on the central axis 140a. The motor shaft 140 passes through the rear through hole 506.

The rear rib 508 is disposed in the rear through hole 506. The rear rib 508 protrudes from an inner surface of the rear through hole 506 toward the central axis 140a. The rear rib 508 is separated from the front rib 502 in the front-rear direction. A distance L10 between a front end of the rear rib 508 and a rear end of the front rib 502 is, for example, equal to or less than 115 mm. Due to this, the motor housing 84 can be downsized. Further, the distance L10 may be equal to or less than 110 mm, may be equal to or less than 105 mm, or may be equal to or less than 100 mm. The distance L10 is, for example, equal to or more than 80 mm. Due to this, the maximum output value of the motor 86 can be suppressed from decreasing due to the downsizing of the motor 86. The distance L10 may be equal to or more than 85 mm, may be equal to or more than 90 mm, or may be equal to or more than 95 mm.

The bearing 142 is mounted on the bulkhead portion 116. The bearing 142 is disposed in the rear through hole 506. The bearing 142 is positioned rearward of the bearing 144. Thus, the bearing 144 is disposed between the front end 140b of the motor shaft 140 and the bearing 142. The bearing 142 is disposed side by side with the bearing 144 in the front-rear direction. With respect to the front-rear direction, the stator body 132, the coil 134, the outer rotor body 136, and the permanent magnet 138 of the motor 86 are disposed between the bearing 142 and the bearing 144. The bearing 142 is in contact with the front end of the rear rib 508 from the motor accommodating space 122 side. Therefore, the bearing 142 is disposed in the motor accommodating space 122, i.e., inside the motor housing 84. Further, the bearing 142 does not slip out of the motor accommodating space 122 through the rear through hole 506. The bearing 142 rotatably supports the motor shaft 140. An outer diameter of the bearing 142 is, for example, equal to or more than 30 mm and equal to or less than 45 mm. The outer diameter of the bearing 142 is smaller than an outer diameter of the bearing 144. An inner diameter of the bearing 142 is, for example, equal to or more than 15 mm and equal to or less than 20 mm. The inner diameter of the bearing 142 is smaller than an inner diameter of the bearing 144. A length of the bearing 142 in the front-rear direction is, for example, equal to or more than 5 mm and equal to or less than 15 mm. The length of the bearing 142 in the front-rear direction is smaller than the length of the bearing 144 in the front-rear direction.

A distance L11 between the front end of the bearing 144 and the rear end of the bearing 142 is equal to or less than 115 mm, for example. Due to this, the motor housing 84 can be made smaller. Further, the distance L11 may be equal to or less than 110 mm, equal to or less than 105 mm, or equal to or less than 100 mm. The distance L11 is, for example, equal to or more than 80 mm. Due to this, the decrease of the maximum output value of the motor 86 as the motor 86 is downsized can be suppressed. The distance L11 may be equal to or more than 85 mm, equal to or more than 90 mm, or equal to or more than 95 mm. The distance L11 is substantially the same as the distance L10.

The distance L12 between the rear end of the bearing 144 and the front end of the bearing 142 is equal to or less than 100 mm, for example. Due to this, the motor housing 84 can be made smaller. The distance L12 may be equal to or less than 90 mm, equal to or less than 85 mm, or equal to or less than 80 mm. Further, the distance L12 is, for example, equal to or more than 60 mm. Due to this, the decrease of the maximum output value of the motor 86 as the motor 86 is downsized can be suppressed. The distance L12 may be equal to or more than 65 mm, equal to or more than 70 mm, or equal to or more than 75 mm. The distance L12 is a separation distance between the bearings 142 and 144.

As shown in FIG. 40, the air vent 510 penetrates the bulkhead portion 116 in the front-rear direction. The air vent 510 is further away from the central axis 140a than the rear through hole 506 is. The air vent 510 connects the motor accommodating space 122 and the fan accommodating space 126.

As shown in FIG. 39, in the present embodiment, the motor unit 10 has only one fan 88. The fan 88 is disposed in the fan accommodating space 126. The fan 88 is disposed outside of the motor accommodating space 122. The fan 88 is fixed to the rear end of the motor shaft 140. When the motor shaft 140 rotates, the fan 88 rotates. As shown in FIG. 15, air passes through the air intake port 26a and flows into the accommodating space 18 of the body housing 12 from outside the motor unit 10. Then, as shown in FIG. 26, the air flows through the intake port 202 of the board housing 192 into the interior space 200 in the board housing 192. The air then flows along the heat dissipating fins 204 and then flows from the interior space 200 into the fan accommodating space 126 through the air passage 208 of the tubular vibration-proof member 104 and the motor intake port 128 of the rear bracket 112. As the air flows along the heat dissipating fins 204, the control circuit board 196 is cooled. As shown in FIG. 40, the air is sent by the fan 88 in a direction separating away from the central axis 140a (radially outward from the fan 88). The air then flows from the fan accommodating space 126 into the motor accommodating space 122 through the air vent 510. The air then flows frontward inside and outside the motor 86. This cools the motor 86. Finally, the air is discharged from the motor accommodating space 122 to the outside of the motor unit 10 through the exhaust port 124 (see FIG. 15) of the front bracket 110. In the present embodiment, the air delivered by the fan 88 is discharged to the outside of the motor unit 10 without passing through the outside of the motor housing 84. For this reason, no fins to guide the air are disposed on an outer surface of the motor housing 84.

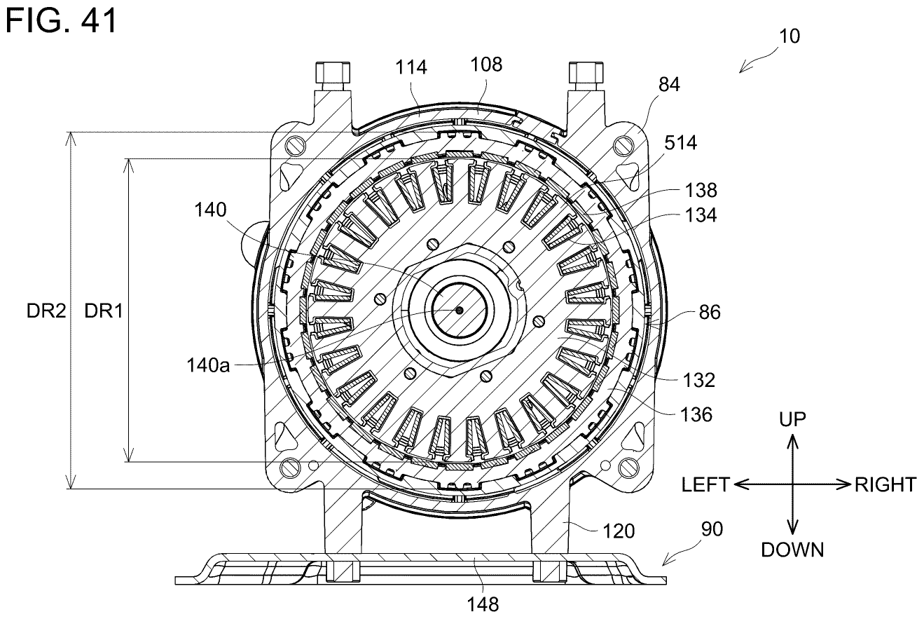

As shown in FIG. 41, the stator body 132 of the motor 86 is surrounded by the outer rotor body 136. A diameter DR1 of the stator body 132 is, for example, equal to or less than 125 mm. This suppresses the motor 86 from becoming larger in size. The diameter DR1 may be equal to or less than 120 mm. The diameter DR1 is, for example, equal to or more than 110 mm. Due to this, the decrease of the maximum output value of the motor 86 as the motor 86 is downsized can be suppressed. The diameter DR1 may be equal to or more than 115 mm. As shown in FIG. 39, a length L13 of the stator body 132 in the front-rear direction is, for example, equal to or less than 23 mm. This suppresses the motor 86 from becoming larger. Further, the length L13 may be equal to or less than 20 mm. The length L13 is, for example, equal to or more than 13 mm. Due to this, a decrease in the maximum output value of the motor 86 as the motor 86 is downsized can be suppressed. The length L13 may be equal to or more than 15 mm.

A diameter DR2 of the outer rotor body 136 is, for example, equal to or less than 148 mm. This suppresses the motor 86 from becoming larger. The diameter DR2 may be equal to or less than 145 mm. Further, the diameter DR2 may be equal to or more than 138 mm, for example. Due to this, the decrease of the maximum output value of the motor 86 as the motor 86 is downsized can be suppressed. The diameter DR2 may be equal to or more than 140 mm. The diameter DR2 is larger than the diameter DR1.

As shown in FIG. 41, the stator body 132 has a plurality of (24 in the present embodiment) teeth 514. The coil 134 is wound around each of the teeth 514. The twenty-four teeth 514 are arranged at equal intervals around the central axis 140a.

The plurality of permanent magnets 138 are fixed to the outer rotor body 136, the plurality of permanent magnets 138 are arranged to surround the stator body 132. The plurality of permanent magnets 138 is disposed between the outer rotor body 136 and the teeth 514. In the present embodiment, the number of the plurality of permanent magnets 138 is 28. The number of the plurality of permanent magnets 138 is greater than or equal to the number of the plurality of teeth 514. Further, the number of the plurality of permanent magnets 138 is less than 1.5 times the number of the plurality of teeth 514.

A residual magnetic flux density Br of the permanent magnets 138 is, for example, equal to or more than 1.32 T. Due to this, the magnetic force generated by the permanent magnets 138 can be made stronger. The residual magnetic flux density may be equal to or more than 1.40 T or equal to or more than 1.50 T. Further, the residual magnetic flux density Br is for example, equal to or less than 1.8 T. The residual magnetic flux density Br may be equal to or less than 1.7 T or equal to or less than 1.6 T.

A coercivity bHc of the permanent magnets 138 is, for example, equal to or more than 971 kA/m. Due to this, the magnetic force generated by the permanent magnets 138 can be made stronger. The coercivity bHc may be equal to or more than 1000 kA/m or equal to or more than 1050 kA/m. Further, the coercivity bHc is, for example, equal to or less than 1200 kA/m. The coercivity bHc may be equal to or less than 1150 kA/m or equal to or less than 1100 kA/m.

In the present embodiment, the permanent magnets 138 are, for example, neodymium magnets. The magnetic force of the permanent magnets 138 is greater than the magnetic force of a samarium cobalt magnet, a ferrite magnet, and a praseodymium magnet, respectively.

In the present embodiment, the maximum output value of the motor 86 is, for example, equal to or more than 1.80 kW. The maximum output value of the motor 86 may be equal to or more than 2.0 kW. Further, the maximum output value of the motor 86 may be equal to or less than 4.0 kW, for example. The maximum output value of the motor 86 may be equal to or less than 3.0 kW, or may be equal to or less than 2.35 kW.

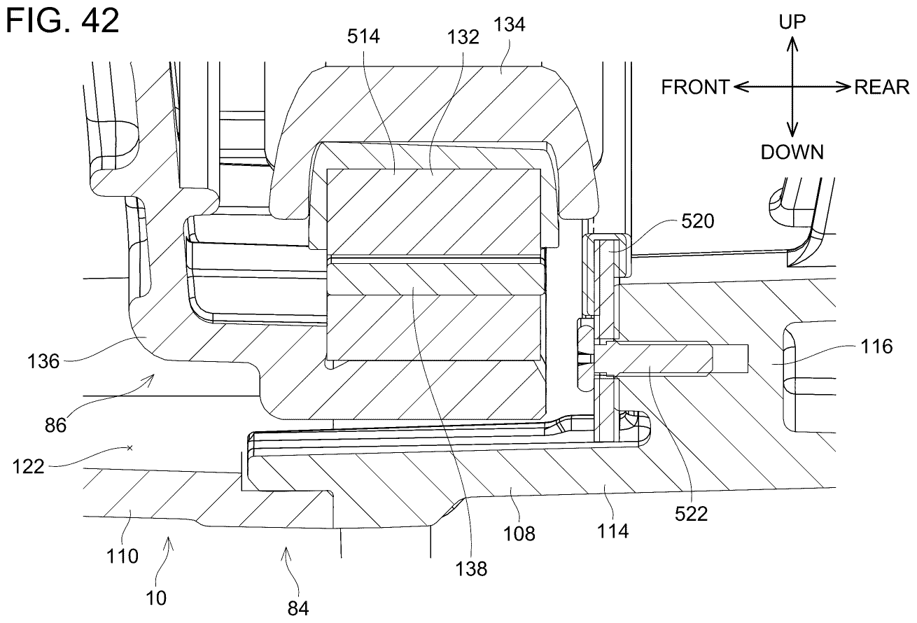

As shown in FIG. 39, the motor unit 10 further comprises a sensor board 520. The sensor board 520 comprises a plurality of Hall elements (not shown). The Hall elements detect the magnetic force from the permanent magnets 138, and the sensor board 520 detects the rotation of the motor 86. The sensor board 520 is disposed in the motor accommodating space 122. With respect to the front-rear direction, the sensor board 520 is positioned between the bearing 144 and the bearing 142. As shown in FIG. 42, the sensor board 520 is opposed to the permanent magnet 138 in the front-rear direction. The sensor board 520 is disposed rearward of the outer rotor body 136 and the permanent magnets 138. The sensor board 520 is fixed to the motor housing body 108 by screws 522. The sensor board 520 is disposed rearward of the front bracket 110.

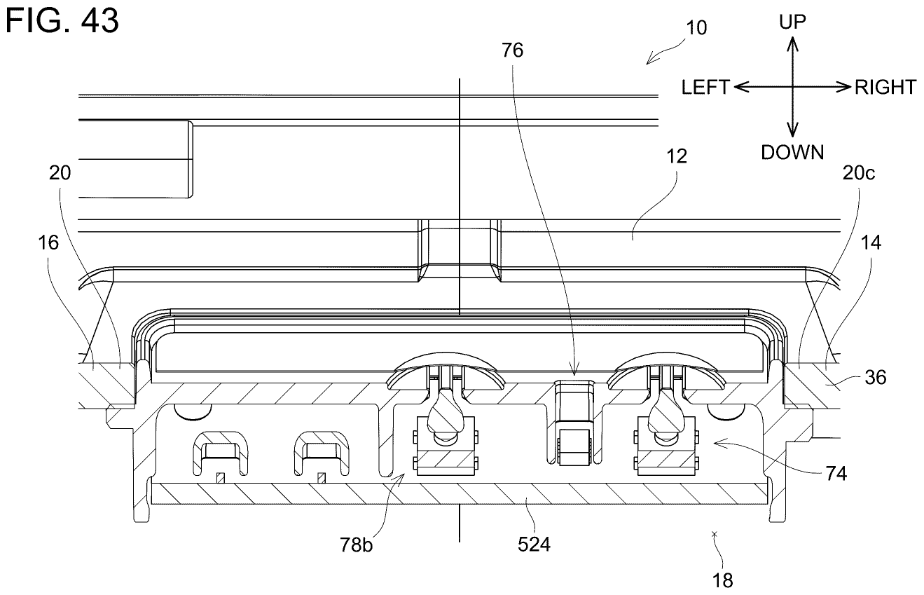

As shown in FIG. 7, the main power switch 74, the display panel 76, the operation switch 78a, and the speed change switch 78b are disposed on the upper wall 20c of the accommodating part 20 of the body housing 12. The main power switch 74 accepts user operation to switch the motor unit 10 between an on state and an off state. The display panel 76 turns on when the motor unit 10 is in the on state and turns off when the motor unit 10 is in the off state. The display panel 76 corresponds to an indicator light. The operation switch 78a accepts user operation to operate the motor 86. The speed change switch 78b accepts user operation to change the speed of the motor shaft 140. As shown in FIG. 43, the main power switch 74, the display panel 76, and the speed change switch 78b are disposed on the switch board 524.

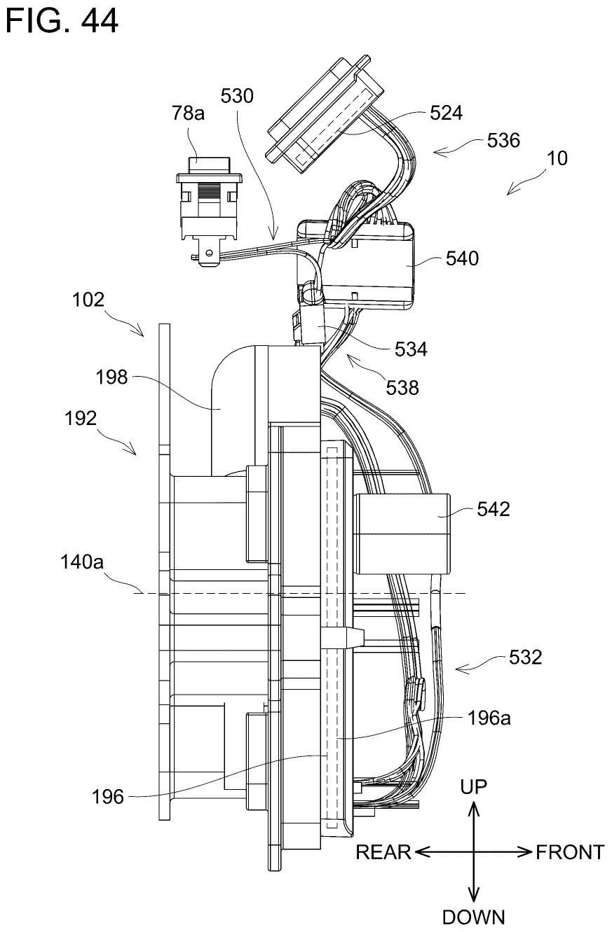

As shown in FIG. 44, the motor unit 10 comprises the plurality of first switch signal wires 530, the plurality of first switch connection signal wires 532, a first switch connection terminal 534, the plurality of second switch wires 536, the plurality of second switch connection wires 538, and a second switch connection terminal 540.

The plurality of first switch signal wires 530 is connected to and extends from the operation switch 78a. The plurality of first switch signal wires 530 is disposed above the control circuit board 196. The plurality of first switch connection signal wires 532 is connected to the mounting surface 196a of the control circuit board 196 and extends from the mounting surface 196a of the control circuit board 196. The mounting surface 196a is substantially perpendicular to the front-rear direction, the mounting surface 196a facing frontward. Electronic component(s) 542 are mounted on the mounting surface 196a. The electronic component(s) 542 are, for example, capacitors, resistors and inductors. The first switch connection terminal 534 is disposed above the control circuit board 196. The first switch connection terminal 534 connects the plurality of first switch signal wires 530 and the plurality of first switch connection signal wires 532. As a result, when the operation switch 78a is operated by the user, a signal is sent from the operation switch 78a to the control circuit board 196 via the first switch signal wires 530, the first switch connection terminal 534, and the first switch connection signal wires 532.

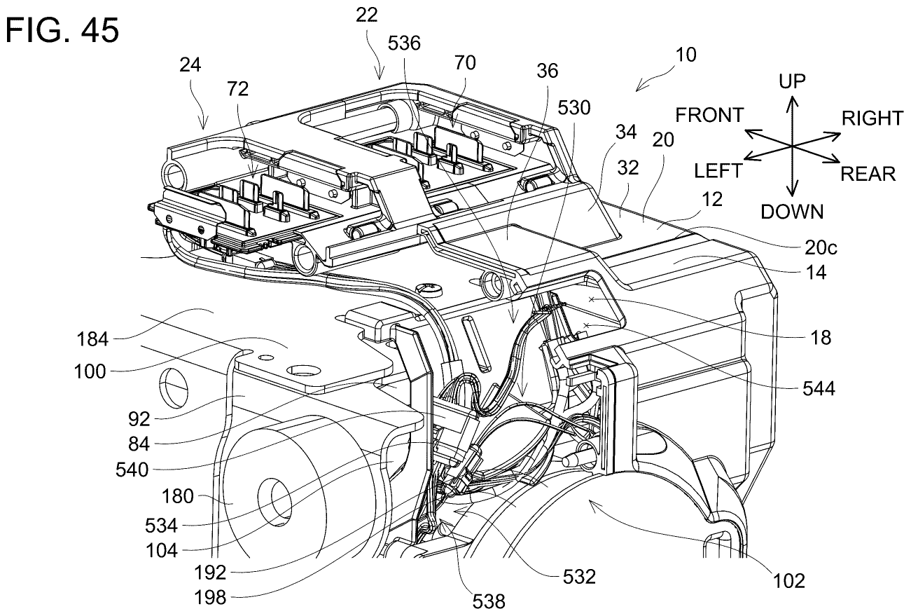

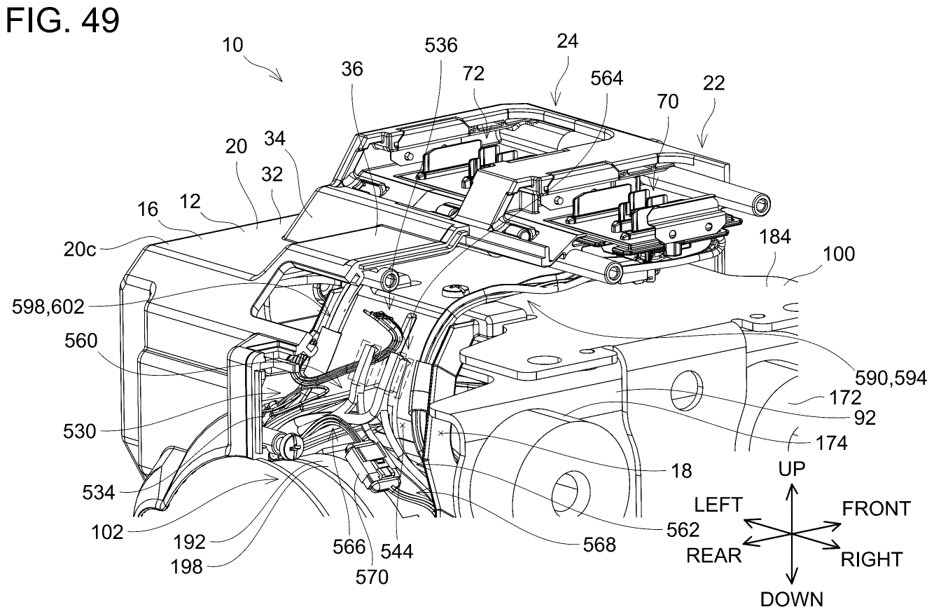

As shown in FIG. 45, the body housing 12 has a terminal accommodating space 544 inside, which is disposed above the control unit 102. The plurality of first switch signal wires 530 and the first switch connection terminal 534 are disposed in the terminal accommodating space 544. The plurality of first switch signal wires 530 and the first switch connection terminal 534 are disposed above the control unit 102. The terminal accommodating space 544 is disposed between the upper wall 20c of the accommodating part 20 of the body housing 12 and the control unit 102. The terminal accommodating space 544 is disposed rearward of the motor housing 84 and the tubular vibration-proof member 104. Thus, the first switch connection terminal 534 is disposed rearward of the fan 88 (see FIG. 34), the bearing 142 (see FIG. 34), and the stator body 132 (see FIG. 34). With respect to the left-right direction, the first switch connection terminal 534 is to the right of the first left vibration-proof member 176 (see FIG. 19), the second left vibration-proof member 178 (see FIG. 19), and the third left vibration-proof member 180 and to the left of the first right vibration-proof member 170 (see FIG. 18), the second right vibration-proof member 172 (see FIG. 18), and the third right vibration-proof member 174 (see FIG. 49). With respect to the left-right direction, the first switch connection terminal 534 is disposed between a right end and a left end of the motor 86 (see FIG. 41). Thus, with respect to the left-right direction, the first switch connection terminal 534 is disposed between a right end of the first battery pack BP1 (see FIG. 4) and a left end of the second battery pack BP2 (see FIG. 4) and between the right wall 154a and the left wall 154b of the plate member 92 (see FIG. 17). With respect to the left-right direction, the first switch connection terminal 534 is disposed between a right end and a left end of the control circuit board 196.

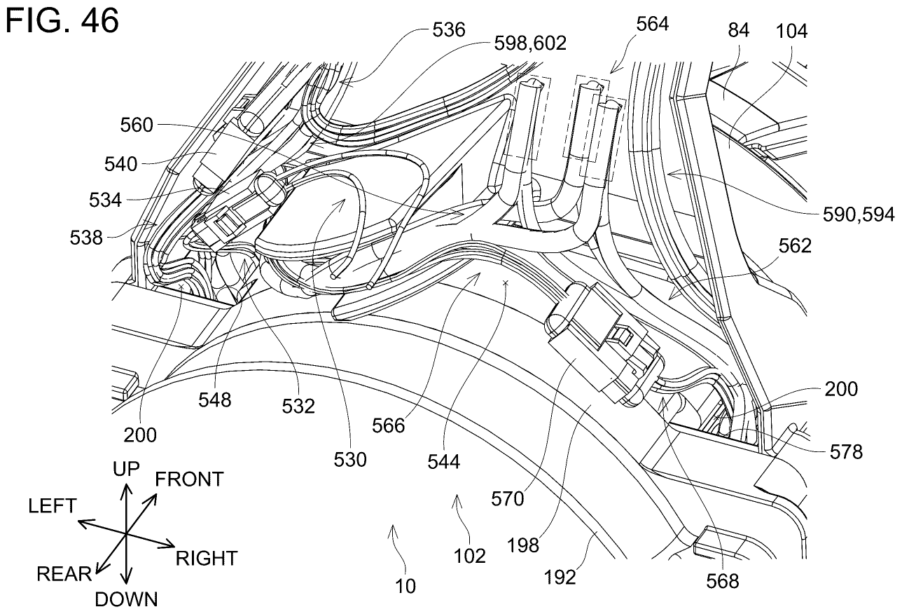

As shown in FIG. 46, the outer housing part 198 of the control unit 102 has an opening 548 for first electric wires (first electrical wire opening 548) that connects the interior space 200 to outside of the outer housing part 198 and the first electrical wire opening 548 is disposed on an upper part of the outer housing part 198. A plurality of first switch connection signal wires 532 penetrates the first electrical wire opening 548.

As shown in FIG. 44, the plurality of second switch wires 536 is connected to the switch board 524. The plurality of second switch wires 536 extends from the main power switch 74 (see FIG. 43), the display panel 76 (see FIG. 43), and the speed change switch 78b (see FIG. 43) via the switch board 524. Some of the plurality of second switch wires 536 are power wires and the remaining second switch wires 536 are signal wires. The plurality of second switch wires 536 is disposed above the control circuit board 196. The plurality of second switch connection wires 538 is connected to the mounting surface 196a of the control circuit board 196 and extends from the mounting surface 196a of the control circuit board 196. Some of the plurality of second switch connection wires 538 are power wires, and the remaining second switch connection wires 538 are signal wires. The second switch connection terminal 540 is disposed above the control circuit board 196. terminal for second switch connection 540 connects the plurality of second switch wires 536 and the plurality of second switch connection wires 538. As a result, when the main power switch 74 and the speed change switch 78b are operated by the user, respectively, signals are sent from the switch board 524 to the control circuit board 196 via the second switch wires 536, the second switch connection terminal 540, and the second switch connection wires 538. A signal is also sent from the control circuit board 196 to the switch board 524 via the second switch connection wires 538, the second switch connection terminal 540, and the second switch wires 536, causing the display panel 76 to light or turn off.

As shown in FIG. 45, the plurality of second switch wires 536 and the second switch connection terminal 540 are disposed in the terminal accommodating space 544. Therefore, the second switch connection terminal 540 is disposed rearward of the fan 88 (see FIG. 34), the bearing 142 (see FIG. 34), and the stator body 132 (see FIG. 34). The plurality of second switch wires 536 and the second switch connection terminal 540 are disposed above the control unit 102. In the left-right direction, the second switch connection terminal 540 is disposed to the right of the first left vibration-proof member 176 (see FIG. 19), the second left vibration-proof member 178 (see FIG. 19), and the third left vibration-proof member 180 (see FIG. 45). and to the left of the first right vibration-proof member 170 (see FIG. 18), the second right vibration-proof member 172 (see FIG. 18), and the third right vibration-proof member 174 (see FIG. 49). With respect to the left-right direction, the second switch connection terminal 540 is disposed between the right end and the left end of the motor 86 (see FIG. 41). Thus, with respect to the left-right direction, the second switch connection terminal 540 is disposed between the right end of the first battery pack BP1 (see FIG. 4) and the left end of the second battery pack BP2 (see FIG. 4) and between the right wall 154a and the left wall 154b of the plate member 92 (see FIG. 17). With respect to the left-right direction, the second switch connection terminal 540 is disposed between the right and left ends of the control circuit board 196. As shown in FIG. 46, the plurality of second switch connection wires 538 penetrates the first electrical wire opening 548.

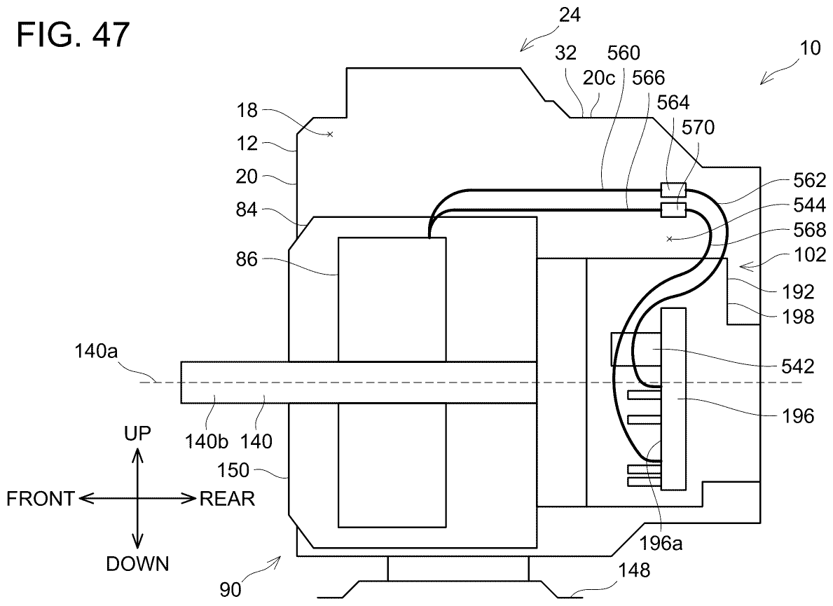

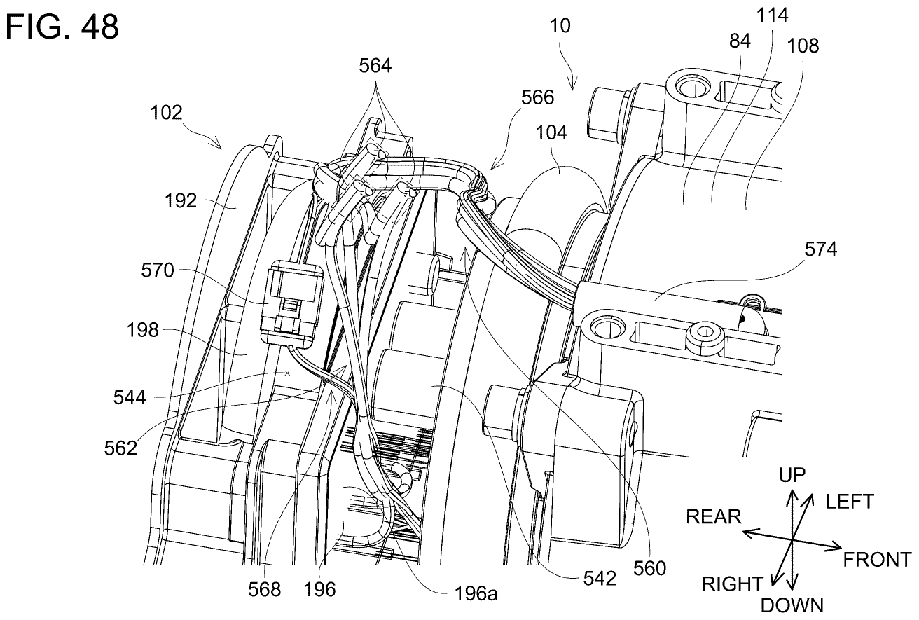

As shown in FIGS. 47 and 48, the motor unit 10 comprises a plurality of motor power wires 560, a plurality of motor connection power wires 562, a plurality of first motor connection terminals 564, a plurality of motor signal wires 566, a plurality of motor connection signal wires 568, and a second motor connection terminal 570.

As shown in FIG. 40, the motor housing body 108 has a connecting tube part 574 that connects the motor accommodating space 122 to the outside of the motor housing 84, and the connecting tube part 574 extends rearward from the tube portion 114. The plurality of motor power wires 560 penetrates the connecting tube part 574. Although not shown, the plurality of motor power wires 560 is connected to the coil 134. The plurality of motor power wires 560 extends from the coil 134 and extends rearward after penetrating the connecting tube part 574.

As shown in FIGS. 47 and 48, the motor connection power wires 562 are connected to and extends from the mounting surface 196a of the control circuit board 196.

The plurality of first motor connection terminals 564 is disposed above the control circuit board 196. In FIGS. 46, 48, and 49, the first motor connection terminals 564 are illustrated by dashed lines. The first motor connection terminals 564 connect the motor power wires 560 and the motor connection power wires 562. As a result, power to operate the motor 86 is supplied from the control circuit board 196 to the motor 86 via the motor power wires 560, the first motor connection terminals 564, and the motor connection power wires 562.

As shown in FIGS. 47 and 49, the plurality of motor power wires 560 and the plurality of first motor connection terminals 564 are disposed above the control unit 102. The plurality of first motor connection terminals 564 is disposed in the terminal accommodating space 544. Thus, the first motor connection terminals 564 are disposed rearward of the fan 88 (see FIG. 34), the bearing 142 (see FIG. 34), and the stator body 132 (see FIG. 34). Further, with respect to the front-rear direction, at least a portion of the first motor connection terminals 564 is disposed frontward of the control circuit board 196. In the left-right direction, the first motor connection terminals 564 are disposed to the right of the first left vibration-proof member 176 (see FIG. 19), the second left vibration-proof member 178 (see FIG. 19), and the third left vibration-proof member 180 (see FIG. 45) and is disposed to the left of the first right vibration-proof member 170 (see FIG. 18), the second right vibration-proof member 172 (see FIG. 18), and the third right vibration-proof member 174 (see FIG. 45). With respect to the left-right direction, the first motor connection terminals 564 are disposed between the right end and the left end of the motor 86 (see FIG. 41). Thus, with respect to the left-right direction, the first motor connection terminals 564 are disposed between the right end of the first battery pack BP1 (see FIG. 4) and the left end of the second battery pack BP2 (see FIG. 4) and between the right wall 154a and the left wall 154b of the plate member 92 (see FIG. 17). With respect to the left-right direction, the first motor connection terminals 564 are disposed between the right and left ends of the control circuit board 196.

As shown in FIG. 46, the outer housing part 198 has a second opening 578 for power wires (second power wire opening 578) that connects the interior space 200 to the outside of the outer housing part 198 and the second power wire opening 578 is disposed on an upper part of the outer housing part 198. The plurality of motor connection power wires 562 penetrates the second power wire opening 578.

As shown in FIG. 40, the plurality of motor signal wires 566 penetrates the connecting tube part 574. The plurality of motor signal wires 566 is connected to the sensor board 520. The plurality of motor signal wires 566 extends from the sensor board 520 and extends rearward after penetrating the connecting tube part 574.

As shown in FIGS. 47 and 48, the plurality of motor connection signal wires 568 is connected to and extends from the mounting surface 196a of the control circuit board 196.

The second motor connection terminal 570 is disposed above the control circuit board 196. The second motor connection terminal 570 connects the plurality of motor signal wires 566 and the plurality of motor connection signal wires 568. As a result, a signal detected by the sensor board 520 (see FIG. 40) is sent from the sensor board 520 to the control circuit board 196 via the motor signal wires 566, the second motor connection terminal 570, and the motor connection signal wires 568. As a result, the control circuit board 196 detects the rotation of the motor 86.

As shown in FIGS. 47 and 49, the plurality of motor signal wires 566 and the second motor connection terminal 570 are disposed above the control unit 102. The second motor connection terminal 570 is disposed in the terminal accommodating space 544. Therefore, the second motor connection terminal 570 is disposed rearward of the fan 88 (see FIG. 34), the bearing 142 (see FIG. 34), and the stator body 132 (see FIG. 34). In the left-right direction, the second motor connection terminal 570 is disposed to the right of the first left vibration-proof member 176 (see FIG. 19), the second left vibration-proof member 178 (see FIG. 19), and the third left vibration-proof member 180 (see FIG. 45), and is disposed to the left of the first right vibration-proof member 170 (see FIG. 18), the second right vibration-proof member 172 (see FIG. 18), and the third right vibration-proof member 174. With respect to the left-right direction, the second motor connection terminal 570 is disposed between the right and left ends of the motor 86 (see FIG. 41). Thus, with respect to the left-right direction, the second motor connection terminal 570 is disposed between the right end of the first battery pack BP1 (see FIG. 4) and the left end of the second battery pack BP2 (see FIG. 4), between the right wall 154a and the left wall 154b of the plate member 92 (see FIG. 17). With respect to the left-right direction, the second motor connection terminal 570 is disposed between the right and left ends of the control circuit board 196. As shown in FIG. 46, the plurality of motor connection signal wires 568 penetrates the second power wire opening 578.

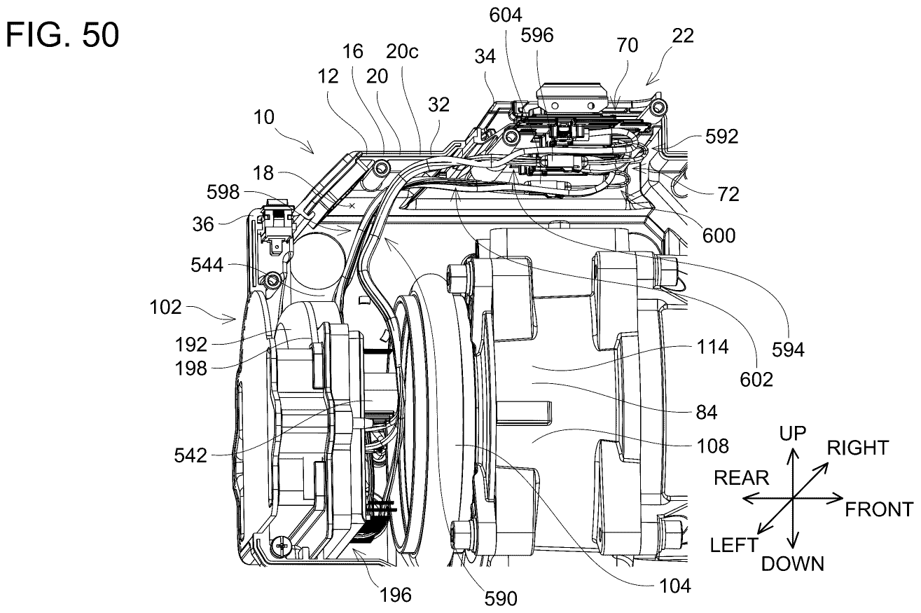

As shown in FIG. 50, the motor unit 10 comprises a plurality of first battery power wires 590, a plurality of first battery signal wires 592, a plurality of first battery connection signal wires 594, a first battery connection terminal 596, a plurality of second battery power wires 598, a plurality of second battery signal wires 600, a plurality of second battery connection signal wires 602, and a second battery connection terminal 604.

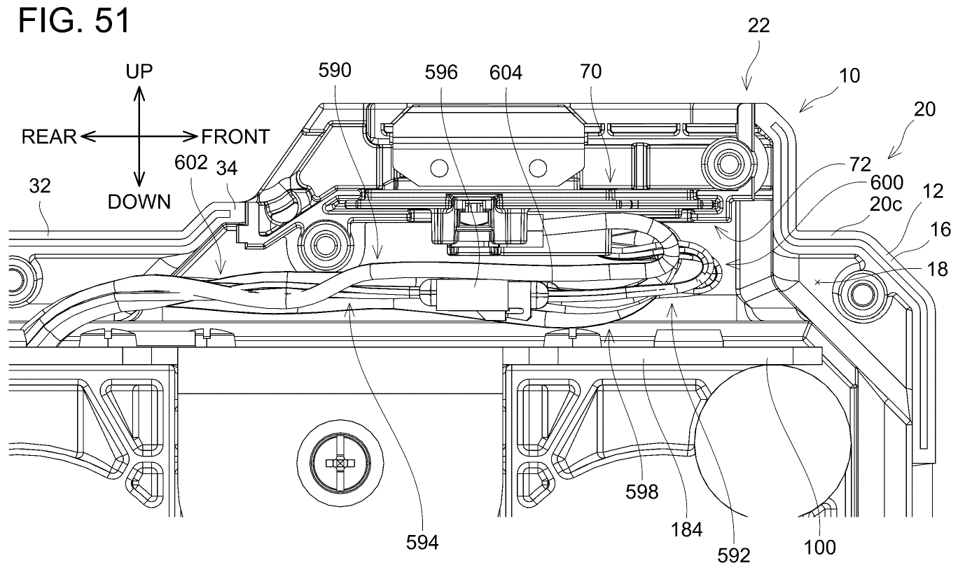

The plurality of first battery power wires 590 is connected to the first battery terminal 70 and the mounting surface 196a of the control circuit board 196 (see FIG. 48). The plurality of first battery power wires 590 extends from the first battery terminal 70 to the mounting surface 196a of the control circuit board 196. Thereby, power from the first battery pack BP1 (see FIG. 4) is supplied from the first battery terminal 70 to the control circuit board 196 via the first battery power wires 590. As shown in FIG. 51, the first battery power wires 590 pass between the first battery terminal 70 and the support plate 184. As shown in FIG. 46, the first battery power wires 590 pass through the second power wire opening 578.

As shown in FIG. 50, the plurality of first battery signal wires 592 is connected to and extends from the first battery terminal 70.

The plurality of first battery connection signal wires 594 is connected to and extends from the mounting surface 196a of the control circuit board 196 (see FIG. 48). As shown in FIG. 46, the plurality of first battery connection signal wires 594 passes through the second power wire opening 578.

As shown in FIG. 50, the first battery connection terminal 596 connects the plurality of first battery signal wires 592 and the plurality of first battery connection signal wires 594. Due to this, a signal is sent from the first battery pack BP1 to the control circuit board 196 and from the control circuit board 196 to the first battery pack BP1 via the first battery terminal 70, the first battery signal wires 592, the first battery connection terminals 596, and the first battery connection signal wires 594. With respect to the up-down direction, the first battery connection terminal 596 is disposed above the control unit 102. As shown in FIG. 51, the first battery connection terminal 596 is disposed between the first battery terminal 70 and the support plate 184. With respect to the left-right direction, the first battery connection terminal 596 is disposed between the right end and the left end of the motor 86 (see FIG. 41).

As shown in FIG. 50, the plurality of second battery power wires 598 is connected to the second battery terminal 72 and the control circuit board 196. The plurality of second battery power wires 598 extends from the second battery terminal 72 to the control circuit board 196. Due to this, power from the second battery pack BP2 (see FIG. 4) is supplied from the second battery terminal 72 to the control circuit board 196 from the second battery power wires 598. As shown in FIG. 51, the second battery power wires 598 pass between the second battery terminal 72 and the support plate 184. As shown in FIG. 46, the second battery power wires 598 pass through the first electrical wire opening 548.

As shown in FIG. 50, the plurality of second battery signal wires 600 is connected to and extends from the second battery terminal 72.

The plurality of second battery connection signal wires 602 is connected to the mounting surface 196a of the control circuit board 196 (see FIG. 48) and extends from the mounting surface 196a of the control circuit board 196. As shown in FIG. 46, the plurality of second battery connection signal wires 602 passes through the first electrical wire opening 548.

As shown in FIG. 50, the second battery connection terminal 604 connects the plurality of second battery signal wires 600 and the plurality of second battery connection signal wires 602. Due to this, a signal is sent from the second battery pack BP2 to the control circuit board 196 and from the control circuit board 196 to the second battery pack BP2 via the second battery terminal 72, the second battery signal wires 600, the second battery connection terminal 604, and the second battery connection signal wires 602. With respect to the up-down direction, the second battery connection terminal 604 is disposed above the control unit 102. The second battery connection terminal 604 is arranged side-by-side with the first battery connection terminal 596 in the left-right direction. As shown in FIG. 51, the second battery connection terminal 604 is disposed between the second battery terminal 72 and the support plate 184. With respect to the left-right direction, the second battery connection terminal 604 is disposed between the right end and the left end of the motor 86 (see FIG. 41).

### Effects

The motor unit 10 in the present embodiment is configured to be detachably attached to each of the plate compactor 4b (example of first working unit) and the rammer 4a (example of second working unit) to operate the plate compactor 4b and the rammer 4a. The motor unit 10 comprises the motor 86 comprising the motor shaft 140, wherein the motor 86 has the maximum output value equal to or more than 1.8 kW, the motor housing 84 supporting the motor 86, and the body housing 12 comprising the first battery receptacle 22 (example of battery receptacle) to which the battery pack BP is configured to be detachably attached, the body housing 12 accommodating the motor housing 84, and the bearing 144 (example of first bearing) and a bearing 142 (example of second bearing) that are attached to the motor housing 84 and rotatably support the motor shaft 140. The bearing 142 is disposed rearward of the bearing 144. The distance L11 between the front end of the bearing 144 and the rear end of the bearing 142 is equal to or less than 115 mm.

According to the above configuration, the motor unit 10 can be suppressed from becoming larger as compared to a configuration in which the distance L11 between the front end of the bearing 144 and the rear end of the bearing 142 exceeds 115 mm.

Further, the bearings 144 and 142 are disposed inside the motor housing 84.

According to the above configuration, the user touching the bearings 144 and 142 can be suppressed.

Further, the motor housing 84 comprises the front bracket 110 (example of first member) to which the bearing 144 is attached, the motor housing body 108 (example of second member) defining the motor accommodating space 122 (example of accommodating space) which accommodates the motor 86 between the front bracket 110 and the motor housing body 108 and to which the bearing 142 is attached.

According to the above configuration, the configuration of the motor housing 84 can be suppressed from becoming complicated as compared to the configuration in which the bearing 144 and the bearing 142 are attached on the same member.

Further, the motor unit 10 further comprises the fan 88 fixed to the motor shaft 140 and disposed only outside the motor accommodating space 122. The motor housing 84 includes the air vent 510. The air flows into the motor accommodating space 122 through the air vent 510 by the rotation of the fan 88.

According to the above configuration, the motor housing 84 can be suppressed from becoming larger as compared to a configuration in which the fan 88 is disposed in the motor accommodating space 122.

Further, the motor unit 10 further comprises the control unit 102 configured to drive the motor 86. The air flows from the control unit 102 toward the air vent 510 by the rotation of the fan 88.

According to the above configuration, the air passes through the control unit 102 and the air vent 510 before passing through the motor 86. Due to this, a single air stream can cool both the control unit 102 and the motor 86.

Further, when the motor unit 10 is viewed along the direction in which the motor shaft 140 extends, the control unit 102 at least partially overlaps the motor 86.

According to the above configuration, when the motor unit 10 is viewed along the direction in which the motor shaft 140 extends, the motor unit 10 can be suppressed from becoming larger in the direction perpendicular to the direction in which the motor shaft 140 extends, as compared to a configuration in which the control unit 102 does not overlap the motor 86.

Further, the motor unit 10 further comprises the sensor board 520 disposed in the motor accommodating space 122 and configured to detect the rotation of the motor 86. The motor shaft 140 comprises the front end 140b (example of fixing part) configured to be fixed to each of the rammer 4a and the plate compactor 4b. The bearing 144 is disposed between the front end 140b of the motor shaft 140 and the bearing 142. The sensor board 520 is fixed to the motor housing body 108.

According to the above configuration, the sensor board 520 can be farther separated from the rammer 4a and plate compactor 4b, as compared to a configuration in which the sensor board 520 is fixed to the front bracket.

The motor unit 10 further comprises the fixing unit 90 comprising the first fixing part 148 configured to be fixed to the plate compactor 4b and the second fixing part 150 configured to be fixed to the rammer 4a. When the motor unit 10 is placed on the placement surface P1, the first fixing part 148 is placed on the placement surface P1. The motor shaft 140 comprises the front end 140b (example of fixing part) configured to be fixed to each of the plate compactor 4b and the rammer 4a. The front end 140b of the motor shaft 140 is substantially parallel to the first fixing part 148.

According to the above configuration, the front end 140b of the motor shaft 140 can easily be fixed to the plate compactor 4b when the first fixing part 148 is fixed to the plate compactor 4b.

The motor unit 10 further comprises the fixing unit 90 comprising the first fixing part 148 configured to be fixed to the plate compactor 4b and the second fixing part 150 configured to be fixed to the rammer 4a. When the motor unit 10 is placed on the placement surface P1, the first fixing part 148 is placed on the placement surface P1. When the first battery pack BP1 (example of a battery pack) is attached to the first battery receptacle 22 (example of a battery receptacle), the first battery pack BP1 is substantially parallel to the fixing part 148 and disposed above the motor 86.

The motor 86 is a high-weight component. Further, the weight of the motor 86 is greater than the weight of the first battery pack BP1. According to the above configuration, the high-weight motor 86 can be placed closer to the placement surface P1 than the first battery pack BP1 is to the placement surface P1. Due to this, the center of gravity G1 of the motor unit 10 can be positioned closer to the placement surface P1.

Further, the first battery pack BP1 (example of battery pack) is configured to be used for the power tool 6.

According to the above configuration, the motor unit 10 can be operated using the highly versatile first battery pack BP1.

The motor unit 10 further comprises the operation switch 78a (example of switch) configured to accept a user operation of controlling the motor 86. The operation switch 78a is disposed on the body housing 12.

According to the above configuration, the configuration of the motor unit 10 can be suppressed from becoming complicated as compared to a configuration in which the operation switch 78a is disposed in another component other than the body housing 12.

The motor unit 10 further comprises the control unit 102 configured to drive the motor 86, the first switch signal wires 530 (example of switch electric wire) extending from the operation switch 78a, the first switch connection signal wires 532 (example of switch connection electric wire) extending from the control unit 102 and connected to the first switch signal wires 530. The first battery receptacle 22 is disposed on the upper wall 20c (example of first wall) of the body housing 12. The first switch connection terminal 534 (example of terminal) connecting the first switch signal wires 530 and the first switch connection signal wires 532 is disposed in the terminal accommodating space 544 (example of a space) between the upper wall 20c and the control unit 102.

According to the above configuration, the first switch connection terminal 534 connecting the first switch signal wires 530 and the first switch connection signal wires 532 is disposed in the terminal accommodating space 544 between the upper wall 20c and the control unit 102, by which the terminal accommodating space 544 between the upper wall 20c and the control unit 102 can be used efficiently.

Further, the motor unit 10 further comprises the motor signal wires 566 (example of motor electric wire) extending from the motor 86 and the motor connection signal wires 568 (example of motor connection electric wire) extending from the control unit 102 and connected to the motor signal wires 566. The second motor connection terminal 570 (example of terminal) connecting the motor signal wires 566 and the motor connection signal wires 568 is disposed in the terminal accommodating space 544 between the upper wall 20c and the control unit 102.

According to the above configuration, the second motor connection terminal 570 connecting the motor signal wires 566 and the motor connection signal wires 568 is disposed in the terminal accommodating space 544 between the upper wall 20c and the control unit 102. Due to this, the terminal accommodating space 544 between the upper wall 20c and the control unit 102 can be used efficiently.

Further, the motor 86 comprises the stator body 132, the coil 134 wound around the stator body 132, the outer rotor body 136 (example of rotor body), and the plurality of permanent magnets 138 (example of magnets) fixed to the outer rotor body 136. The residual magnetic flux density of each of the permanent magnets 138 is equal to or more than 1.32 T. The coercivity of each of the permanent magnets 138 is equal to or more than 971 kA/m.

According to the above configuration, the permanent magnets 138 can be made smaller as compared to a configuration in which the residual magnetic flux density of each of the permanent magnets 138 is less than 1.32 T and/or the coercivity of each of the permanent magnets 138 is less than 971 kA/m. Due to this, the motor unit 10 can be downsized.

Further, the permanent magnets 138 are neodymium magnets.

According to the above configuration, since the magnetic force of the neodymium magnet is the strongest among permanent magnets, the permanent magnets 138 can be made smaller. Due to this, the motor unit 10 can be downsized.

The stator body 132 comprises the plurality of teeth 514. The number of the plurality of permanent magnets 138 is equal to or more than the number of the plurality of teeth 514.

According to the above configuration, an occurrence of cogging can be suppressed during operation of the motor 86.

The motor unit 10 further comprises the control unit 102 configured to drive the motor 86, the first right vibration-proof member 170, the second right vibration-proof member 172, the third right vibration-proof member 174, the first left vibration-proof member 176, the second left vibration-proof member 178, and the third left vibration-proof member 180 (examples of vibration-proof member) configured to be elastically deformable and suppress transmission of vibration of the motor 86 from the motor 86 to the first battery receptacle 22 and transmission of vibration of the motor 86 from the motor 86 to the control unit 102.

According to the above configuration, the battery pack BP and control unit 102 can be suppressed from vibrating even if the motor 86 vibrates due to the operation of the motor 86.

The motor unit 10 in the present embodiment is configured to be detachably attached to each of the plate compactor 4b (example of first working unit) and the rammer 4a (example of second working unit) to drive the plate compactor 4b and rammer 4a. The motor unit 10 comprises the motor 86 comprising the motor shaft 140, the motor housing 84 including the motor accommodating space 122 (example of accommodating space) which accommodates the motor 86 and including the air vent 510, the body housing 12 comprising the first battery receptacle 22 to which the battery pack BP is configured to be detachably attached (example of battery receptacle), the body housing 12 accommodating the motor housing 84, the fan 88 fixed to the motor shaft 140 and disposed only outside the motor accommodating space 122, and the fixing unit 90 comprising the first fixing part 148 configured to be fixed to the plate compactor 4b, and the second fixing part 150 configured to be fixed to the rammer 4a. When the fan 88 rotates, air passes through a space inside the body housing 12 and outside the motor housing 84, the air vent 510, and the motor accommodating space 122 in this order.

According to the above configuration, since the fan 88 is located outside of the motor accommodating space 122, the motor housing 84 can be suppressed from becoming larger. This can suppress the motor unit 10 from becoming larger in size.

The motor unit 10 further comprises the control unit 102 configured to drive the motor 86. The air flows from the control unit 102 toward the air vent 510 by the rotation of the fan 88.

According to the above configuration, the air passes through the control unit 102 and the air vent 510 before passing through the motor 86. Due to this, a single air stream can cool both the control unit 102 and the motor 86.

Further, when the motor unit 10 is viewed along the direction in which the motor shaft 140 extends, the control unit 102 at least partially overlaps the motor 86.

According to the above configuration, when the motor unit 10 is viewed along the direction in which the motor shaft 140 extends, the motor unit 10 can be suppressed from becoming larger in the direction perpendicular to the direction in which the motor shaft 140 extends, as compared to a configuration in which the control unit 102 does not overlap the motor 86.

The motor unit 10 in the present embodiment is configured to be detachably attached to each of the plate compactor 4b (example of first working unit) and rammer 4a (example of second working unit) to drive the plate compactor 4b and rammer 4a. The motor unit 10 comprises the motor 86, the motor housing 84 supporting the motor 86, the control unit 102 configured to drive the motor 86, the body housing 12 comprising the first battery receptacle 22 (example of battery receptacle) to which the battery pack BP is configured to be detachably attached, the body housing 12 accommodating the motor housing 84 and the control unit 102, the motor signal wires 566 (example of motor electric wire) extending from the motor 86, and the motor connection signal wires 568 (example of motor connection electric wire) extending from the control unit 102 and connected to the motor signal wires 566. The first battery receptacle 22 is disposed on the upper wall 20c (example of first wall) of the body housing 12. The second motor connection terminal 570 (example of terminal) connecting the motor signal wires 566 and the motor connection signal wires 568 is disposed in the terminal accommodating space 544 (example of a space) between the upper wall 20c and the control unit 102.

According to the above configuration, the second motor connection terminal 570 connecting the motor signal wires 566 and the motor connection signal wires 568 is disposed in the terminal accommodating space 544 between the upper wall 20c and the control unit 102, by which the terminal accommodating space 544 between the upper wall 20c and the control unit 102 can be used efficiently.

Further, the motor unit 10 further comprises the operation switch 78a (example of switch) configured to accept an operation by a user of controlling the motor 86, the first switch signal wires 530 (example of switch electric wire) extending from the operation switch 78a, the first switch connection signal wires 532 (example of switch connection electric wire) extending from the control unit 102 and connected to the first switch signal wires 530. The first switch connection terminal 534 (example of a terminal) connecting the first switch signal wires 530 and the first switch connection signal wires 532 is disposed in the terminal accommodating space 544 between the upper wall 20c and the control unit 102.

According to the above configuration, the first switch connection terminal 534 connecting the first switch signal wires 530 and the first switch connection signal wires 532 is disposed in the terminal accommodating space 544 between the upper wall 20c and the control unit 102, by which the terminal accommodating space 544 between the upper wall 20c and the control unit 102 can be efficiently used.

The motor unit 10 in the present embodiment is configured to be detachably attached to each of the plate compactor 4b (example of first working unit) and the rammer 4a (example of second working unit) to drive the plate compactor 4b and rammer 4a. The motor unit 10 comprises the motor 86, the motor housing 84 supporting the motor 86, the body housing 12 comprising the first battery receptacle 22 (example of battery receptacle) to which the battery pack BP is detachably attached, the body housing 12 accommodating the motor housing 84, and the fixing unit 90 comprising the first fixing part 148 configured to be fixed to the plate compactor 4b and the second fixing part 150 configured to be fixed to the rammer 4a. The motor 86 comprises the stator body 132, the coil 134 wound around the stator body 132, the outer rotor body 136 (example of rotor body), and the plurality of permanent magnets 138 (example of magnets) fixed to the outer rotor body 136. The residual magnetic flux density Br of each of the permanent magnets 138 is equal to or more than 1.32 T. The coercivity bHc of each of the permanent magnets 138 is equal to or more than 971 kA/m.

According to the above configuration, the permanent magnets 138 can be made smaller than in a configuration in which the residual magnetic flux density of each permanent magnet 138 is less than 1.32 T and/or the coercivity of each permanent magnet 138 is less than 971 kA/m. Due to this, the motor unit 10 can be downsized.

Further, the permanent magnets 138 are neodymium magnets.

According to the above configuration, since the magnetic force of the neodymium magnet is the strongest among permanent magnets, the permanent magnets 138 can be made smaller. Due to this, the motor unit 10 can be downsized.

Further, the stator body 132 comprises the plurality of teeth 514. The number of the plurality of permanent magnets 138 is equal to or more than the number of the plurality of teeth 514.

According to the above configuration, an occurrence of cogging can be suppressed during operation of the motor 86.

### (Variants)

The motor unit 10 in one embodiment may comprise three or more battery receptacles. In this case, the three or more battery packs BP can be attached to the body housing 12.

In one embodiment of the motor unit 10, the attaching direction D1 of the first battery pack BP1 may be different from the attaching direction of the second battery pack BP2. The detaching direction D2 of the first battery pack BP1 may be different from the detaching direction of the second battery pack BP2.

In the motor unit 10 of the above embodiment, the first right vibration-proof member 170, the second right vibration-proof member 172, and the third right vibration-proof member 174 are fixed to the right wall 154a of the plate member 92. In a variant, the number of vibration-proof members fixed to the right wall 154a of the plate member 92 is not limited to three, but may be two or less, four or more.

In the motor unit 10 of the above embodiment, the first left vibration-proof member 176, the second left vibration-proof member 178, and the third left vibration-proof member 180 are fixed to the left wall 154b of the plate member 92. In a variant, the number of vibration-proof members fixed to the left wall 154b of the plate member 92 is not limited to three, but may be two or less, four or more.

In one embodiment of the motor unit 10, the permanent magnets 138 may be a permanent magnet other than a neodymium magnet.

In one embodiment of the motor unit 10, the sensor board 520 may be fixed to the front bracket 110.

In one embodiment of the motor unit 10, the motor 86 is not limited to an outer rotor type motor, but may be an inner rotor type motor, for example.

The motor unit 10 in one embodiment may comprise a reduction mechanism. The reduction mechanism is disposed between the outer rotor body 136 of the motor 86 and the motor shaft 140. The reduction mechanism reduces the rotation of the outer rotor body 136 and transmits it to the motor shaft 140. Therefore, the rotation speed of the motor shaft 140 is less than that of the outer rotor body 136. The motor shaft 140 is offset from the outer rotor body 136 in a direction perpendicular to the front-rear direction (e.g., up-down direction and left-right direction).

What is claimed is:

1. A motor unit configured to be detachably attached to each of a plurality of types of working units to operate the working unit to which the motor unit is attached, the motor unit comprising:
a body housing comprising an accommodating part including a first wall, a first battery receptacle disposed on the first wall, and a second battery receptacle disposed on the first wall; and
a motor disposed inside the accommodating part and configured to drive the working unit,
wherein
the first battery receptacle is configured to have a first battery configured to power the motor attached thereto, the first battery being configured to slide along the first wall,
the second battery receptacle is configured to have a second battery configured to power the motor attached thereto, the second battery being configured to slide along the first wall,
the accommodating part is not disposed between the first battery attached to the first battery receptacle and the second battery attached to the second battery receptacle,
the first battery comprises a first side surface,
the second battery comprises a second side surface, and
the second side surface faces the first side surface and is disposed parallel to the first side surface when the first battery is attached to the first battery receptacle and the second battery is attached to the second battery receptacle.

2. The motor unit according to claim 1, wherein the motor unit does not comprise a wall part disposed between the first side surface of the first battery and the second side surface of the second battery when the first battery is attached to the first battery receptacle and the second battery is attached to the second battery receptacle.

3. The motor unit according to claim 1, wherein the first wall is disposed above the motor when the motor unit is placed on a placement surface.

4. The motor unit according to claim 1, wherein the first wall comprises a first surface on which the first battery receptacle and the second battery receptacle are disposed.

5. The motor unit according to claim 1, further comprising a vibration-proof member disposed between the motor and the body housing and being elastically deformable.

6. The motor unit according to claim 5, further comprising:
a motor housing accommodating the motor; and
a plate member fixed to the motor housing,
wherein the vibration-proof member is fixed to the plate member and the body housing.

7. The motor unit according to claim 6, further comprising:
a control unit disposed inside the accommodating part and configured to control the motor; and
a support unit supporting the control unit and fixed to the plate member via the vibration-proof member.

8. The motor unit according to claim 1, wherein
each of the first battery and the second battery comprises a hook configured to be operated by a user, and
the body housing comprises engaged parts, each engaged part being configured to engage with a corresponding one of the hooks.

9. The motor unit according to claim 1, wherein when the motor unit is viewed along a direction perpendicular to the first wall, the first battery receptacle does not overlap the second battery receptacle.

10. The motor unit according to claim 1, wherein
the first battery receptacle is configured to have the first battery attached thereto, wherein the first battery is configured to slide in a first direction which extends along the first wall,
the second battery receptacle is configured to have the second battery attached thereto, wherein the second battery is configured to slide in the first direction, and
the motor comprises a motor shaft extending in the first direction and fixed to the working unit.

11. The motor unit according to claim 10, further comprising a control unit disposed inside the accommodating part and configured to control the motor,
wherein when the motor unit is viewed along the first direction, the control unit at least partially overlaps the motor.

12. The motor unit according to claim 1, further comprising a fixing part fixed to the working unit,
wherein the motor is disposed between the fixing part and the first battery receptacle and between the fixing part and the second battery receptacle.

13. A motor unit configured to be detachably attached to each of a plurality of types of working units to drive the working unit to which the motor unit is attached, the motor unit comprising:
a body housing comprising an accommodating part including a first wall, a first battery receptacle disposed on the first wall, and a second battery receptacle disposed on the first wall;
a motor disposed inside the accommodating part and configured to drive the working unit; and
a fixing unit comprising a first fixing part and a second fixing part,
wherein
the first battery receptacle is configured to have a first battery configured to power the motor attached thereto,
the second battery receptacle is configured to have a second battery configured to power the motor attached thereto,
the plurality of types of working units comprises a first working unit and a second working unit different from the first working unit,
the first fixing part is configured to be fixed to the first working unit, and
the second fixing part is configured to be fixed to the second working unit.

14. The motor unit according to claim 13, wherein
when the motor unit is placed on a placement surface, the first fixing part is placed on the placement surface, and
the motor is disposed between the first fixing part and the first battery receptacle and between the first fixing part and the second battery receptacle.

15. The motor unit according to claim 13, further comprising a motor housing accommodating the motor,
wherein the second fixing part is disposed on the motor housing.

16. The motor unit according to claim 13, wherein the first fixing part comprises a first fixing surface configured to be fixed to the first working unit,
the second fixing part comprises a second fixing surface configured to be fixed to the second working unit, and
the second fixing surface is substantially perpendicular to the first fixing surface.

17. The motor unit according to claim 13, further comprising a fan disposed inside the accommodating part and configured to rotate by operation of the motor,
wherein
a first air vent is defined between the accommodating part and the second fixing part,
a second air vent is defined on the second fixing part, and
when the fan rotates, air flows into the accommodating part via one of the first air vent and the second air vent and flows outside the accommodating part via another of the first air vent and the second air vent.

18. The motor unit according to claim 13, wherein a rated capacity of the first battery differs from a rated capacity of the second battery.

19. A working machine comprising:
a rammer unit; and
a motor unit configured to be detachably attached to the rammer unit to drive the rammer unit,
wherein
the motor unit comprises:
a body housing comprising an accommodating part, a first battery receptacle disposed on the accommodating part, and a second battery receptacle disposed on the accommodating part; and
a direct-current motor disposed inside the accommodating part and configured to drive the rammer unit,
the first battery receptacle is configured to have a first battery configured to power the direct-current motor attached thereto, and
the second battery receptacle is configured to have a second battery configured to power the direct-current motor attached thereto.
